(19) United States
(12) Patent Application Publication
(10) Pub. No.: US 2008/0109297 A1
(43) Pub. Date: May 8, 2008

(54) METHODS AND SYSTEMS FOR PRICING CONTINGENT RIGHTS

(76) Inventors: Andrew K. Leach, Hinsdale, IL (US); Richard M. Harmon, Lake Forest, IL (US)

Correspondence Address: STRATEGIC PATENTS P.C.., C/O PORTFOLIOIP, P.O. BOX 52050, MINNEAPOLIS, MN, 55402, US

(21) Appl. No.: 11/852,477

(22) Filed: Sep. 10, 2007

Related U.S. Application Data
(60) Provisional application No. 60/825,113, filed on Sep. 8, 2006.
(60) Provisional application No. 60/825,302, filed on Sep. 12, 2006.

(51) Int. Cl. G06Q 30/00; G06Q 10/00

(52) U.S. Cl. 705/10; 705/35

(57) ABSTRACT

The present invention relates to providing a contingent right to purchase an event ticket within an integrated rights marketplace, wherein the cost of the contingent right is based at least in part on a measure of demand for the contingent right. In embodiments, the present invention may provide a contingent event certificate market platform, and select a currency for the contingent event certificate market platform based on an aspect of the user of the platform.

### CROSS-REFERENCE TO RELATED APPLICATIONS

This application claims the benefit of the following provisional applications, each of which is hereby incorporated by reference in its entirety: U.S. Provisional App. No. 60/825,113 filed on Sep. 8, 2006 and U.S. Provisional App. No. 60/825,302 filed Sep. 12, 2006.

The following documents are hereby incorporated by reference:

Ser. No. 60/824,427, (Demand Aggregation For Events Contingent Upon Threshold Demand) filed on Sep. 1, 2006 by Harmon et al.;

Ser. No. 09/586,723 (Contingency-based Options and Futures for Event Tickets and Related Goods and Services), filed on Jun. 5, 2000 by Cella et al

This application is also related to the following U.S. patent applications each of which is incorporated by reference herein in its entirety:

U.S. patent application Ser. No. 10/179,634 (Electronic System and Method for Trading Seat Licenses, Event Tickets and Contingent Event Ticket Certificates), filed on Jun. 25, 2002 by Richard Harmon et al.;

U.S. patent application Ser. No. 10/386,741 (System and Method for Executing a Payment Transaction over a Computer Network), which is a continuation-in-part of application Ser. No. 10/179,634, filed on Mar. 12, 2003 by Harmon et al;

U.S. Patent Application Ser. No. 60/674,866 (Methods and Apparatus for Marketing Contingent Event Certificates), filed by Harmon et al;

U.S. Patent Application Ser. No. 60/749,933 (Method and Apparatus for MP3/Live Event Integration), filed by Harmon et al;

U.S. Patent Application Ser. No. 60/674,733 (Methods and Apparatus to Predict Demand for a Product or Service), filed by Harmon et al; and

U.S. patent application Ser. No. 09/586,723 (Contingency-based Options and Futures for Event Tickets and Related Goods and Services), filed on Jun. 5, 2000 by Cella et al.

### BACKGROUND

Marketplaces exist where event producers sell access or purchase rights, such as event tickets and accommodations, or goods and services to consumers. In some cases, the marketplaces are distinct transaction centers, such as a local theatre box office, hotel reservation system, retail store and the like. In other cases, a third party, such as a ticket consolidator, facilitates the transaction between an event producer and a consumer. These primary marketplaces are distinguished by the type of transaction they provide, namely, a primary sale of access or purchase rights.

Marketplaces also exist where holders of access or purchase rights—those who have made a primary purchase through a primary marketplace—offer their rights for sale. These secondary marketplaces may be as simple as an individual selling a ticket to another individual, such as a friend. They may also be facilitated by service companies who, similarly to the ticket consolidators of the primary market, facilitate individual access rights sale transactions among holders of the access rights and purchasers. Secondary marketplaces are distinguished from primary marketplaces in that they facilitate secondary transactions in access or purchase rights already issued.

Historically, the above-described access rights marketplaces have related to the primary issuance or secondary exchange of rights the terms of which were fully determined at the time of issuance or sale. However, a marketplace also exists, as described in the documents incorporated herein by reference, for the sale and exchange of contingent access or purchase rights. This forward marketplace may support both primary contingent rights futures issuances and purchases as well as secondary exchange of contingent rights. This forward marketplace may be distinguished from other marketplaces in that the access or purchase rights being exchanged are contingent rights the terms of which depend on a contingency. Marketplaces for exchanging contingent futures may be referred to as pre-primary, forward or futures markets. It may be noted that within each marketplace rights, contingent or determined, may be exchanged at different times and among different individuals. For example, rights may be offered to a limited group, such as a fan club, set of registered users, group of season ticket holders or the like, before being offered more generally to a wider range of individuals, such as the public. Thus, a forward market may have an initial pre-forward market stage, a primary market may have a pre-primary stage, and a secondary market may have a pre-secondary market stage. Thus, where context indicates, pre-primary may refer to a forward market for a right that is subject to a future contingency or to a pre-primary stage with respect to a primary market. A forward market may be a forward market for exchange of contingent rights or it may be an introductory pre-sale stage for determined rights.

The forgoing marketplaces (pre-forward, forward, pre-primary, primary, and pre-secondary and secondary) each address a portion of the continuum of access rights marketplaces. References throughout this disclosure to forward markets, primary markets and secondary markets should be understood to encompass, except where context indicates otherwise, to include associated pre-forward, pre-primary and pre-secondary markets.

There exist primary marketplaces where an event producer, such as and without limitation a sports franchise, first sells access rights, such as and without limitation event tickets. The inventors have elsewhere described systems and methods for selling contingent event certificates. The inventors have elsewhere described systems and methods for a secondary marketplace in which there exists an exchange for trading access rights and contingent event certificates. There remains a need for an integrated marketplace for originating and trading in which both contingent access and purchase rights futures and access and purchase rights may be sold.

These and other systems, methods, objects, features, and advantages of the present invention will be apparent to those skilled in the art from the following detailed description of the preferred embodiment and the drawings.

### SUMMARY

Disclosed herein are methods and systems for exchanging rights associated with determined events, forward rights associated with events that are subject to a contingency, rights to goods and services associated with events, and rights to goods, services and other commodities that are not necessarily associated with a particular event (or with respect to which the offering of the same is the event in question). The methods and systems include methods and systems for futures and options pricing, purchasing, and selling, for certificates, tickets, licenses, contracts, permissions, and other rights or evidence of rights to acquire services, goods, rights, and so forth. In certain embodiments, where context permits, an event may be a sporting event, a concert, or a wide range of other events, such as publishing a work of authorship, producing a media work, providing a service or selling a good. A good or service may be associated with an event (e.g. a Red Sox t-shirt associated with a playoff game event), or the good or service may be independent of any event (e.g., a consumer good like a television, or service like acupuncture). In embodiments disclosed herein, such futures and options may be referred to as contingent access or purchase rights, which in turn may be evidenced by a certificate, referred to herein in many cases as a contingent event certificate. As used herein, a contingent event certificate may include, but is not limited to, embodiments such as a ticket, reservation, permission, contract, license or some other manifestation (physical or digital) of a right to an event, good, commodity or service that is associated with a contingency or plurality of contingencies. Many kinds of contingent event certificate are described herein and in the documents incorporated by reference herein.

In the present invention, an integrated rights marketplace is provided. This marketplace may be associated with a user interface, a transactional platform, data structure, process flow, and the like.

The integrated rights marketplace may associate a forward market, a primary market, and a secondary market. The integrated rights marketplace may associate a forward market and a primary market. The integrated rights marketplace may associate a forward market and a secondary market. The integrated rights marketplace may associate a primary market, and a secondary market. These markets may relate to the sale and/or resale of a contingent right and/or determined right (e.g., a ticket to a scheduled event that is not subject to a contingency).

In embodiments, the interface to the integrated rights marketplace may allow users to acquire contingent rights and/or determined rights (“rights”), to exchange rights, to sell rights, to compare rights, to shop for rights, to transact rights, or perform some other activity in association with rights. A transaction may include, but is not limited to, a purchase, a sale, a trade, or some other transaction type.

The contingent, forward right may be embodied in an electronic or physical form as a contingent event certificate, and may relate to a ticket (e.g., a ticket to a live event), a reservation, a license, a contract, a permission, to a right to obtain a product, a right to obtain a service, or some other contingent, forward right. In embodiments, a contingency may include, but is not limited to, the presence of a team in a game, the presence of a participant in an event, the presence of a group of performers in an event, the presence of an event at a location, the occurrence of an event on a date, the occurrence of an event at a venue, the occurrence of a weather-related event, the occurrence of a product release, the occurrence of a service release, the presence of a performer in a live event, the presence of a group of performers in a live event, or some other contingent occurrence.

In embodiments, the determined right may be embodied in an electronic or physical form as an event ticket, bill of sale (e.g., in the case of a consumer good), purchase and sale agreement, invoice, reservation receipt (e.g., to an accommodation like a hotel room), or some other manifestation of a determined right. A determined right may be a ticket to a scheduled event, a right to purchase a good, a right to purchase a service, or some other right.

In embodiments, the interface may be associated with a web service, a security facility, a payment facility, or some other service. A payment facility may include, but is not limited to, a credit card payment facility, a bank account debit facility, PayPal, BillPay, or some other payment facility.

Methods and systems provided herein include methods and systems for providing an integrated rights marketplace encompassing the forward, primary, and secondary markets. The methods and systems include methods and systems for providing a forward market interface for enabling purchase of contingent access rights issued by issuers of contingent access rights, providing a primary market interface for purchasing rights associated with an event from an issuer of primary access or purchase rights and providing a secondary market interface for enabling exchange among owners of at least one of primary access or purchase rights and contingent access or purchase rights. In embodiments, the forward market interface may relate to a market for rights with respect to events for which there is as yet a contingency. In embodiments the primary market interface may relate to a market for determined rights. In embodiments the secondary market interface may relate to a market for contingent rights and determined rights. In embodiments the forward market interface, the primary market interface and the secondary market interface may be presented within the same domain or interface. In embodiments, the domain or interface may include at least one web page. In embodiments, the domain or interface may include one or more associated databases to facilitate integrating the forward, primary, and secondary marketplace domains. In embodiments, the determined right may be an event ticket. In embodiments, the contingent right may be a contingent event certificate. In embodiments, the contingent right may include both a right and an obligation to acquire the determined right upon the occurrence of a contingency. In certain embodiments, the methods and systems may further include providing a transactional platform for executing a transaction that is associated with at least one of a contingent right and a determined right. In embodiments, the transactional platform may enable execution of transactions associated with both contingent rights and determined rights.

These and other systems, methods, objects, features, and advantages of the present invention will be apparent to those skilled in the art from the following detailed description of the preferred embodiment and the drawings.

### BRIEF DESCRIPTION OF THE FIGURES

The invention and the following detailed description of certain embodiments thereof may be understood by reference to the following figures:

FIG. 1 depicts an integrated rights marketplace for the issuance and exchange of rights, including contingent rights and determined rights.

FIG. 2 depicts one use of the integrated marketplace interface to transact a right to an event.

FIG. 3 depicts one use of the integrated marketplace interface to transact a right to a consumer good.

FIG. 4 depicts uses of the integrated marketplace interface to transact rights to services.

FIG. 5 depicts a trading marketplace for contingent event certificates and associated interfaces and participants.

FIG. 6 depicts a market platform for contingent event certificates or rights along with associated participants.

FIG. 7 depicts a cartoon of a forward rights marketplace.

FIG. 8 is a flow chart of a method of trading a personal seat license (PSL), event tickets, and contingent event ticket certificates according to the present invention

FIG. 9 is a block diagram of a network based exchange according to an embodiment of the invention.

FIG. 10 depicts a screen shot of a graphical user interface for an exchange according to an embodiment of the invention showing a login page.

FIG. 11 depicts a screen shot of a graphical user interface for an exchange according to an embodiment of the invention showing a customized customer page showing seat license holdings of a PSL owner.

FIG. 12 depicts a screen shot of a graphical user interface for an exchange according to an embodiment of the invention showing a customized customer page showing event ticket holdings of a PSL owner.

FIG. 13 depicts a screen shot of a graphical user interface for an exchange according to an embodiment of the invention showing a new order page.

FIG. 14 depicts a screen shot of a graphical user interface for an exchange according to an embodiment of the invention showing a customized customer page showing submitted orders.

FIG. 15 depicts a screen shot of a graphical user interface for an exchange according to an embodiment of the invention showing a customized customer page of a customer having no holdings.

FIG. 16 depicts a screen shot of a graphical user interface for an exchange according to an embodiment of the invention showing a purchase event tickets page.

FIG. 17 depicts a screen shot of a graphical user interface for an exchange according to an embodiment of the invention showing a more detailed purchase ticket page.

FIG. 18 depicts a screen shot of a graphical user interface for an exchange according to an embodiment of the invention showing a purchase event tickets invoice page.

FIG. 19 depicts a screen shot of a graphical user interface for an exchange according to an embodiment of the invention showing a customized customer page showing the event ticket holdings of an event ticket trader.

FIG. 20 depicts a screen shot of a graphical user interface for an exchange according to an embodiment of the invention showing an event ticket purchase/sell event tickets page.

FIG. 21 depicts a screen shot of a graphical user interface for an exchange according to an embodiment of the invention showing an event tickets sales invoice page.

FIG. 22 depicts a screen shot of a graphical user interface for an exchange according to an embodiment of the invention showing a bid acceptance message page.

FIG. 23 depicts a screen shot of a graphical user interface for an exchange according to an embodiment of the invention showing a customized customer page showing an event ticket purchaser's event ticket holdings.

FIG. 24 depicts a screen shot of a graphical user interface for an exchange according to an embodiment of the invention showing an event tickets transfer page.

FIG. 25 depicts a screen shot of a graphical user interface for an exchange according to an embodiment of the invention showing a ticket transfer e-mail message sent to an event ticket transferee.

FIG. 26 depicts a screen shot of a graphical user interface for an exchange according to an embodiment of the invention showing a customized customer page showing an event tickets transferee's ticket holdings.

FIG. 26 depicts a screen shot of a graphical user interface for an exchange according to an embodiment of the invention showing a customized customer page showing an event tickets transferee's ticket holdings.

FIG. 27 depicts a contingent travel rights exchange.

FIG. 28 depicts a contingent event rights exchange relating to an event participant.

FIG. 29 depicts a contingent consumer product rights exchange.

FIG. 30 depicts a secondary market for contingent rights exchange.

FIG. 31 depicts a contingent rights exchange relating to weather phenomenon.

FIG. 32 depicts a contingent forward rights exchange.

FIG. 33 depicts a contingent rights exchange relating to non-post season sporting events.

FIG. 34 depicts pricing contingent rights.

FIG. 35 depicts contingent purchase rights associated with consumer products.

FIG. 36 depicts a rights exchange user interface.

FIG. 37 depicts contingent event rights relating to team location.

FIG. 38 depicts a contingent rights exchange associated with a social network.

FIG. 39 depicts a contingent rights exchange relating music production.

FIG. 40 depicts a contingent rights exchange relating to a private event.

FIG. 41 depicts associating media channels with a contingent rights exchange.

### DETAILED DESCRIPTION

People often buy items, such as products, tickets, and the like, on a primary market and resell them on a secondary market. In embodiments, the items may be associated with access rights, purchase rights, rights with respect to a particular event, venue, activity, a license, contract, permission, or the like. Where such rights are generally defined or determined at the time of issuance, such as without being subject to a contingency, they may be referred to herein as “defined rights” or “determined rights.” Contingent event certificates may comprise rights, evidence of rights, rights and obligations, or evidence of rights and obligations to acquire something. The rights may be associated with a future item, such as attending an event, buying tickets, purchasing a consumer good or service, or otherwise acquiring a benefit, wherein the rights may be contingent upon a future occurrence or determination, such as aggregation of sufficient demand for the future item, or the like (in some cases referred to herein as “forward rights”). Contingent event certificates and contingent rights are described in detail herein and in the documents appended or incorporated by reference hereto. Generally, contingent rights may be first sold in a forward market and then traded or resold in a secondary market. As contingencies are resolved, contingent rights may convert, emerge, mature, vest, et cetera into determined rights, which may be first sold on a primary market and then traded or resold in a secondary market. The present invention provides systems and methods that may be associated with an integrated rights marketplace, which may comprise one or more of a forward market, a primary market, and a secondary market.

A contingent access right may comprise a right, such as an option, that may or may not be associated with an event, where the right matures or expires depending upon how a contingency becomes defined in the future. In embodiments, the contingent access right may comprise a right only. In other embodiments the contingent access right may include both a right and an obligation to conduct a transaction, perform an action, and so on. Thus, in the case that the option matures, the holder of the contingent access right may have the right and obligation to do something. In other embodiments, the option may comprise a right but not an obligation to do something. Contingent access rights may be embodied as contingent event certificates. As may be described and/or appreciated, many embodiments of contingent event certificates are possible. In embodiments, a contingent event certificate may include, but is not limited to, embodiments such as a ticket, reservation, permission, contract, license or some other manifestation (physical or digital) of a right to an event, good, commodity or service that is associated with a contingency or plurality of contingencies. All such embodiments are within the scope of the present disclosure. Throughout this disclosure, the terms “contingent access right” and “contingent event certificate” may be used interchangeably to refer to a contingent access right, contingent purchase right, contingent good right, contingent service right, and so forth. Certain embodiments of the inventions disclosed herein may take advantage of features and components of contingent event certificate methods and systems, an exemplary embodiment of which is disclosed in U.S. patent application Ser. No. 10/179,634, the entirety of which is incorporated by reference herein and should be understood to be encompassed in the present disclosure and where demand may be a contingent variable.

Throughout this disclosure the terms “contingent access right” and “contingent event certificate” may be used interchangeably to refer to a contingent access or purchase right and/or an embodiment thereof. Throughout this disclosure the phrase “for example” means “for example and without limitation.” Throughout this disclosure the phrase “in an example” means “in an example and without limitation.” Throughout this disclosure the phrase “in another example” means “in another example and without limitation.” Throughout this disclosure, the phrase “such as” means “such as and without limitation.” Generally, any and all examples may be provided for the purpose of illustration and not limitation.

Elements, components, applications, features, systems, methods, aspects, et cetera of the present invention may be described in detail herein and in documents incorporated by reference herein. These documents may include U.S. Patent Application Ser. No. 60/674,733; Methods and Apparatus to Predict Demand for a Product Service (Harmon 1); U.S. patent application Ser. No. 09/586,723 Contingency-based Options and Futures for Event Tickets and Related Goods and Services (Cella); U.S. Patent Application Ser. No. 60/674,866; Methods and Apparatus for Marketing Contingent Event Certificates (Harmon 2); U.S. Patent Application Ser. No. 60/749,933; Method and Apparatus for MP3/Live Event Integration (Harmon 3); U.S. patent application Ser. No. 10/179,634; Electronic System and Method for Trading Seat Licenses, Event Tickets and Contingent Event Ticket Certificates (Harmon 4); and U.S. patent application Ser. No. 10/386,741; and System and Method for Executing a Payment Transaction Over a Computer Network (Harmon 6). The entire disclosure of each of the foregoing documents is hereby incorporated by reference. Excerpts from any and all of these documents may be provided below. These excerpts are provided for the purpose of illustration and not limitation. It will be appreciated that the aforementioned documents may provide support for any and all of the elements depicted in the figures and elsewhere, regardless of whether such support is explicit in the excerpts.

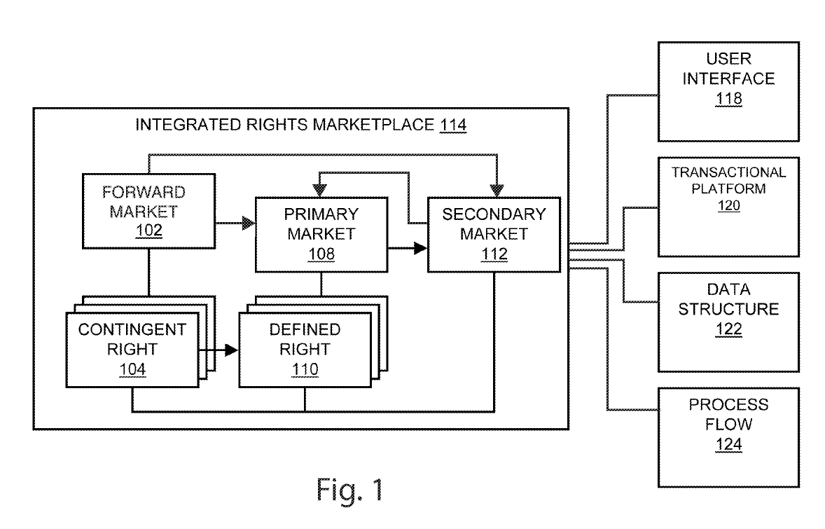

One embodiment of an event right relates to a ticket to an event, such as a sporting event, concert, or the like. Referring to FIG. 1, there are three phases in the lifecycle of a ticket. A forward market 102 operates during the first phase. Here, the ticket may be first sold as a contingent access right 104, such as if it is uncertain whether the event will take place, or if some parameter with respect to the event remains undefined to the extent that uncertainty remains as to whether the ticket will in fact result in a right to attend an actual event. A primary market 108 operates during the second phase. Here, the ticket is first sold as a determined right 110, such as by an issuer or event provider, or by a service provider operating on behalf of one of them. For example, a concert promoter may sell a ticket to a concert, either directly to a consumer or through a service company, such as TicketMaster. A secondary market 112 operates during the third phase. Here, the ticket (whether it be the contingent right 104 or the determined right 110) may be resold, perhaps any number of times. An integrated rights marketplace 114 may comprise the forward market 102, the primary market 108, the secondary market 112, any number of contingent rights 104, and any number of determined rights 110. This marketplace 114 may be associated with and/or enabled by a user interface 118, a transactional platform 120, a data structure, a process flow 124, and the like. Any and all of the markets 102, 108, 112 may be implemented as an auction-type market, a retail-type market, a bid-ask type market, and so on.

The contingent right 104 may comprise a reservation, option, forward right, or the like that exists before an event is fully defined. A contingent right 104 may be embodied as a contingent event certificate, which may exist electronically and/or physically. In embodiments, a data structure 122 may encompass a representation of the contingent right 104. As indicated by the arrow from the contingent right 104 to the determined right 110, the contingent right 104 may mature into a determined right 110 upon a contingent event becoming fully defined. For example and without limitation, a contingent right 104 may mature when a designated team becomes scheduled to appear in the Super Bowl; when a particular player is scheduled to appear in a particular sporting event; when an event is scheduled to take place at a designated venue; upon the existence and/or forecast of a weather-related event (such as and without limitation, snow); based upon an indicator of demand for an event; based upon a performance hallmark (such as and without limitation a baseball player hitting a certain number of home runs before the All-Star Break); based upon a random event (such as and without limitation a coin flip or the like); based upon multiple contingent events (such as and without limitation a combination of any and all of the foregoing contingent events); and so on. In embodiments a contingent right 104 may be associated with a right to acquire something upon occurrence of a contingency, an obligation to acquire something upon occurrence of a contingency, or both.

In embodiments, the forward market may sell forward rights that are not associated with a contingency. The purchased forward rights may, in an example, secure a right to a face value ticket to an event (e.g., a Broadway musical). The forward right may be sold in the forward marketplace, traded and sold in the forward marketplace, and, once the contingency is determined, later traded or sold within the secondary market.

The determined right 110 may comprise a right to something, such as and without limitation access to an event, a sporting event, an entertainment event (such as and without limitation a concert), a travel event (such as and without limitation a vacation package), a product launch (such as and without limitation a toy on the first date of sale), and so on. A determined right 110 may be embodied as a ticket or event ticket, which may exist electronically and/or physically. In embodiments, the data structure 122 may encompass a representation of the determined right 110. The determined right 110 may be associated with the primary market 108, the secondary market 112, and the contingent right 104. As indicated by the arrow from the contingent right 104 to the determined right 110, the determined right 110 contingent right 104 may comprise a matured version of the contingent right 104. Alternatively or additionally, the determined right 110 may be created upon the maturing of the contingent right 104.

A process flow 124 of the integrated rights marketplace 114 may comprise one or more of the following logical steps, in the order presented or in any and all other orders: First, a contingent right 104 may be created and sold in association with and/or according to a process of the forward market 102. As the arrow from the forward market 102 to the secondary market 112 indicates, the contingent right 104 may then be transferred into the secondary market 112. There, the contingent right 104 may be resold any number of times. Whether or not the contingent right 104 is transferred to the secondary market 112, at some point a contingent event may become fully defined, thus causing the contingent right 104 to mature. Upon this maturing and as indicated by the arrows from the secondary market 112 to the primary market 108 and from the forward market 102 to the primary market 108, the continent right 104 may be transferred to the primary market 108, where it converts into and/or is exchanged for a determined right 110. This determined right 110 may then be sold in association with and/or according to a process of the primary market 108. As the arrow from the primary market to the secondary market 112 indicates, the determined right 110 may then be transferred into the secondary market 112. There, the determined right 110 may be resold any number of times. As indicated by the arrow from the primary market 108 to the forward market 102, a determined right 110 may be transferred to the forward market 102 where it is associated with a contingency and offered for sale as a contingent right 104. For example and without limitation, this may be the case with a ticket to the World Series. Well in advance of when the exact teams participating in the World Series is known, the event producer, Major League Baseball, may transfer (or sell) the defined right for a seat at one of the games to the forward market. The defined right may be associated with a contingency such as a particular team participating in the game, and the resulting contingent right 104 may be sold as herein described.

The forward market 102, primary market 108, and secondary market 112 may be owned, controlled, maintained, or operated separately from the integrated rights marketplace 114. In such a configuration the integrated rights marketplace 114 may be characterized by one or more of the process flows 124 herein described associating the individual markets with contingent rights 104 and/or determined rights 110. In an example, three separately owned and operated markets—a primary market 108 such as ticketmaster.com, a secondary market 112 such as stubhub.com, and a forward 102 market such as ticketreserve.com—may be organized into the integrated rights marketplace 114 through the process flows 124 that associate contingent rights 104 and determined rights 110. In the example, a contingent right 104 may be sold on ticketreserve.com, resold on stubhub.com, converted to a determined right 110 on ticketmaster.com, and resold on stubhub.com. Any and all other combinations and examples of individually owned and commonly owned markets may be included in the integrated rights marketplace 114 and are incorporated herein.

The process flows 124, user interface 118 features, the data structure 122, and the transactional platform 120, may be incorporated individually or in various combinations into separately owned or operated markets such as ticketmaster.com, stubhub.com, and ticketreserve.com to embody any portion of, or the entirety of the integrated rights marketplace 114. In an example, process flow 124 of selling contingent rights may be incorporated into stubhub.com constituting a portion of the integrated rights marketplace 114. User interface 118 features (hereinafter described) that may provide the user with information pertaining to the maturing and/or conversion of a contingent right 104 into a determined right 110 may be incorporated into ticketmaster.com constituting a portion of the integrated rights marketplace.

The transactional platform 120 may comprise a server system that is interconnected through a communications network (such as and without limitation the Internet) to a client system. The server system may comprise conventional components of a server system, such as and without limitation a CPU, memory, a hard drive, a network port, a power port, and the like. The client system may comprise conventional components of a client system, such as and without limitation a computer workstation, a local area network of computers, an interactive television, an interactive kiosk, a personal digital assistant, an internet wireless communications device or the like, any and all of which may interact with the server system via the communications network. The transactional platform 120 may provide an implementation, instance, embodiment, et cetera of the integrated rights marketplace 114, including without limitation the forward market 102, the primary market 108, the secondary market 112, the contingent right 104, the determined right 110, the data structure 122, the process flow 124, the user interface 118, and so on.

The user interface 118 may present a user with information and user-action elements (such as buttons, checkboxes, text-entry fields, and the like) for interacting with the integrated rights marketplace 114. In one aspect, the user interface 118 may allow a user to define a contingent right 104, such as and without limitation by declaring a right and the contingent event upon which the right depends. In another aspect, the user interface 118 may allow a user to place a bid to buy a contingent right 104 in the forward market 102. In another aspect, the user interface 118 may provide a user with a view into the status of an order for a contingent right 104, a user-owned inventory of contingent rights 104, a market-wide inventory of contingent rights 104, and so on. In another aspect, the user interface 118 may allow a user to place a bid to buy and/or offer to sell a contingent right 104 in the secondary market 112. A bid to buy may include a bid in an auction-type market. In another aspect, the user interface 118 may provide the user with information pertaining to the maturing and/or conversion of a contingent right 104 into a determined right 110. For example and without limitation, the user interface 118 may provide a webpage that shows the contingent rights 104 that are owned by the user, whether the contingent rights 104 matured, at what time they matured, and so on. In another aspect, the user interface 118 may allow a user to select a determined right 110, such as and without limitation a determined right 110 that the user wishes to buy, sell, learn more about, and so on. In another aspect, the user interface 118 may allow a user to place an order to buy a determined right 104 in primary market 108. In another aspect, the user interface 118 may provide a user with a view into the status of an order for a determined right 110, a user-owned inventory of determined rights 110, a market-wide inventory of determined rights 110, and so on. In another aspect, the user interface 118 may allow a user to place an order to buy and/or sell a determined right 110 in the secondary market 112. In another aspect, the user interface 118 may provide the user with information pertaining to the exercise and/or expiration of a determined right (such as and without limitation the use of a determined right 110 to enter an event and/or the end a event, wherein the determined right 110 is associated with access rights to the event). For example and without limitation, the user interface 118 may provide a webpage that shows the determined rights 110 that are owned by the user, whether the determined rights 110 have been exercised, at what time they were exercised, whether the determined rights 110 have expired, at what time they expired, and so on. In another aspect, the user interface may enable a user to view their holdings across all three marketplaces (forward, primary, and secondary) and to simultaneous see the status of each holding.

In another aspect, the user interface 118 may allow a user to enter a right into the integrated rights marketplace 114. The user may provide an electronic representation of the right through the user interface 118. The electronic representation may include a scanned image of an event ticket, identification such as a serial number of the right, and other electronic representations that enable the integrated rights marketplace 114 to uniquely identify the right. In an example the user may scan the front and back of an event ticket into an image file and download the image file through the user interface 118. To maintain integrity of the rights transactions associated with the integrate rights marketplace 114, a right entered through the user interface may require validation, such as requiring the user to send the physical event ticket. The user may be required to give the integrated rights marketplace 114 an exclusive right to trade the entered right. Users entering rights may include without limitation consumers, event producers, corporate entities, ticket service companies such as TicketOne, Stub Hub, Ticketmaster, tickest.com, venue box offices, public entities such as colleges, and other holders of rights. The user may specify an offer price for an entered right or may allow the rights marketplace to determine an offer price based at least on market demand for the right or for an event associated with the right. The user may be required to provide information about the entered right through the user interface 118 so that the entered right may be associated with an appropriate market. In an example, a user may be a corporate entity selling excess tickets to a concert, and indicating this may result in the tickets being offered on the secondary market 112. In another example, a user may be a student organization entering access rights to a lecture, and indicating this may result in the access rights being offered on the primary market.

In another aspect, user interface 118 may be adapted to provide a user access to separately owned or operated markets such as ticketmaster.com, stubhub.com, and ticketreserve.com so that a user may view the individual markets as integrated markets within the integrated rights marketplace 114. As an example, user interface 118 may include a link to the ticketmaster.com website. In another example, the user interface 118 may allow a user to select from a plurality of primary rights markets (e.g. ticketmaster.com, tickets.com, venue box offices, and the like). The user interface 118 may also allow a user to access features of the integrated rights marketplace 114 that have been incorporated into the separately owned or operated markets. For example, a stubhub.com user interface may only support trading determined rights 110, whereas the integrated rights marketplace user interface 118 may support trading determined rights 110 and/or contingent rights 104 on stubhub.com

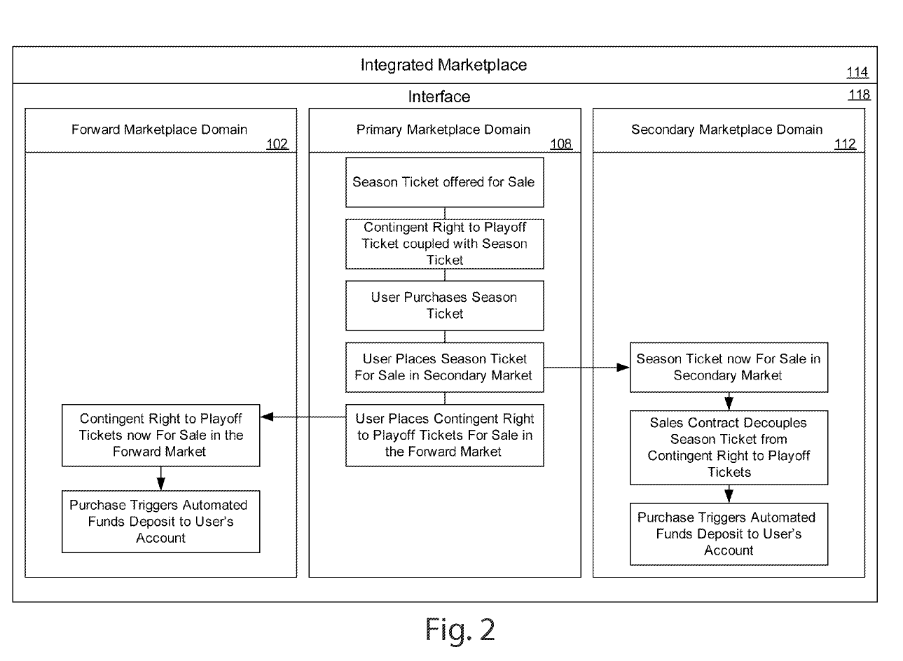

As depicted in FIG. 2, the integrated marketplace 114 and the user interface 118 may enable a user to access each of the forward 102, primary 108, and secondary 112 marketplace domains and to transact contingent and determined rights relating to events within and across the marketplaces (102, 108, 109), convert contingent rights to determined rights, convert determined rights to contingent rights, or perform some other activity relating to rights in the forward 102, primary 108, and secondary 112 marketplaces. In an example, a user may access the interface 118 and see that the Boston Red Sox baseball club has offered a season ticket for sale within the primary marketplace domain 108. The user may purchase the season ticket through the interface 118. This purchase may be made by clicking a link, button, dragging and dropping the ticket into a virtual shopping cart, or performing some other purchase activity. The purchase of the ticket may be associated with a payment facility that automatically deducts the cost of the ticket from the user's account. The account may be a credit card account, a bank account, a PayPal or BillPay account, or some other account in which the user has funds. In this example, upon purchase of the Red Sox season ticket, the user's status as a season ticket holder may afford him the contingent right to Red Sox playoff tickets if the Red Sox are able to make it to the playoffs; in effect, he has purchased the determined right to a Red Sox season ticket and a contingent right to a plurality of Red Sox playoff tickets based upon the contingency that the Red Sox make it to the playoffs.

Continuing the example and still referring to FIG. 2, as the owner of the season ticket determined right, the user may place the season ticket determined right for sale in the secondary market at a cost greater than that he paid. The interface 118 may enable placement of the ticket from the primary marketplace 108 to the secondary marketplace 112 by clicking a link, button, dragging and dropping the ticket into a secondary marketplace 112 section of the interface 118, or performing some other activity. As part of the placement within the secondary marketplace 112, the user may be able to associate the sale with terms and conditions. The terms and conditions may state a minimum price, a method of payment, shipping arrangements, or some other prerequisite of sale. The terms and conditions may also state that the season ticket is sold only as a determined right and that the seller retains the contingent right to the Red Sox playoff tickets. This may have the effect of decoupling the season ticket determined right from the playoff ticket contingent right, even though when the season ticket was purchased in the primary marketplace 108 the rights were coupled by the original seller (the Red Sox). Once the season ticket is purchased in the secondary marketplace 112 by a second user, the purchase may trigger an automated deposit of funds into the seller's account. The account may be a credit card account, a bank account, a PayPal or BillPay account, or some other account in which the seller deposits funds. Now that the user has decoupled the season ticket determined right from the playoff ticket contingent right, the user may place the playoff ticket contingent right for sale within the forward marketplace 102. The interface 118 may enable placement of the ticket from the primary marketplace 108 to the forward marketplace 102 by clicking a link, button, dragging and dropping the ticket into a forward marketplace 102 section of the interface 118, or performing some other activity. Once the contingent playoff ticket right is purchased in the forward marketplace 103 by another user, the purchase may trigger an automated deposit of funds into the seller's account. The account may be a credit card account, a bank account, a PayPal or BillPay account, or some other account in which the seller deposits funds.

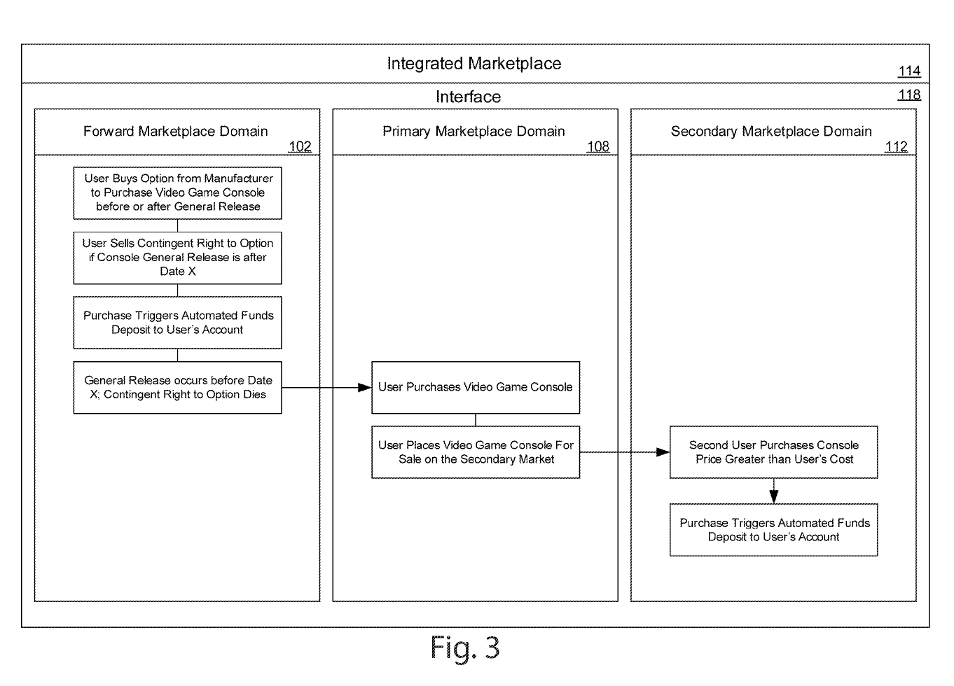

As depicted in FIG. 3, the integrated marketplace 114 and the user interface 118 may enable a user to access each of the forward 102, primary 108, and secondary 112 marketplace domains and to transact contingent and determined rights relating to consumer or other goods within and across the marketplaces (102, 108, 109), convert contingent rights to determined rights, convert determined rights to contingent rights, or perform some other activity relating to rights in the forward 102, primary 108, and secondary 112 marketplaces. In an example, a video game console manufacturer may access the interface and place within the forward marketplace 102 the option to purchase a new video game console before after the general release to the public (i.e., it is an early purchase option but also a guaranteed right to purchase what may become a scare commodity following general release). A user may access the interface 118 and purchase the option. This purchase may be made by clicking a link, button, dragging and dropping the option into a virtual shopping cart, or performing some other purchase activity. The purchase of the option may be associated with a payment facility that automatically deducts the cost of the option from the user's account. The account may be a credit card account, a bank account, a PayPal or BillPay account, or some other account in which the user has funds. Following the purchase, the user may choose to sell within the forward marketplace 102 a contingent right to the option where the contingency is that the manufacturer will not release the video game console until after Date X. Another user may access the interface 118, see the contingent right to the option is for sale, and purchase it. Once the contingent right to the option is purchased in the secondary marketplace 112 by a second user, the purchase may trigger an automated deposit of funds into the seller's account. The account may be a credit card account, a bank account, a PayPal or BillPay account, or some other account in which the seller deposits funds.

Still referring to FIG. 3, in this example the general release of the video console occurs before Date X, so the contingency is not met and the purchaser's contingent right to the option fails. This results in the seller of the contingent right to the option retaining the right to purchase the console. The holder of the option may then purchase the video console. The purchase of the console may be associated with a payment facility that automatically deducts the cost of the console from the user's account. The account may be a credit card account, a bank account, a PayPal or BillPay account, or some other account in which the user has funds. Following purchase, the owner of the console may be aware of the scarcity of the console on the general market and decide to place the console for sale in the secondary marketplace 112 at a cost greater than that he paid. The interface 118 may enable placement of the console from the primary marketplace 108 to the secondary marketplace 112 by clicking a link, button, dragging and dropping the console into the secondary marketplace 112 section of the interface 118, or performing some other activity. Another user may access the interface 118 and purchase the console on the secondary market 112. Once the console is purchased in the secondary marketplace 112, the purchase may trigger an automated deposit of funds into the seller's account. The account may be a credit card account, a bank account, a PayPal or BillPay account, or some other account in which the seller deposits funds.

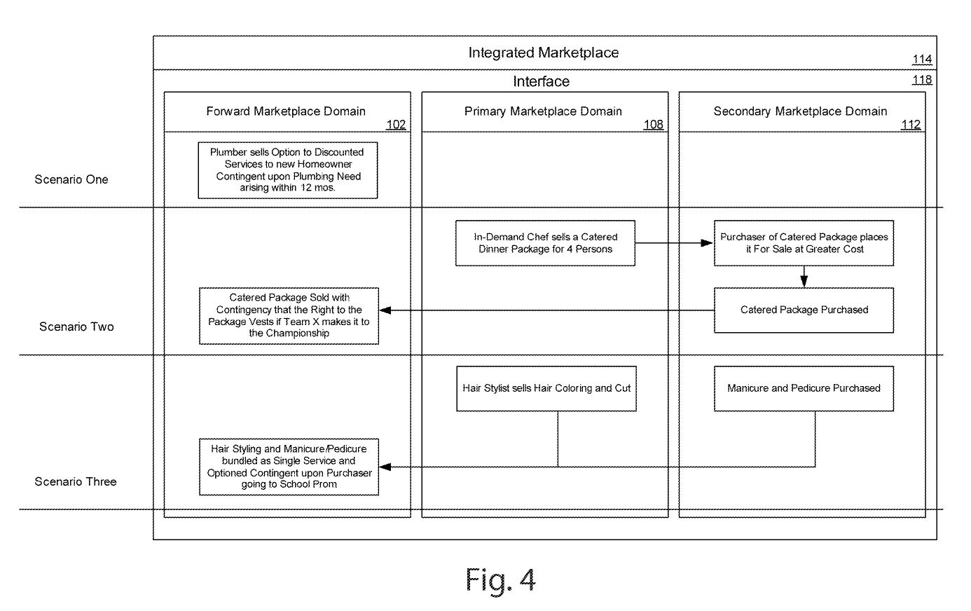

As depicted in FIG. 4, the integrated marketplace 114 and the user interface 118 may enable a user to access each of the forward 102, primary 108, and secondary 112 marketplace domains and to transact contingent and determined rights relating to services within and across the marketplaces (102, 108, 109), convert contingent rights to determined rights, convert determined rights to contingent rights, or perform some other activity relating to rights in the forward 102, primary 108, and secondary 112 marketplaces. FIG. 4 depicts three simplified scenarios in which the integrated marketplace 114 interface 118 is used to transact services.

In Scenario One of FIG. 4, a plumber may, within the forward marketplace 102, sell a contingent right to his services at a discount to a new homeowner where the contingency is that the new homeowner must have a need/use those services within 12 months of purchasing the contingent right. Once the contingent right is purchased in the forward marketplace 102, the purchase may trigger an automated deposit of funds into the plumber's account. The account may be a credit card account, a bank account, a PayPal or BillPay account, or some other account in which the seller deposits funds.

In Scenario Two of FIG. 4, a popular chef whose services are very much in demand may access the interface 118 and sell, within the primary marketplace 108, a determined right to have her cater a dinner for four persons. Once the determined right is purchased in the primary marketplace 108, the purchase may trigger an automated deposit of funds into the chef's account. The account may be a credit card account, a bank account, a PayPal or BillPay account, or some other account in which the seller deposits funds. The purchaser of the determined right to the catered dinner package may recognize the high-demand for the chef's services and decide to place the catered dinner package for sale in the secondary marketplace 112. The purchaser who buys the catered dinner package on the secondary marketplace 112 may simply choose to enjoy the chef's services and retain the determined right to those services for himself. However, in this hypothetical example, it is near a football championship. The holder of the determined right to the catered dinner package may offer for sale, within the forward marketplace 102, an option to purchase the catered dinner package subject to the contingency that Team X makes it to the Championship Game (e.g., for a catered Super Bowl party). Payments and debits may be associated with each transaction and processed as described herein.

In Scenario Three of FIG. 4, a single user or plurality of users may combine a service purchased in the primary marketplace 108 with a service purchased in the secondary marketplace 112 to form a single service package that is then sold in the forward marketplace 102 (or, alternatively in the primary 108 or secondary 112 marketplaces). In this example, a user may access the interface 118 and purchase, within the primary marketplace 108, a determined right to a hair coloring and cut by Hair Stylist. The same user may also purchase, within the secondary marketplace 112, a manicure and pedicure from Manicurist. The user next may bundle these services into a single service offering and sell a contingent right to this service, within the forward marketplace 102. Payments and debits may be associated with each transaction and processed as described herein.

The data structure 122 may comprise information that relates to and/or defines a contingent right 104, a determined right 110, an order in a forward market 102, an order in a primary market 108, an order in a secondary market 112, a history of any and all such order, and so on. In embodiments, a database may comprise the data structure 122. The information may include a price that is associated with a bid, ask, price, et cetera of a contingent right and/or determined right 110. The information may, without limitation, relate to an element of a contingent event, such as and without limitation a team, player, venue, location, weather, demand (for an event), a performance hallmark, a random event, a sporting event, an entertainment event, travel, a product launch, and so on. The information may be associated with a contingent event certificate or defined event certificate (such as and without limitation a ticket). This information may indicate a right; a forward right; a reward; an access right (such as and without limitation to a season of events, a seat at an event, a venue, any and all combinations of the foregoing, and so on); a right; an obligation; an indication of whether or not the certificate is transferable; and so on. The information may comprise a digital embodiment of the contingent right 104 and/or the determined right 110 and, thus, may comprise a contingent event certificate and/or a defined event certificate. The information comprising the data structure 122 may further include consumer data and market data. Market data may include historical pricing information. In embodiments, the user interface 118 may provide information from the integrated rights marketplace 114 to a user via a webpage, a text message, a voice message, a message on a private display, a message on a public display, and so on. In any and all embodiments, the user interface 118 may receive information from the user for communicating with the integrated rights marketplace 114, including, without limitation, information that is directed at navigating the information from the integrated rights marketplace 114; information that is directed at creating, modifying, canceling, et cetera a buy and/or sell order, wherein the order may relate to a contingent right 104 and/or a determined right 110; and so on. The user interface 118 may be accessible through an on-line social network such as through a web page of the social network.

All of the elements of the integrated rights marketplace 114 and associated elements 118, 120, 122, and 124 may be depicted throughout the figures with respect to logical boundaries between the elements. According to software or hardware engineering practices, the modules that are depicted may in fact be implemented as individual modules. However, the modules may also be implemented in a more monolithic fashion, with logical boundaries not so clearly defined in the source code, object code, hardware logic, or hardware modules that implement the modules. All such implementations are within the scope of the present disclosure.

In embodiments, the methods and systems may facilitate allocating an access right to a potential or contingent product, service, or live event based at least in part on a credit amount obtained through consumer activities associated with a producer, service provider, or performer of the potential or contingent live event.

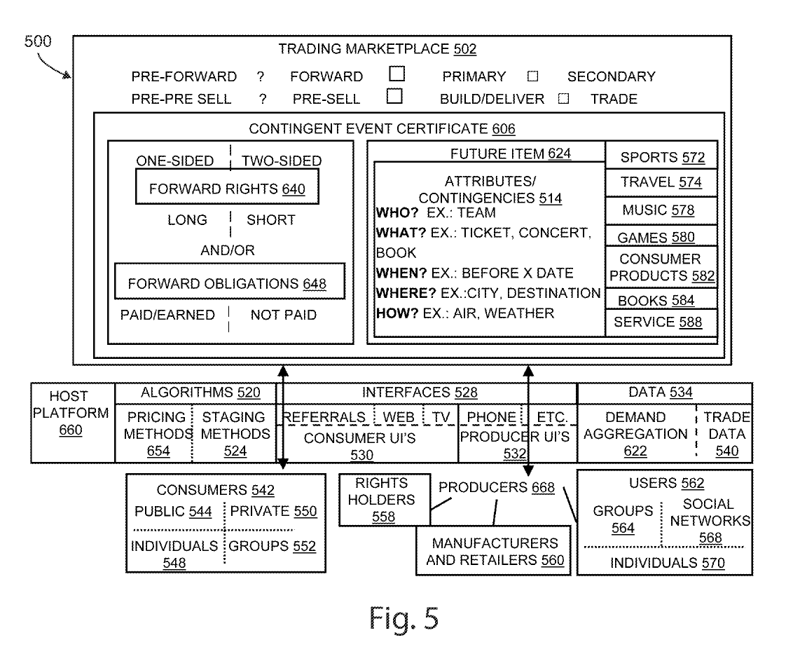

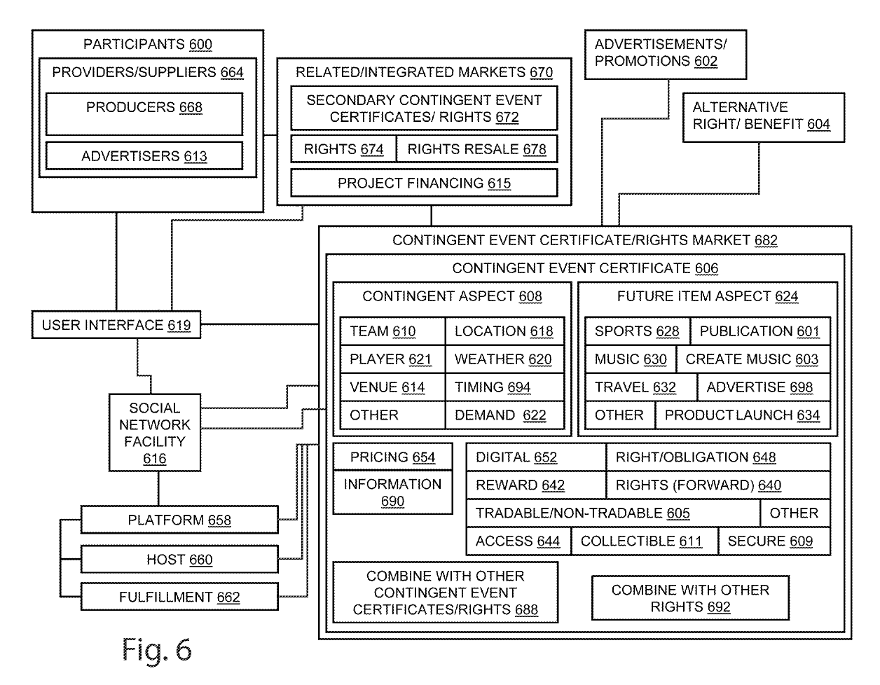

Referring now to FIGS. 5 and 6, other elements that may be resident along with the modules, processes, steps, methods, and systems described herein may be depicted. A trading marketplace 502 for a contingent event certificate or right and/or obligation (“CEC”) 606 may enable a consumer 542 or producer 668 to participate, through a host platform 660, in the acquisition or generation of a future item 624 and to obtain or offer forward rights 640 and/or forward obligations 648 associated with the future item 624 and, in embodiments, wherein the forward right 640 and/or forward obligation 648 is associated with aggregation of sufficient demand for the future item 624. CECs 606 may be provided on a trading marketplace 502. CECs 606 may be provided in a pre-forward market, such as an offering of a CEC 606 to a portion of potential consumers 542 or producers 668 prior to an offering of the CEC 606 to a wide audience. During the pre-forward market, the future item 624 may be pre-pre sold. CECs 606 may be provided in a forward market, such as an offering of a CEC 606 to a wide audience of potential consumers 542 or producers 668. During a forward market, the future item 624 may be pre-sold. CECs may be offered in a primary market, such as a determined right to a future item. During a primary market, a future item 624 may be built, produced, delivered, and the like. CECs 606 may be offered in a secondary market. During a secondary market, CECs 606 may be re-sold, traded, and the like. A CEC 606 may be offered for future items 624, such as those related to sports 572, travel 574, music 578, games 580, consumer products 582, books 584, services 588, and the like. A CEC 606 may be offered for a dream product, service, event, offering, and the like. For example, a user may want to see U2 play with The Police and will create a CEC 606 proposal for this event. The user may ask other to vote on the proposal so that demand for the event may be gauged. If the contingency that the two artists play together is resolved, the user may be rewarded with a CEC 606, may have an opportunity to purchases CECs 606 before others or at a lower cost, and the like. In an embodiment, the user may reap no additional benefits.

There may be attributes or contingencies associated with the future item 624. For example, an attribute or contingency 514 of a CEC 606 may be that it is offered for a specific team in a sports 572 future item 624. In another example, an attribute of a CEC 606 may be that it is offered for a specific kind of future item 624, such as an event ticket, a book, a digital download, and the like. In another example, a contingency or attribute 644 of the CEC 606 may be its expiration after a certain date. In another example, a contingency or attribute 514 may be the location of the future item 624 associated with the CEC 606. In another example, the contingency or attribute 514 may be how a contingency may be resolved, such as due to an aspect of demand aggregation, the weather, a team standing, and the like.

The CEC 606 may associate forward rights 640 and/or forward obligations 648 with the future item 624. Forward rights 640, for example, may be the right of a CEC 606 holder to purchase or obtain a future item 624, such as consumer product, a consumer service, an event ticket, and the like. Forward obligations 648 may be an obligation on behalf of a CEC 606 holder to purchase or obtain a future item 624, such as consumer product, a consumer service, an event ticket, and the like. In some embodiments, the CEC 606 may comprise a forward right 640, a forward obligation 648, or both. In any event, forward rights 640 and forward obligations 648 associated with a future item 624 may be contingent on an occurrence or outcome, such as the aggregation of sufficient demand for the future item 624. In some embodiments, forward rights 640 and forward obligations 648 associated with a future item 624 may not be contingent on an occurrence or outcome, such as for a determined right to a future item 624. For example, a retailer of an extremely popular gaming system may offer consumers 542 or producers 668 of the trading marketplace 502 the opportunity to reserve the second generation of the gaming system prior to its eagerly anticipated release. In this case, the CEC 606 offers the CEC 606 holder the forward right 640 to purchase the gaming system once it is released without having to worry about the demand and supply issues that would certainly plague conventional consumers of the high demand gaming system. The retailer may or may not additionally associate a future obligation 648 to purchase with the forward right 640. In this example, there may not be a contingency associated with the future item 624 other than the actual product launch as the item may already be in development and there may already be plans to retail the item. In some embodiments, a future obligation 648 may be associated with a future item 624, such as a future purchase obligation, even if the face value of the future item 624 is not yet known. For example, there may be a different face value price for a future item 624 offered to an early adopter, such as a participant in a pre-forward market, versus the price offered to a late adopter, such as a participant in a forward market. In such a scenario, as well as in others that can be readily appreciated by one skilled in the art, the lack of a face value during the forward market may serve as an incentive.

Forward rights 640 may be one-sided or two-sided. For example, a forward right 640 may be granted to a CEC 606 holder to purchase the second generation of a gaming system from a retailer. The forward right 640 is one-sided as only the CEC 606 holder has rights and the retailer must provide the second generation gaming system for purchase to the CEC 606 holder. A forward right 640 may also be granted as a two-sided right. For example, a consumer 542 may be granted a forward right 640 by the retailer in the one-sided rights example above in exchange not for money but for the right to access the consumer 542 for surveys and opinion polls.

Forward rights 640 may be long or short. For example, an offeror of a CEC 606 may have access to the future item 624, such as by owning it, being a distributor or retailer it, being the producer, and the like. Thus, the offeror may have a long position in the future item 624. In some embodiments, the offeror may have a short position in a future item 624, such as when they do not have access to the future item 624 and are simply taking advantage of the opportunity that a contingency may not be met so that the CEC 606 will vest or mature and they will not have to fulfill the CEC 606 by providing the future item 624. In any event, the offeror may be obligated to provide the future item 624 regardless of whether they had access to the future item 624 at the time of offering forward rights 640 to the future item 624.

Forward rights 640 and/or forward obligations 648 may be paid, earned, not paid, and the like. For example, a consumer 542 or producers 668 may participate in a loyalty program with an electronics retailer that may allow them to earn points towards a forward right 640 and/or obligation 648. In the example, a consumer 542 or producers 668 may earn points by obtaining a credit or charge card with the retailer, making purchases from the retailer, making accessory purchases directly related to a future item 624, and the like.

The trading marketplace 502 may be hosted on a host platform 660. The host platform 660 may comprise algorithms 520 such as for pricing methods 654 and staging methods 524, interfaces 528 such as a consumer user interface 530 and a producer user interface 532, and a data facility 534 such as for demand aggregation 622 and trade data 540.

Pricing methods 654 may be used to set a price for a forward right 640 or obligation 648 to a future item 624. Pricing methods 654 may be based on the marketplace. For example, the price may be set initially in a Dutch auction, such as by progressively lowering the price from a high starting point until a participant is willing to accept the price. In another example, the price of forward rights 640 for a future item may be established using pricing methods 654 that are based on power rankings. For example, the price of a forward rights 640 to an NFL game may be based on the power rankings of NFL teams. In another example, pricing of a forward right 640 or obligation 648 may be based on a previous forward market.

In an embodiment, consumers 542 may use a consumer user interface 530 to access the trading marketplace 502. The consumer user interface 530 may be accessed by the web, email, phone, wireless device, television, referrals, and the like. In an embodiment, consumers 542 may be public 544, private 550, individuals 548, groups 552, and the like.

In an embodiment, producers 668 may use a producer user interface 668 to access the trading marketplace 502. The producer user interface 668 may be accessed by the web, email, phone, wireless device, television, referrals, and the like. In an embodiment, producers 668 may be rights holders 558, manufacturers and retailers 560, users 562, and the like. Users 562 may be groups 564, social networks 568, individuals 570, and the like.

Referring now to FIG. 6, an advertisement or promotion 602, further described in Harmon 3 and/or Cella, may include any form of advertisement or promotion 602. For example, in one embodiment of the invention, credits from music downloads may be used for promotional programs such as a sponsor program. Rather than access rights being a feature of who gets to the front of the line, or who ends up getting through on the phone at Ticketmaster, in accordance with the present invention access may be earned, such as through a loyalty program. The advertisement or promotion 602 may alternatively or additionally be described in Cella. Thus, in another embodiment, knowing that a skier might arrive based on a weather contingency, a vendor could target advertising for a host of related products and services, even if the skier doesn't end up purchasing the package.

An alternative right/benefit 604, as further disclosed in Harmon 3, may include a wide range of alternative benefits, such as when users accumulate credits that can be applied toward a purchase of a product or toward purchase of a ticket or entry to an event if it were to be certain.

The contingent aspect 608 of a contingent event certificate 606 or right may, without limitation, be described within or throughout any and all of the documents incorporated by reference herein. This contingency may be associated with a team 610, as described in Cella. For example, among many possibilities, options could be made exercisable based only on the presence of a buyer's designated team in the Super Bowl. A contingency may be associated with a player 621. For example, a fan could purchase a right for a ticket to a particular game if that player was to appear in the game. This contingency may be associated with a venue 614, as described in Harmon 6. For example, contingent event ticket certificates for various events may in the future be scheduled to take place at a designated venue 614. A contingency may be associated with a location 618, as described in Harmon 3. For example, a band may or may not end up playing a given town (that is, rights may be for a specific music event in a given town). A contingency may be associated with weather 620. For example, vendors may offer the same item to different individuals, depending on different tastes for weather-related goods and services. A ski package could be contingent on the presence of snow, for example. In another example, a user may purchase a contingent event certificate for travel contingent upon weather wherein the contingency is if there is snow, the travel is to a ski resort and if there is rain or insufficient snow, travel is to a beach. A contingency may be associated with demand 622 for a future item, as described in Harmon 1. For example, a toy manufacturer may create contingent event certificates 606 for several different lines of toys. Based on demand 622 as determined at least by the number of contingent event certificates 606 sold on a primary market, the toys may be released in time for the holidays. The toy manufacturer may decide to produce certain toys in different quantities (or not at all) based on the demonstrated demand levels. Alternatively, the toy manufacturer may issue a limited number of contingent event certificates 606 for the toys that would entitle and obligate a holder of the contingent event certificate 606 to purchase a first production run of the toy. In this way, the holder of a contingent event certificate 606 would be assured to be able to purchase the toy at a fixed price if the toy is produced. In addition, the toy manufacturer can size the first production run appropriately to ensure every contingent event certificate 606 holder can purchase the toy.

The future item aspect 624 of a contingent event certificate 606 or right may, without limitation, be described within or throughout any and all of the documents incorporated by reference herein. The future item 624 may be associated with sports 628, as described in Harmon 6 and/or Harmon 1. Contingent event ticket certificates 606 may be for various events, such as sporting events. In embodiments, sports fans may themselves be allowed to define a market. For example, a fan may want to see Manchester United play the Spanish National team in the new Miami stadium in 2007. Once this new market is created, a plurality of sports fans (that is, consumers) may purchase the initial allotment and/or trade the contingent event certificates 606. Alternatively or additionally, the future item 624 may be associated with particular contingent combinations associated with sports 628, as described throughout Cella. For example, the participant-event for which an options or futures contract for tickets and/or accommodations may be purchased may be a team-game, team-round, or team-round-game. The future item 624 may be associated with music 630, as described in Harmon 3. For example, advanced music access rights may be created for any unique, recurring or one-time event where the possibility of the event occurring is not assured. Concerts, festivals, operas and any other type of domestic or international music or entertainment events may be contingent events. The future item 624 may be associated with travel 632, as described in Cella. For example, a buyer could purchase an option to purchase a vacation package to a Caribbean island, contingent on the absence of any hurricanes in the Atlantic Ocean one week before the date of departure. The future item 624 may be associated with an accommodation, as described in Cella. For example, a buyer could purchase an option of having a hotel room in a particular city contingent on a particular event occurring in that city, such as a concert, playoff game, political convention, and the like. In another example, a buyer could purchase the option of having a restaurant reservation at a 4-star restaurant contingent upon an event occurring near the restaurant, such as a sporting event, concert, convention, and the like. The future item 624 may be associated with transportation, as described in Cella. For example, a buyer may purchase the option of a flight to a city contingent upon an event occurring in the city, such as a sporting event, concert, convention, and the like. Transportation may include flights, chartered flights, chauffeured limousines, rental cars, trains, buses, yachts, and the like. The future item 624 may be associated with a product launch 634, as described in Harmon 1. For example, a product designer may have a concept for a new type of home appliance. The product designer may offer contingent event certificates 606 that both entitle and obligate the holder to purchase the home appliance. Through promotion of the appliance, demand 622 may be generated based on a description, virtual model, prototype, review, et cetera of the home appliance. The promotion may include information about the offered contingent event certificates 606. The demand 622 resulting from both direct and indirect promotion of the appliance may be assessed by a count of contingent event certificates 606 sold on the forward market. The product designer may use the demand measure to establish contingent agreements for production, distribution, sales, advertising, and support of the appliance. Production may commence once demand 622 reaches a minimum level that may be selected to reduce or eliminate the risk of financial failure. While this example is for a home appliance, the product launch could be for any type of product or service such as a movie, a game, a toy, a book, a composition of music, lawn care service, insurance product, and the like. It will be appreciated that contingent event certificates 606 offered through a forward market can be used to assess the viability of any and all new products or service creations.

The certificate 606 aspect of a contingent event certificate 606 or right may, without limitation, be described within or throughout any and all of the documents incorporated by reference herein. The certificate 606 may be associated with forward rights 640, as described in Cella. For example, disclosed herein is a system for allowing a remote user to purchase, over a distributed computer network (e.g., the Internet), an option to purchase a ticket, goods or services, or other item that is based on a contingent event. The certificate 606 may be associated with a reward 642, as described in Harmon 2. xFor example, in one embodiment, businesses can reward employees with contingent event certificates 606 if a set standard or goal is achieved. It will be appreciated that a certificate 606 may be tradable (or non-tradable) 605, refundable, purchasable, and so on. It will also be appreciated that a certificate may encompass rights, obligations, and/or the like 648. The rights and/or obligations that the certificate 606 encompasses may mature, vest, convert, expire, et cetera. For example and without limitation, the rights and/or obligations may vest as a reward 642 that occurs in response to an occurrence of a predetermined event. The certificate 606 may encompass associated access 644 to something, as described in Harmon 1. For example, each contingent event ticket certificate may correspond to a particular seat within a venue 614. In the case of a personal seat license (PSL), a typical PSL grants the licensee the right to purchase season tickets for a particular seat in the venue 614 every season. A contingent access rights exchange provides a mechanism whereby individuals holding inventory in the form of PSLs may post offers to sell some or all of their holdings, such as subject to a contingency. In other embodiments travel or ski packages (travel, hotel, lift tickets, etc) for spring skiing trips may be optioned.

Harmon 1 relates to a market for trading permanent seat licenses (PSLs), individual event tickets, and contingent event ticket certificates for various events, such as sporting events, concerts, and the like which are scheduled to take place, or may in the future be scheduled to take place at a designated venue. The invention provides both a method of trading such products and an electronic exchange for facilitating such trades.

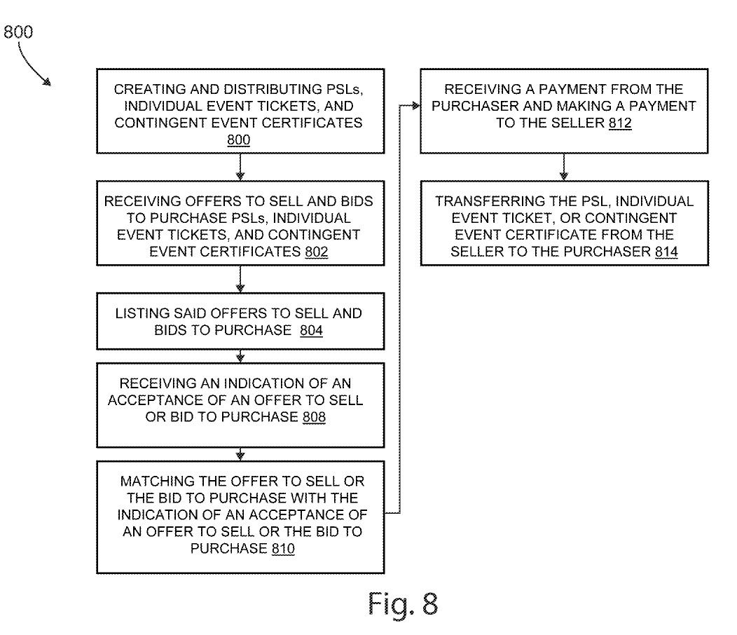

Referring now to FIG. 8, a method is disclosed for trading PSLs, event tickets and contingent event ticket certificates. Step 800 calls for creating and distributing an inventory of PSLs, individual event tickets, and contingent event ticket certificates. Contingent event tickets are a novel product created in accordance with the present invention. A contingent event ticket certificate represents the right and obligation to purchase an event ticket at face value for an event that may (or may not) be scheduled in the future. According to an embodiment of the invention, whoever is the holder of record of a contingent event ticket certificate when the contingent event is scheduled and tickets for the event go on sale is automatically billed for the face value of the ticket. If the contingent event ticket certificate holder has agreed to pay by credit card, the designated credit card account is automatically charged. In order to facilitate electronic trading of PSLs, event tickets, and contingent event ticket certificates, it is preferred that the initial distribution of tickets and contingent event ticket certificates is performed electronically so that a database may be maintained of all tickets and contingent event ticket certificates in the inventory, the current owner of each ticket or contingent event ticket certificate, and an audit trail of all previous owners going back to the ticket's or contingent event ticket's creation. Also in the interest of facilitating electronic trading of PSLs, event tickets and contingent event ticket certificates and maintaining accurate ownership records of such products, it is further preferred that only tickets associated with PSLs are traded on the exchange.

Since each PSL, ticket, and contingent event ticket certificate corresponds to a particular seat within a venue, it is possible to group PSLs, tickets, and contingent event certificates into zones or sections having similar viewing characteristics. A person using the present inventive method or electronic exchange to purchase a ticket may specify a zone in which he or she wishes to purchase a ticket. A ticket for any seat within the specified zone will satisfy a purchase request for a ticket within the specified zone.

Once the PSL, ticket, and contingent event ticket certificate inventory has been distributed, step 802 involves receiving offers to sell and bids to purchase PSLs, event tickets and contingent event ticket certificates. In an embodiment of the invention transactions are settled in real time. Only the actual holders of inventory (PSLs, tickets, and contingent event ticket certificates) can place offers for sale, while any member of the exchange can place bids to purchase. However, other trading rules are possible where a party not holding inventory may be allowed to offer PSLs, tickets or contingent event ticket certificates for sale as long as he or she makes good delivery of the sold products at a specified time and in a specified manner.

Step 804 calls for listing the received offers to sell and bids to purchase inventory. In order to limit confusion and increase the efficiency of the market, not every offer and bid need be displayed. For example, the current market rate for PSLs, tickets or contingent event ticket certificates may be quickly surmised from the best bid and best offer for a particular zone. The most recent transaction for a PSL, ticket or contingent ticket in a given zone may also give further guidance as to the current market price.

Step 808 involves receiving an indication either from a purchaser indicating that he or she accepts one of the listed offers to sell, or from a seller indicating that he or she accepts one of the listed bids to purchase. The party who posted the accepted bid or offer is matched to the party who indicated an acceptance of the bid or offer in step 810. A payment is received from the purchaser and a payment is made to the seller in step 812. Finally, the inventory that is the subject of the transaction, be it a PSL, an individual event ticket (or tickets), or a contingent event ticket certificate (or certificates), is transferred from the seller to the purchaser in step 814.

In addition to the method of trading PSLs, individual event tickets, and contingent event tickets just described, the present invention further encompasses an exchange for trading PSLs, event tickets and contingent event ticket certificates according to the method just described, such as the herein described exchange, trading marketplace 502 and contingent event certificate or rights market 682, 900.

Buyers approach the exchange with no inventory but with cash in hand to make purchases. The buyers may post bids to purchase inventory on the exchange. Typically such a posting would include a description of the inventory the buyer wishes to purchase and the amount the buyer is offering to pay. For example, a buyer may post a bid for four zone 18 tickets for an August 10 doubleheader, offering to pay $20.00 per ticket. The seller's offer to sell the tickets at $40.00 and the buyer's bid to purchase the tickets at $20.00 are listed on the exchange and are visible to all participants in the exchange, both buyer and sellers. Thus, a market price is established somewhere between $20.00 and $40.00 per ticket for a set of four tickets in zone 18 for the August 10 double header between Team A and Team B.

In addition to listing their inventory for sale at a specific price above the current market price, sellers may alternatively chose to accept a buyers' bid to purchase tickets at the buyer's bid price. So, for example, if a seller sees a buyer's $20.00 bid and decides that it is close enough to what he or she willing to accept for the tickets, the seller may accept the offer. Of course, other sellers who may also have inventory equivalent to that being offered by the first seller (i.e., four tickets in zone 18 for the August 10 doubleheader between Team A and Team B), may under cut the first seller's original $40.00 offering price by either offering to sell their inventory at a lower price, or by accepting a buyer's lower bid price.

A similar process is at work on the buyers side of the exchange. Buyers may place bids to purchase tickets at prices below those currently offered by the sellers, or buyers may accept sellers listed offers. If a buyer sees a seller's $40.00 per ticket offer and decides that her or she is willing to pay that amount to attend the event, the buyer may accept the seller's offer. Of course, other buyers may also want to attend the August 10 doubleheader and beat the first buyer to the punch by either accepting the first seller's $40.00 per ticket offer, or by posting a bid for four zone 18 tickets at a price higher than the $20.00 per ticket offered by the first buyer.

Once an offer or bid is accepted the exchange matches the buyer with the seller. Preferably this function is transparent to the parties using the exchange. The buyer and seller deal only with the exchange, never directly with one another. The exchange receives a payment from the purchaser in at least the amount agreed upon in the transaction (an additional transaction servicing fee may also be required to support the exchange). Likewise, the exchange may make payment to the seller in an amount up to the price agreed upon the transaction. (Again, a transaction servicing fee may be required, and the seller's payment reduced accordingly.) To complete the transaction the inventory being sold must be delivered from the seller to the exchange and from the exchange to the purchaser.

As will be described more fully below, an embodiment of an exchange according to the present invention may be completely electronic. PSLs, event tickets, and contingent event ticket certificates along with ownership records, and the records of exchange participants, and provisions for making and receiving payment are all stored on a database. In this embodiment the act of physically delivering the inventory to the exchange and from the exchange to the purchaser is not required. Nor are the steps on making and receiving payments. Instead, the ownership records of the inventory records are changed to reflect the new owner, and credit card accounts may be charged for payment and credited for sales.

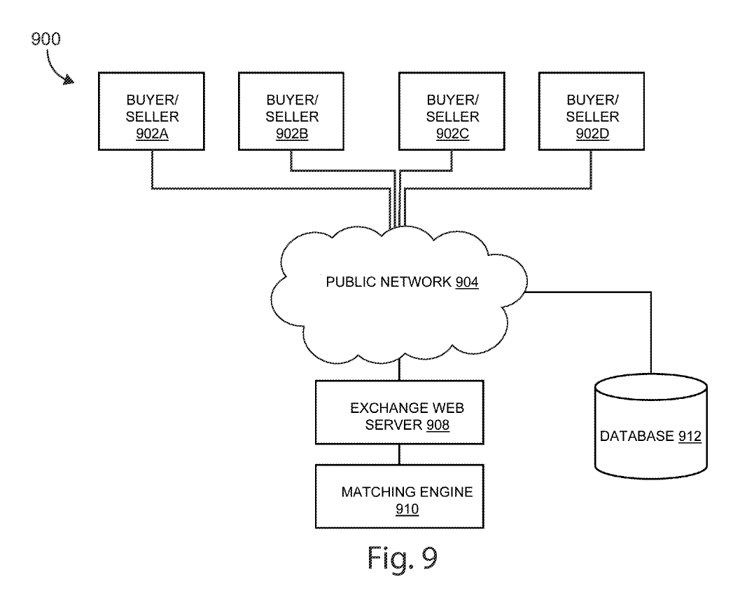

FIG. 9 shows a block diagram of a network-based exchange for trading PSLs, individual event tickets, and contingent event ticket certificates according to an embodiment of the invention. The exchange 900 includes a number of user terminals 902a, 920b, 902c . . . 902n linked to a ticket exchange web server 908 via a public network 904 such as the World Wide Web. Web server 908, in addition to being connected to public network 904 is functionally connected to exchange software 910 for matching offers and bids with indications of accepting offers and bids, and a database 912 which maintain records of PSLs, tickets and contingent event ticket certificates, who owns them, and how they are traded.

According to an embodiment of the invention only tickets associated with PSLs may be traded on the network-based exchange. In this embodiment the tickets associated with the PSLs are wholly creatures of the virtual exchange environment. When an individual purchases a PSL (preferably through the exchange after having registered with the exchange) a record is created in the database 912. If the PSL is not purchased through the exchange, a record of the PSL must be created and stored in the exchange database. When the licensee purchases his or her season tickets each season according to his or her rights under the PSL, the database is updated to reflect this additional inventory. Each individual ticket for each scheduled event is represented in the database and a record of its current owner (initially the PSL licensee) is also stored.

Individuals who do not own PSLs, but who are interested in purchasing tickets on the exchange must first register with the exchange. A database record is created for each registered member of the exchange. As registered customers and inventory holders make purchases and sales, their records are updated to reflect their newly acquired or depleted inventory. Furthermore, a record of each transaction is recorded each time inventory changes hands. Thus, each PSL, event ticket or contingent event ticket certificate will have a complete audit history associated with it so that each owner and each transaction can be identified at a later time. Like PSL owners, customers who have purchased inventory on the exchange may also trade their holdings. Thus, a “ticket” may change hands (virtually) several times before it is finally printed and actually used to gain access to an event.

Contingent event ticket certificates may be treated in a similar manner, or they can be distributed entirely independently of PSLs. In a first alternative, contingent event ticket certificates are created with the season ticket packages purchased by the PSL licensees each season. Thus, in the arrangement the PSL owner is the owner of record for all contingent event ticket certificates associated with the licensed seat at the beginning of each season. For example, a PSL licensee having a license to purchase season tickets for a baseball team's home games would also obtain 11 contingent event ticket certificates, three for the Divisional Playoff series games (assuming a best of 5 series), four for the League Championship series and four for the World Series, assuming a best of 7 format for the league championship series and world series. These are the maximum number of possible post season home games if the team enjoys home field advantage in each series and each series extends to the maximum number of games. Of course, the actual number of contingent events scheduled at the team's home venue may actually be much less than 11 depending on the team's performance.

Another alternative for initial distribution of contingent event ticket certificates is to offer PSL licensees a right of first refusal to purchase contingent event ticket certificates. If the PSL licensee does not exercise his or her right to purchase the corresponding contingent event ticket certificates, they may be offered for sale to the highest bidders in an on-line auction conducted on the exchange 900.

Finally, contingent event ticket certificates may be offered directly to all registered members of the exchange 900. According to this alternative, contingent event tickets are offered in an open auction. Bidding may be scheduled for a set period of time and the member offering the highest bid at the close of bidding is awarded the contingent event ticket certificate for which he or she is bidding in exchange for the winning bid price.

A note should be made here regarding the payment mechanisms for contingent event ticket certificates. Obviously, if the contingent event ticket certificates are included in the season ticket packages of PSL licensees, the PSL licensee may be charged for the contingent event ticket certificates when he or she pays for his or her season tickets. The same is true if the PSL licensees are offered a right of first refusal to purchase the contingent event ticket certificates. In the open auction model, however, since members of the exchange may be required to submit a valid credit card number to join the exchange, the credit card account of the highest bidder may be automatically charged the bid amount immediately upon the close of bidding. The purchasing member's inventory record may then be updated to reflect the newly purchase contingent event ticket certificate.

A similar automatic credit card transaction can be established to take place when contingent event ticket certificates mature into actual event tickets, such as when a team becomes eligible for post season play. Typically an announcement will be made as to when post season event tickets (playoff or championship series games and the like) will go on sale. This date, or some other arbitrary date, can be established as the date on which contingent event ticket certificates for a contingent event which is subsequently scheduled mature into actual event tickets for the newly scheduled event. Whoever is the holder of a contingent event ticket certificate on the specified date is charged the face value of the newly scheduled event ticket. Likewise, the inventory record of the owner of the contingent event ticket certificate will be updated to reflect that he or she then owns an actual event ticket rather than a contingent event ticket certificate.

Referring again to FIGS. 5 and 6, the certificate 606 may be associated with a right and obligation 648, as described in Harmon 6. For example, a contingent event ticket certificate 606 may represent the right and obligation to purchase an event ticket at face value for an event that may (or may not) be scheduled in the future. The certificate 606 may be tradable 650, as described in Harmon 1. The certificate 606 may be digital 652, as respectively described in Harmon 6 and Harmon 1. For example, in order to facilitate electronic trading of contingent event certificates 606, it is preferred that the initial distribution of contingent event certificates 606 is performed electronically. The act of physically delivering the inventory to the exchange and from the exchange to the purchaser is not required. Nor are the steps of making and receiving payments. Instead, the ownership records of the inventory records are changed to reflect the new owner, and financial accounts may be charged and credited for purchases and sales accordingly.

Pricing 654 that is associated with a contingent event certificate 606 or right may, without limitation, be described within or throughout any and all of the documents incorporated by reference herein. At least one example of this is provided in Harmon 1, where it is noted that the current market rate for contingent event certificates 606 may be quickly surmised from the best bid and best offer for a particular zone of a ballpark.

A contingent event certificate (or rights) market 682 may be associated with a platform 658, which may, without limitation, be described within or throughout any and all of the documents incorporated by reference herein. The platform 658 may be associated with a host 660. The platform 658 may be associated with fulfillment 662, which may be electronic (as described hereinabove with reference to a digital 652 certificate 606) or physical.

Participants 600 may comprise providers or suppliers 664, such as and without limitation producers 668, as generally described in Harmon 6. For example, a merchant supplier may be the party that offers to produce a particular consumer product item in the event a demand threshold is obtained through the sale of forward rights.

Participants 600 may comprise related/integrated markets 670, which may be described within or throughout any and all of the documents incorporated by reference herein. The markets 670 may comprise a secondary contingent event certificates or rights market 672. For example, in embodiments a neutral third party may centralize market-related data and provide a marketplace where access rights can be liquid. In embodiments the present invention further encompasses an exchange for trading contingent event ticket certificates. In a preferred embodiment of the invention the exchange holds the inventory of items being traded. The items being traded may be intangible items such as contingent event certificates 606. The markets 670 may comprise a rights market 674, as described in Harmon 3. For example, credits may convert to a ticket or “full forward” right that is liquid and tradable on the rights market 674. Since full rights can be traded, a market could be run well in advance of the anticipated future item. The markets 670 may comprise a rights resale market 678, as respectively described in Harmon 6. For example, once a PSL, ticket, or contingent event ticket certificate inventory has been distributed, embodiments of the present invention involve receiving offers to sell and bids to purchase PSLs, event tickets and contingent event ticket certificates. In an embodiment of the invention transactions are settled in real time. In a preferred embodiment of the invention the exchange holds the inventory of items being traded. The items being traded may be intangible items such as event tickets, or simply access rights. The markets 670 may comprise a primary contingent event certificate or right market 682, such as involving a method for trading contingent event certificates 606.

The platform 658 may be associated with a user interface 619 for communication with consumers.

A contingent event certificate 606 or right may be combined 688 with one or more other contingent event certificates 606 or rights in a contingent event market platform. Combining 688 contingent event certificates 606 or rights may facilitate providing access to a future item for a plurality of contingent event certificate 606 or right holders. A combination of contingent event certificates 606 or rights may facilitate improving the chances that a holder of the combined contingent event certificates 606 or rights will remain obligated to exercise one of the contingent event certificates 606 or rights. Contingent event certificates 606 or rights may be combined 688 such that a failure of one contingent event certificate 606 or right may be the contingency required for a second contingent event certificate 606 or right to mature.

Contingent event certificates 606 or rights may be combined 688 such that the holder or holders of the combined contingent event certificates 606 or rights may exchange the certificate at a reduced cost. This may be compared to purchasing a single ticket versus purchasing a “group rate” quantity of tickets. The single ticket may be more costly than one of the group rate tickets because the purchaser of the group rate ticket is obligated to purchase a minimum number of tickets. Contingent event certificates 606 or rights may be combined 688 to form a group that may qualify for a group rate cost. To illustrate this, an exercise cost for a single mature (contingency met) contingent event certificate 606 or right may be $100 whereas a combination of contingent event certificates 606 or rights may result in a cost to exercise each contingent event certificate 606 or right in the combination that may be $85. The contingencies for each contingent event certificate 606 or right in the combination may be the same, such that all of the combined contingent event certificates 606 or rights mature together.

Contingent event certificates 606 or rights may be combined to facilitate improving the chances that at least one of the combined contingent event certificates 606 or rights will mature and be exercised. This may be beneficial to a holder of combined contingent event certificates 606 or rights who wishes to improve the likelihood of attending an event, obtaining a consumer product, being offered a service, and the like. While the future item may be the same for each combined contingent event certificate 606 or right, the contingencies may be different. A combination of contingent event certificates 606 or rights may cover a plurality of contingencies such that if any of the contingencies is met, the holder may exercise the mature contingent event certificate 606 or right. For example, a combination of contingent event certificates 606 or rights may cover an event that is contingent upon weather conditions, such as an outdoor concert. The combination may include a contingent event certificate 606 or right that is contingent upon clear weather, another may be contingent on rain, and yet another may be contingent upon snow. The contingent event certificate 606 or right contingent on clear weather may include an open-air lawn seat. The contingent event certificate 606 or right contingent on rain may include a seat in a covered pavilion; and the contingent event certificate 606 or right contingent on snow may include an indoor seat in a heated building. This combination provides a variety of contingencies for one event.

The cost to exercise and/or the number of contingent event certificates 606 or rights available for each of the contingency may be different. For example and without limitation, the venue 614 may include X number of indoor seats each with an exercise price of $100, 4X pavilion seats each with an exercise price of $85, and 10X open air lawn seats each with an exercise price of $40.

A combination of contingent event certificates 606 or rights may be associated such that the failure to mature of one of the contingent event certificates 606 or rights in the combination becomes a contingency for another contingent event certificate 606 or right in the combination to mature. This allows a market maker of contingent event certificates 606 or rights for a future item to manage the total number of contingent event certificates 606 or rights to mature such that this number does not exceed the number of available seats. In our example the combination contingent event certificate 606 or right that is contingent on rain will not mature if the weather is clear, thereby only allowing the contingent event certificate 606 or right contingent on clear weather to mature. The holder of this combination contingent event certificate 606 or right may be obligated to purchase the open-air lawn seat.

An alternative combination of contingent event certificates 606 or rights may facilitate a holder of the combination to attend one of two or more contingent events. As an example, a combination of contingent event certificates 606 or rights for a Major League baseball playoff game may include a contingency based on the venue 614 in which the game is played. Continuing the example, a contingency for two contingent event certificates 606 or rights may be that a team, such as the Mets, participates in the playoff game. The first contingent event certificate 606 or right in the combination may also include a contingency that the game be played in the Mets home stadium, whereas the second contingent event certificate 606 or right in the combination may include a contingency that the game be played in the opponent's home stadium. A similar combination may include a first contingent event certificate 606 or right of the combination on the Mets playing the playoff game at home and the second contingent event certificate 606 or right of the combination may include a contingency that another team (the Yankees) plays in the playoff game at home. This combination may allow a holder to exercise only one of the combined contingent event certificates 606 or rights. The Yankees playoff game contingent event certificate 606 or right would not mature if the Mets playoff game contingent event certificate 606 or right matures. It should be appreciated that these combinations of contingent event certificates could apply to the previously disclosed broad range of forward rights to things well beyond live events such as consumer products, consumer services, and various forms of the arts such as movies. Many other such examples will be appreciated and all such examples are within the scope of the present disclosure.

An offering related to a contingent event certificate 606 or right may include disclosure of information 690 about the related offer only if the contingency matures. Withholding the information 690 about the related offering may facilitate increased flexibility of the provider of the related offer in fulfilling the related offer for a mature contingent event certificate 606 or right. An example includes an offer for hotel accommodations related to a contingent event certificate 606 or right. The related offering information 690 available prior to the contingent event certificate 606 or right maturing may be limited to a class of hotel, a geographic area, and the like. Upon maturing, the related offer provider may determine a specific hotel based at least in part on an aspect of an agreement to provide lodging the provider has made with one or more hotels in the class or geographic area.

A related offering may include a secondary contingency that must be met in addition to the contingent event certificate 606 or right contingency. As an example, the contingent event certificate 606 or right contingency may include a seat at a Mets home playoff game. The related offering may include a contingency that depends upon the holder of the mature contingent event certificate 606 or right providing information 690 such as personal information and/or demographics to the related offer provider to receive the related offering.

A contingent event certificate 606 or right may be combined 692 with other rights. The other rights may be associated with a future item. The other rights may be related in time with the future item. The other rights may facilitate the holder of the mature contingent event certificate 606 or right accessing a future item. In the example of an event, the rights may include one or more of parking privileges, transportation to the venue city, transportation to the venue, transportation to a hotel in the venue city, transportation (such as taxi, trolley, limousine, town car, bus, train, and any other mode of transportation) among two or more locations associated with the venue 614. The rights may include use of venue facilities, admittance to event associated parties, social network events, meet and greet with the participants of the event, and so on. The rights may include goods and services such as items associated with the event. The contingent event certificate 606 or right may be combined with rights related to lodging. For example, a holder of a mature contingent event certificate 606 or right may, in addition to purchasing a seat at the contingent event may also purchase a hotel room near the venue 614 at a predetermined price (such as a discounted price).

The contingent event certificate 606 or right may be combined 692 with other rights such as the right to sell the contingent event certificate 606 or right before or after maturing. The contingent event certificate 606 or right may be combined 692 with rights to purchase other contingent event certificates 606 or rights at a predetermined price. For example, a holder of a contingent event certificate 606 or right for a next generation gaming system, if the contingent event certificate 606 or right matures, gain the right to purchase a contingent event certificate 606 or right for a sequel to a video game compatible with the next generation gaming system at a predetermined price. In another example, a holder of a contingent event certificate 606 or right for a first round NBA playoff game may, if the contingent event certificate 606 or right matures, gain the right to purchase a second round NBA playoff game contingent event certificate 606 or right at a predetermined price. Many other such combinations 692 of a contingent certificate or right with another right will be appreciated and all such examples are within the scope of the present disclosure.

A contingent event certificate 606 or right may obligate the holder to make a purchase at a future time 694, perhaps when the contingent event certificate 606 or right matures. A contingent event certificate 606 or right may mature at a time 694 when the contingency associated with the contingent event certificate 606 or right is met such that it is no longer contingent. In effect, a contingent event certificate 606 or right becomes an event certificate when the contingency is no longer in question. In an example, a future item may include a seat at a second round NBA playoff game. The contingency may include a specific team, such as the Boston Celtics, participating in the game. A contingent event certificate 606 or right for this contingent event may be sold or traded anytime up until the event. However, the contingent event certificate 606 or right remains contingent until it is known with absolute certainty that the Boston Celtics will participate in the second round NBA playoff game. At some time 694, it may be determined that the Celtics have satisfied the requirements established by the NBA to participate in the game. Specifically this may include having a regular season and first round playoff win-loss record that is better relative to at least some other teams in the regular season and first round playoffs. When the Celtics have met all the criteria as defined by NBA, the contingent event certificate 606 or right may mature and be known as an event certificate or ticket.

However, the contingent event certificate 606 or right may expire when the Celtics do not win enough regular season games to participate in the playoffs, or if the Celtics are eliminated in the first round of playoffs from further contention, or if the Celtics are eliminated in the second round of playoffs before the event. This last expiring condition may occur if the contingent event certificate 606 or right is for a 4th game in a best of 5 game series and the series is completed in three games.

A contingent event certificate 606 or right may be contingent 608 upon an aspect of a sporting event. For example, a user may want to see a particular American League baseball team play a National League baseball team regardless if it is a post-season game or not. If the match-up is announced, the contingent event certificate 606 or right may mature. In another example, a contingency of a CEC 606 may be that a particular player joins a team, a particular team plays in a specific city, a team makes the Wild Card slot, and the like. In another example, a user may want to see a specific player in a championship, such as Roger Federer in the US Open. If Roger Federer survives the bracket and makes it into the US Open, the contingent event certificate 606 or right may mature.

A contingent event certificate 606 or right may be contingent 608 upon the timing 694 of an event. For example and without limitation, two contingent event certificates 606 or rights may be issued as rain checks for a rained out baseball game before the rain date has been set. Both may be contingent 608 upon the timing 694 of the game on the rain date, with one certificate or right maturing if the rain date is set for a day game and the other maturing if the rain date is set for a night game. Similarly, the timing 694 may relate to whether the rain date is a weekday, weekend, holiday, and so forth. Many other such examples of timing 694 will be appreciated and all such examples are within the scope of the present disclosure.

A contingent event certificate 606 or right may be associated with an advertisement 602. The holder of the certificate or right may be entitled to view, receive, produce, transmit, et cetera an advertisement 602 if and when a contingency becomes defined. For example and without limitation, two advertisers may each purchase a contingent right for a television-advertising slot. The first advertiser may be interested in advertising sunglasses when the forecast is for sunny weather. The second advertiser may be interested in advertising goulashes when the forecast is for rainy weather. The advertisers may purchase the contingent rights in advance of the forecast being known for the time of the slot. When the weather forecast becomes known, one of the rights may mature and the other may expire, depending upon forecast and the contingent right. Many other such examples related to advertising 602 will be appreciated and all such examples are within the scope of the present disclosure.

A future item 624 associated with a contingent event certificate 606 or right may be an event such as a performance, competition, or other participatory event; a product launch; a service offering, and the like. The future item 624 may alternatively be associated with a publication 601. The future item 624 may be associated with the publication 601 of one or more publications. The contingent event certificate 606 or right may be contingent upon a time associated with the publication 601, a release, an availability, and the like. For example, a contingent event certificate 606 or right may entitle a holder to purchase a copy of a first printing of a publication 601 upon its release. In this example, a holder of a contingent event certificate 606 or right may be obligated to purchase the first printing of a new book immediately upon release. In this way, the publisher may be motivated to make the first printing knowing that the holders of the contingent event certificate 606 or right for this future item 624 will be obligated to purchase the publication 601 at a predetermined price. The holder of the contingent event certificate 606 or right may be willing to acquire this contingent event certificate 606 or right so that they know they have the right (as well as the obligation) to purchase the first printing of the publication 601.

Music 630 and reunions of certain musical groups hold a great attraction for many people. A contingent event certificate 606 or right that could entitle a holder to a copy of the first distribution of a new recording of a reunited musical group may also be popular and generate interest in the reunion. Determining the likelihood that a reunion and recording would be economically viable may be difficult. Proceeding with the reunion and recording may present personal challenges to the band members as well as financial risks to the band, their promoters, recording label, and the like. The musical group and those who may be taking a risk related to the reunion and recording may use contingent event certificates 606 or rights as a measure of the reward potential of a reunion and recording. Additionally, the musical group may receive some income from the sale of contingent event certificates 606 or rights that may be used to pay for some of the recording related costs before the recording is complete.

A contingent event certificate 606 or right provides a holder with certain rights that may be related to a future item 624 associated with the contingent event certificate 606 or right. The rights may relate to a future purchase associated with the future item 624. The rights, being related to a future item 624, may not be exercisable until a contingency associated with the future item 624 is satisfied. If the contingency is not satisfied, the rights may expire.

The contingent event certificate 606 or right may represent an agreement between the holder of the contingent event certificate 606 or right and a provider of the future item 624. Therefore the future item provider may also have rights associated with the contingent event certificate 606 or right. The future item provider may have the right to receive compensation from the holder of a mature contingent event certificate 606 or right in exchange for the ticket, seat, or other good or service to which the holder of the contingent event certificate 606 or right is entitled.

In addition to rights related to a future item, a holder of a contingent event certificate 606 or right may have other rights such as the right to sell or exchange the contingent event certificate 606 or right through a contingent event certificate or right market platform 658 as herein described.

A contingent event certificate 606 or right may facilitate a business rewarding one or more employees if a set standard or goal is achieved. A contingency for a contingent event certificate 606 or right may include achieving the set standard or goal. In this way a business can use a contingent event certificate 606 or right to provide a reward to an employee contingent on the employee or the business achievement.

As an example, a business may provide contingent event certificates 606 or rights to a work team of employees, consultants, contractors, officers, and participants of the work team. The contingent event certificate 606 or right may provide the work team a right to a future item contingent on the work team achieving a set standard or goal. The work team may be charged with producing a prototype of a new product. The future item may be a night out on the town that is contingent upon the prototype's being produced before a deadline. If the team produces the prototype by the deadline, the contingent event certificate 606 or right may mature such that the contingent event certificate 606 or right would entitle the holder to the night out on the town.

A contingent event certificate 606 or right may include a plurality of associated future items, such as access to a season of events. The plurality of associated future items may be contingent on an acceptance of an agreement related to the future items. The plurality of future items may be contingent on a plurality of contingencies. Examples of a contingent event certificate 606 or right including a plurality of associated future items includes a season of lawn care services, a sports team season ticket for all home games, a pass to all concerts in a concert tour, a pass to all opening nights at an opera house for a season, and the like. The plurality of future items may include certain terms that a holder of a contingent event certificate 606 or right must agree with before the holder may redeem a mature contingent event certificate 606 or right. Such a term may include a ban on smoking at the event venue. In another example, the associated event may be a party on the lawn within a concert. For example, a user may purchase a contingent event certificate 606 for a block of lawn seats to a Jimmy Buffett concert with the contingency that the concert be located in Foxboro, Mass. If the concert is scheduled to be in Foxboro, Mass., the user may be obligated to purchase the block of lawn seats, but may also have the opportunity to hold a party on the lawn during the concert. In an embodiment, the opportunity to have a party may be sold as a separate contingent event certificate 606 or may be sold as part of the seats' contingent event certificate 606.

A contingent event certificate 606 or right that may include a plurality of associated future items may be split up by a holder of the contingent event certificate 606 or right into subsets of the associated future items such as individual future items. Such a split may facilitate the holder of the contingent event certificate 606 or right for a plurality of future items to sell or exchange one or more contingent event certificates 606 or rights for the subset of future items. However, a contingent event certificate 606 or right for a plurality of future items may be restricted from being split thereby obligating the holder or holders to exchange the contingent event certificate 606 or right for the plurality of future items as a whole.

A plurality of future items for a contingent event certificate 606 or right may be contingent on a plurality of future items. As an example, a plurality of future items may include a seat at each home playoff game of a sports team. The plurality of future items is contingent on the team reaching the playoffs and then continuing to win in the playoffs such that further home games may be played. If the team does not make the playoffs, the contingent event certificate 606 or right for the plurality of home playoff games expires. Likewise if the team fails to advance beyond the first home playoff game, the contingent event certificate 606 or right would expire.

A contingent event certificate 606 or right may be tradable such as through exchange or sale on a contingent event certificate or right platform 658, or by exchange with the event producer or event ticket provider for another event. However, a contingent event certificate 606 or right may be non-tradable 605.

As an example, a contingent event certificate 606 or right for a future event may occur at a time when a holder of the contingent event certificate 606 or right is traveling out of the country and cannot attend the event. The holder may wish to exchange the certificate for another event they can attend. However, the certificate may obligate the holder to make a purchase associated with the event, and therefore the event producer may not accept the contingent event certificate 606 or right in trade for another event ticket or contingent event certificate 606 or right. Yet the holder of the contingent event certificate 606 or right may sell or exchange the contingent event certificate 606 or right through the contingent event certificate 606 or right platform, effectively transferring the purchase obligation to a new holder.

A contingent event certificate 606 or right may include security features 609 and may provide a secure form of agreement between the holder and the future item producer. To ensure an agreement between a holder of a contingent event certificate 606 or right and future item producer is secure, a contingent event certificate 606 or right platform facilitator may require a potential buyer or holder of a contingent event certificate 606 or right to provide critical information such as credit cards and the like to secure the holder's obligation to make a purchase if the contingent event certificate 606 or right matures.

The contingent event certificate or right platform 658, and the contingent event certificate 606 or right itself may be secure and protected from malicious intent of others. The contingent event certificate 606 or right may include a serial number that is associated with the holder of the contingent event certificate 606 or right such that only the holder of the contingent event certificate 606 or right may authorize sale, exchange, or redemption of the contingent event certificate 606 or right.

Sports fans, music fans, NASCAR fans, and fans in general often collect and/or trade memorabilia. A contingent event certificate 606 or right may be associated with such memorabilia. A contingent event certificate 606 or right may be provided to a holder in a collectible 611 format such as a framed certificate. In this way, even an expired contingent event certificate 606 or right may be collectible 611.

A contingent event certificate 606 or right may include a collectible item. A contingent event certificate 606 or right for a collectible item may include a contingency associated with the collectible item. For example, a contingent event certificate 606 or right for a collectible item may entitle a holder of the contingent event certificate 606 or right to an autographed photograph of New England Patriots quarterback Tom Brady if the Patriots win the National Football League title game. In this example, the collectible item is the autographed photograph, and the contingency is the Patriots winning the title game.

Advertisers 613 may be associated with contingent event certificates 606 or rights. Advertisers 613 may be associated with an event of a contingent event certificate 606 or right. Advertisers 613 may be associated with a contingent event certificate or right platform 658. Advertisers 613 may be associated with the sale, exchange, and redemption of a contingent event certificate 606 or right. Advertisers 613 may provide a producer of a contingent event certificate 606 or right with compensation to be associated with the contingent event certificate 606 or right. For example, an advertiser of bicycling equipment may pay a producer of a contingent event certificate 606 or right for attendance to the Tour de France to allow the advertiser to promote bicycling equipment in association with the contingent event certificate 606 or right. This may come in the form of an internet ad campaign, advertisements 602 on a website of the contingent event certificate or right platform 658, print or other media indicating a sponsorship or promotion of the contingent event certificate 606 or right.

Advertisers 613 may also provide promotions to holders of contingent event certificates 606 or rights. An advertiser may, through coordination with a contingent event certificate or right platform 658 facilitator, gain access to a list of holders of contingent event certificates 606 or rights and may offer a promotion to the holders that may be associated with the future item. For example, an advertiser of tennis equipment may promote a tennis racket with custom markings associated with a tennis event to holders of contingent event certificates 606 or rights for the tennis event. Since the holders of the contingent event certificate 606 or right may already have a strong interest in the tennis event (and therefore may know about tennis), they may be more likely to respond positively to such an offer.

Producers 668 may be associated with contingent event certificates 606 or rights. Producers 668 may include merchant suppliers who may have originally proposed the particular future item associated with the contingent event certificate 606 or right. A producer 668 associated with a contingent event certificate 606 or right may include an entity, individual, or group who may hold rights related to the future item. Such an example includes an investor in the future item, a participant in the future item, an owner of a venue 614, an owner of a participating team 610, and the like. A publisher may be a producer 668 for a future item related to publishing such as a release of a new book. A consumer product company like Apple Computer or a consumer services company like AIG Insurance may be a producer 668 for an event related to the production of consumer products and consumer service offerings. In addition to sports participants, musicians, artists, manufacturers, distributors, retailers, service providers, and others may also be associated with a contingent event certificate 606 or right. An artist may receive a base portion of sales of contingent event certificates 606 or rights for an event that they are participating in. In addition the artist may receive other compensation based upon a contingency such as the number of contingent event certificates 606 or rights sold or the average sale price of a contingent event certificate 606 or right in a predetermined period of time.

Suppliers 664 associated with a contingent event certificate 606 or right may include manufacturers. Suppliers 664 of product launches 634 may be associated with a contingent event certificate 606 or right. A manufacturer may accept an obligation to deliver a product by a predetermined date and may receive a contingent event certificate 606 or right that is contingent on them fulfilling the obligation. In an example, a manufacturer may commit to producing 100,000 new games by October 15 to ensure they are available in retail outlets in time for holiday purchases. In exchange for this commitment, the manufacturer may receive a contingent event certificate 606 or right that may allow the holder to receive a portion of sales revenue for the new game. If the manufacturer meets the production commitment, the certificate may mature and the manufacturer may receive the portion of sales revenue. If the manufacturer does not meet the production commitment, the certificate may expire.

A producer 668 that is associated with a CEC 606 may include a content producer such as and without limitation an entity, individual, or group that may produce content or hold rights related to the production of content. Numerous types of content will be appreciated including, without limitation, content that is audio, video, multimedia, interactive, web based, text based, document based, digital, executable, interpretable, user generated, and so on. For example and without limitation, in embodiments the producer 668 may encompass an individual who produces an online video. A user of a social network may suggest the production of an online video. In response to this, the producer 668 may associate himself with that request and may offer to produce the online video contingent upon a certain number of users committing to view the video and a commercial that would be distributed along with the video. This commitment may be embodied as a CEC 606. Alternatively, the producer 668 may produce the online video contingent upon a certain number of users committing to purchase a copy of the video.

A market for a contingent event certificate 606 or right may be related to or integrated 670 with other markets such as financing markets 615. Related or integrated markets 670 may facilitate securing the underlying interest or security on which the contingent event certificate 606 or right value is initially established. If a contingent event certificate 606 or right is for a sporting event, such as a college bowl football game, or a consumer product or service, a related financing market 615 may be established to purchase (or guarantee to purchase) a plurality of event tickets or, in other examples, to facilitate manufacture and distribution of the product or provision of the service.

A related or integrated financing market 615 may provide a means for individuals, entities, and the like to participate in the open market sale and exchange of contingent event certificates 606 or rights without requiring a purchase or exchange of a contingent event certificate 606 or right. Participation in a related or integrated financing market 615 may allow a financing expert to identify a financing model that provides the level of security with upside potential that may facilitate receiving the necessary financial backing to establish the market for the contingent event certificates 606 or rights.

Financing sources for such a related or integrated market include venture capital, traditional banking, third party private lending, and any combination of these and other financing sources that may facilitate reducing risk to any of the combined financing sources. Venture capital may be a source of financing for establishing and maintaining the contingent event certificate 606 or right platform. Venture capital may also be a source of financing for continual financing event purchases to enable the establishment of the market. Traditional banking may also be included as a financing source in a related or integrated financing market. Traditional banks offer short term and long term interest rates to customers. Typically a short term investment produces a slightly higher interest rate than a long term investment. Financing associated with a contingent event certificate 606 or right may facilitate a traditional bank offering customers a short term base interest rate and a variable rate based on the value of contingent event certificates 606 or rights held by the bank.

A bank may offer its customers a contingent event certificate 606 or right for doing something such as signing up for on-line bill payment for example.

Finances to purchase or guarantee purchase of a plurality of one or more items associated with a future item (such as a product, a subscription, a ticket, a meal, a hotel room, and the like) may be provided by a variety of financing vehicles. These financing vehicles may include debt instruments such as loans, convertible securities that may have one or more conversion terms, revenue sharing agreements, and other vehicles as may be used to provide an investor a way of providing financing.

A convertible security may include providing financing in exchange for one or more options by which the inventor providing the financing is to be reimbursed. A conversion option may include converting at least a portion of the security to an ownership in the event, the contingent event certificate 606 or right platform, or the like. In an example, a holder of a convertible security may exchange repayment for the current event for a repayment of a future event. This convertible security may allow a holder of the security to continue to defer repayment. An objective of such a conversion option may be to allow the contingent event certificate 606 or right platform to continue to make purchases and issue new contingent event certificates 606 or rights with the potential of the holder of the convertible security to earn even greater return on their initial investment. The conversion option may facilitate converting at least a portion of current repayment to future repayment.

Financing vehicles may also be combined in contingent event certificate or right related/integrated markets 682, 670. A combination of vehicles may facilitate reducing a financial risk associated with the market for contingent event certificates 606 or rights. In an example, a debt instrument, providing repayment on a schedule at a fixed rate of interest may include a risk of default independent of the success of the contingent event certificate 606 or right offering. However, by combining a debt instrument with a revenue sharing agreement, a lender of a debt instrument may receive some portion of revenue of the contingent event certificate 606 or right offering which may mitigate the default risk.

A project financing market 615 related to a contingent event certificate 606 or right may be future item-based. Aspects of the financing market 615 may be dependent at least in part on the type of future item. A future item that may be cancelled, such as an outdoor concert, may impact a financing market differently than a future item such as a sports championship. The differences between these two types of future items may be reflected in the level of risk, and therefore the required reimbursement terms, of a related financing market for the future item. In an example, a concert by a single performer, such as Britney Spears, may have a measurable risk of being cancelled. A single performer may get sick, or may be delayed in travel, or may have personal problems that keep her from performing on any given night. Such an event has a quantifiable risk of being cancelled. This risk may be factored into the terms an investor may require for investing in a contingent event certificate 606 or right offering for the event and the investor may expect higher interests, a greater portion of revenue, and/or revenue from other of the performer's events.

A group event, such as a sports championship is unlikely to be cancelled, especially due to one person's physical or emotional health. In such an event, a financing market 615 may have different terms such as lower interest rate but higher revenue sharing as the chance of cancellation is nearly zero. Other events, such as product launches, tournaments, TV productions, theatre productions, movie premieres may have risks associated with the event but may be unlikely to be cancelled. A movie premiere may go on even if the star of the movie is not available to attend the premiere. While this risk may be factored in, and one or more contingent event certificates 606 or rights may include this as a contingency, the financing market 615 may be impacted differently.

Financing markets 615 for season based contingent event certificates 606 or rights (contingent event certificates 606 or rights for a plurality of associated events), may include financing to holders of mature contingent event certificates 606 or rights. Perhaps due to the typically larger cost of a season ticket compared to a single event ticket, a financing market 615 may be established in which the holders may borrow money to purchase the season tickets when the contingent event certificate 606 or right matures. The financing market 615 may include paying the venue producer for the season ticket and receiving reimbursement from the holder of the mature contingent event certificate 606 or right through a debt instrument or the like.

In an example of a season based contingent event certificate 606 or right, a mature contingent event certificate 606 or right may entitle (and obligate) the holder to purchase a season subscription to lawn care services. In another example of a season based contingent event certificate 606 or right, a mature contingent event certificate 606 or right may entitle (and obligate) the holder to purchase a season ticket to the Boston Symphony 2005-06 performance season. A financing market 615 for a season based contingent event certificate 606 or right may include a lender purchasing the season ticket and providing a ticket to individual BSO performances when the holder has made sufficient payment to the lender. If the holder does not make sufficient payment to the lender, the lender may do as they see fit with the ticket.

A project financing market 615 may be associated with a contingent event certificate 606 or right and may be based at least in part on an aspect of a seat at an event. An aspect of the seat may include a seat license, a season ticket for the seat, or a seating block related to the seat. The seat may be a single seat or a plurality of seats such as a block of seats (e.g. section 601 of the TD BankNorth Garden). A contingent event certificate 606 or right may include an obligation to license a seat associated with a venue 614 of the event.

A seat license may be financed through a secondary market that may include promoters, business entities, and others desiring a financial interest in the seat license. In an example, a contingent event certificate 606 or right may provide a holder with access to a seat that requires a license to use the seat and amenities such as parking passes, private entrance, lounge areas and the like. A seat license may also allow the licensee to have first right of refusal for a ticket for the licensed seat to all of the events held at the venue. A financing arrangement may include providing financing for the seat license in exchange for access to at least some portion of the events held at the venue. The holder of a contingent event certificate 606 or right that includes a seat license may agree to allow a financier of the seat license to have access to one-half of the tickets available to the holder.

A project financing market 615 associated with a contingent event certificate 606 or right may facilitate providing financing based at least in part on a venue 614 for an event. Venues 614 that may be associated with a project financing market 615 may include sports stadiums (e.g. baseball, basketball, football, soccer, rugby, and the like), golf courses, tennis stadiums, ski slopes, Olympic venues, race track (auto, dog, horse), arena, field, pitch, concert hall, theatre, lecture hall, retail stores, retail outlets, bookstores, and the like. Owners, mortgage holders, investors, and the like of one or more of these venues 614 may participate in a project financing market 615 to facilitate selling out events held at the venue 614. Such entities may wish to provide financing to one or more contingent event certificate 606 or right offerings to increase the probability that the amount of revenue they receive associated with the venue 614 may include sources other than ticket sales.

Referring again to FIG. 6, a market for a contingent event certificate 606 or right may be associated with a secondary 672 market 670 for a contingent event certificate 606 or right. Participants 600 such as financial participants and market participants in a market for contingent event certificates 606 or rights may access a secondary contingent event certificate or right market 670 through a user interface 619. The user interface 619 may allow a participant to post contingent event certificates 606 or rights on the secondary market for purchase, exchange, trade, or auction through a contingent event certificate 606 or right offer screen.

The user interface 619 may also allow a financial participant to monitor postings on the secondary market by viewing a certificate of authenticity of the contingent event certificate 606 or right. The user interface 619 may also allow a participant to place a bid for a contingent event certificate 606 or right and perform a transaction such as purchasing the contingent event certificate 606 or right on the secondary market.

A secondary contingent event certificate 606 or right market may include expired contingent event certificates 606 or rights. A participant user interface to a secondary contingent event certificate 606 or right market may include a listing of contingent event certificates 606 or rights available including a status of each contingent event certificate 606 or right (expired, contingent, mature). A secondary contingent event certificate 606 or right market may be integrated with a contingent event certificate 606 or right market to facilitate status updates and trading or exchange of CECs 606.

A user interface 619 between participants 600 and a project financing market 615 may facilitate a participant 600 determining the financing alternatives associated with the contingent event certificate 606 or right such as those associated with the product launch, service offering, service provider, the venue 614, the seat, the event, financing sources, and financing vehicles. In an example, a contingent event certificate or right market participant 600 may use a user interface 619 to view a listing of available financing alternatives and the type of contingent event certificate 606 or right for which they are eligible.

A project financing market user interface 619 may allow a financial participant of a contingent event certificate 606 or right market to view financing offers, compare financing scenarios, distribute request for financing a contingent event certificate 606 or right offering.

A project financing market user interface 619 may facilitate a project financier reviewing and interacting with the current financing of an ongoing contingent event certificate 606 or right offering. The user interface may include controls to facilitate releasing quantities of contingent event certificates 606 or rights to the marketplace.

Participants of a contingent event certificate 606 or right market may use a user interface 619 to facilitate viewing seat alternatives that may be associated with a mature contingent event certificate 606 or right. The user interface 619 may allow a participant to view a seating chart of a venue 614 and select at least one seat, section, area for purchase of a contingent event certificate 606 or right. The user interface 619 may allow a participant to experience the view angles from a particular seat or block of seats. The user interface 619 may allow a user to select the seat through the contingent event certificate or right market website or through a venue provider's website and be offered a contingent event certificate 606 or right that best fits the selected seat.

Participants of a contingent event certificate 606 or right market may use a user interface 619 to facilitate viewing a consumer product prototype that may be associated with a CEC 606. The user interface 619 may allow a participant to review proposed specifications, see different views of the prototype, learn more about the advantages of the product, and the like. The user interface 619 may allow a user to select a prototype of a consumer product through the contingent event certificate or right market website or through a producer's website and be offered a contingent event certificate 606 or right that best fits the selected prototype.

A participant 600 of a contingent event certificate or right market 682 may use a user interface 619 to select and or define an assignee to which a contingent event certificate 606 or right would be assigned if the contingent event certificate 606 or right matures. This aspect of a contingent event certificate 606 or right market user interface may facilitate affiliates or brokers 619 who may bid on one or more contingent event certificates 606 or rights but assign them to a third party that has made an agreement with the broker or affiliate to purchase the mature contingent event certificate 606 or right.

A participant user interface 619 of a contingent event certificate or right market 682 may facilitate access to related websites such as the venue website, the team or teams participating in the contingent event, a product retailer, a social networking website, a service provider website, and many others that may be related to the future item or a sponsor of the future item.

A financial or market participant user interface 619 of a contingent event certificate 606 or right market may facilitate a holder of a contingent certificate making a selection to post a CEC 606 to a rights resale market if the contingent event certificate 606 or right matures. The selection may be made by the participant as a condition of acceptance of the participant's bid. It may be made at the time a bid for the contingent event certificate 606 or right is accepted, or it may be made upon receipt of payment for the CEC 606.

An advertiser 613 may use a user interface 619 to access the contingent event certificate or right market platform 658. The advertiser 613 may use the user interface 619 to perform a transaction with the platform such as paying for placement of an advertisement 602. The advertiser user interface 619 may also facilitate the advertiser 613 accessing demographics of holders of contingent event certificates 606 or rights. An advertiser 613 may also use the user interface 619 to enable the back end production of new future items that reach a pre-established threshold of demand. Advertisers 613 may also use the user interface 619 to author new proposals for future items, such as consumer products and services. In an embodiment, the proposal may only be distributed in a limited fashion, such as to the advertiser's 613 employees so that new future items may be nominated by the advertiser 613 for production, distribution, and retail to a wide audience.

Advertisers 613 may also use a user interface 619 to a contingent event certificate or right market platform 658 to review contingent event certificate 606 or right offering sale and exchange performance related statistics. The advertisers 613 may use demographic and contingent event certificate 606 or right offering performance information to provide targeted advertisements 602 to participants of the market.

Producers 668 may interact with a contingent event certificate or right market platform 658 through a user interface 619. The user interface 619 may facilitate an event producer's 668 releasing allocations of contingent event certificates 606 or rights to be sold or exchanged through the market platform 658. In an example, a producer 668 may choose to manage releases of contingent event certificates 606 or rights over time to maintain interest in the future item and to provide participants the opportunity to purchase a contingent event certificate 606 or right.

The producers 668 may also use the user interface 619 of the contingent event certificate 606 or right market to identify rules associated with the contingent event certificates 606 or rights. The producers 668 may use the user interface 619 to monitor contingent event certificate 606 or right activity such as transaction rates, fees, sale prices, and the like.

Producers 668 may also use the user interface 619 of the contingent event certificate 606 or right market to price future item proposals. For example, if a producer 668 nominates a new toy, and wants it produced by a backend toy producer, the producer 668 may need to “presell” a threshold number of the toy. However, the producer 668 may need to give the price for the toy to the offerees. As a single inventor, the producer 668 may not be able to price the toy so the backend toy producer would have to look at the concept, estimate the retail value, and likely “approve” the proposal before it is released into the market or social network. Producers 668 may have a “review” and “approval” process for future item proposals before they get generally released into the market or social network.

Employees, loyalty club members, fan club members, season ticket holders, registered users, pre-selected users, pre-qualified users, or others closely associated with a producer 668 may be identified through the producer user interface 619 such that the platform 658 provides them an offer of a contingent event certificate 606 or right in advance of a public offering of the contingent event certificates 606 or rights. In essence, this may be a private market prior to opening the CEC market 682 to a wider audience. For example, as a registered user of CBS Sportsline, users may have a window of time, such as for 48 hours, to purchase CECs 606 for the Final Four prior to the general public.

Producers 668 may use the user interface 619 to coordinate demand 622 associated with the contingent event certificate 606 or right offering and/or the future item. A producer 668 may identify a threshold, such as a threshold of contingent event certificate 606 or right offer transaction activity, and may use the user interface 619 to establish this threshold in the platform 658. For example, the threshold may be associated with a demand 622 for a new children's toy. The producer 668 may use the user interface 619 to receive an alert if the threshold is exceeded. The producers 668 may then use the user interface 619 to manage one or more aspects of the contingent event certificate 606 or right offering.

A participant 600 of a contingent event certificate or right market 682 may associate a contingent event certificate 606 or right he/she is holding with a social network facility 616, which may provide, comprise, encompass, or otherwise be associated with social networking website. A user interface 619 for the social network site may allow a user to enter a link to a listing on the contingent event certificate or right platform 658 of the contingent event certificate 606 or right the user currently has to offer.

A contingent event certificate market platform 658 may be hosted on a computing facility, such as and without limitation a server. The host 660 may be a computer system that provides services to other computing systems and clients over a network, such as a local area network, wide area network, wireless network, intranet, the Internet, or the like. The server may be a computer system that operates continuously on the network and provides full-time access to the contingent event certificate market platform 658. The host 660 may provide a facility for an application server, database server, file server, client-server, or the like. The host 660 may provide hardware and/or software in support of the hosting of the contingent event certificate market platform 658. Host 660 hardware may include a central processing unit; input/output (I/O) facilities, such as keyboards, displays, disk drives, modems, network cards, or the like; memory, such as RAM, ROM, or the like; mass memory, such as optical discs, hard disks, or the like; or other such computer hardware. Host server software may include system software, program software, application software, business software, databases, or the like.

The host 660 may provide software-based services for users of the contingent event certificate market platform 658 that may provide personalized access capabilities, which may be adapted for consumers, event producers, manufacturers, distributors, retailers, service providers, advertisers, social network interfaces, related/integrated markets, or the like. Users may have customized access to host services of the contingent event certificate market platform 658 through a web portal, where access may be dependent upon the type of user, such as a username/password customer interface for contingent event certificate 606 transactions, a secure access for producers 668, customer service access for advertisers 613, or the like. The host 660 may provide access to data storage for users of the contingent event certificate market platform 658, such as user information, billing information, event information, contingent conditions, certificate tracking of ownership and price, or the like. The host 660 may also provide facilities for providing tickets or contingent event certificates 606 to users, system security, internationalization and technological interface to users, or the like.

The contingent event certificate market platform 658 may provide for a facility to fulfill user orders (fulfillment 662), and send the user a physical document in the form of a contingent event certificate 606, event ticket, receipt, voucher, product, or the like. The document may be printed and physically mailed to a user-specified shipping address, bought at a ticket window or box office, printed at a store by a store employee, printed at a kiosk by the user, or the like. The document may include a facility for identification and authentication of the document by ID number, barcode, magnetic stripe, password, biometrics, or the like. The document may have an element for securing against counterfeiting, such as special paper, treatments to the paper, intricate artwork, holograms, or the like. The contingent event certificate market platform 658 may allow for the transfer of ownership of the contingent event certificate 606. Transfer of ownership may be performed on-line, by phone, at a ticket window or box office, at a store, a kiosk, or the like. Transfer of ownership may result in a new contingent event certificate 606 identification number being generated, and a new document sent to the new owner. Fulfillment 662 of contingent event certificate 606 orders may also take other forms, such as a pass card, a discount pass, a club card, a season pass, or the like. The document may have the facility to add or subtract contingent event certificate 606 registrations, interface with a computational facility, scanned for entrance to an event, or the like.

The contingent event certificate market platform 658 host 660 may comprise a facility for storing data. Data may include user information, billing information, product information, service offering information, event information, contingent conditions, certificate tracking of ownership and price, or the like. Data may be stored local to the contingent event certificate market platform's 682 host 660, such as within the same physical memory space as applications software, operating software, or the like. Data may be stored remote from the contingent event certificate market platform's 682 host 660, such as in a separate memory, separate computer resource, content delivery networks, content distribution networks, or the like. Data stored in the contingent event certificate market platform 658 may be accessible by customers, social networks, advertisers 613, producers 668, related/integrated markets 670, or the like. Access to data within the contingent event certificate market platform 658 may require authentication, such as a username, password, security code, or the like. Data may also continually change to reflect changing event information, pricing, threshold demand levels, contingent changes, or the like.

The contingent event certificate market platform 658 may provide security against risks associated with computer use. Techniques for reducing risks to computer security associated with the contingent event certificate market platform 658 may include providing backups, anti-virus software, firewalls, access control lists, authorization and authentication software, encryption, intrusion-detection systems, or the like. Backups may be a continuous or scheduled activity within the system, and may provide for the copying of data so that these additional copies may be restored if the originals are damaged or lost. Anti-virus software may include computer programs that attempt to identify, thwart, and eliminate computer viruses and other malicious software. Firewalls may help protect the contingent event certificate market platform 658 from intrusions by restricting network traffic, which may be based on a set of system administrator defined rules. Authorization may restrict access to the contingent event certificate market platform 658 to a group of users, such as customers, registered users, manufacturers, distributors, retailers, service providers, event producers, contingent event certificate market platform 658 employees, or the like. Restrictions may be accomplished through the use of authentication systems. The contingent event certificate market platform 658 may employ encryption to protect messages, or intrusion-detection systems that scan the network for unauthorized users and activities.

The contingent event certificate market platform 658 may provide internationalization of user interfaces 619 such as language translation, currency conversion, location-based services, or the like. The contingent event certificate market platform 658 may provide for a user interface 619 that includes access to the system through a plurality of languages, language translations, translator services, or the like. Languages may include English, Spanish, German, French, Portuguese, Italian, Japanese, Russian, Chinese, or the like. The contingent event certificate market platform 658 may provide for a user interface 619 that includes access to currency conversion. Currencies may include the US dollar, Canadian dollar, Euro, Pound, Yen, Ruble, or the like. Currency conversion services may be associated with the currency of the user. For instance, a user that has selected German as their user interface language may cause the contingent event certificate market platform 658 to choose the Euro as the default currency for the exchange, with alternate currencies made available as selected by the user.

The contingent event certificate market platform 658 may provide for location-based services, such as a service based on cell phone location, IP address, user self-entry, internet service provider location, event location, or the like. An example of a location-based service may be a user placing a phone call from a cell phone in Italy for an event located in Italy. The contingent event certificate market platform 658 may set a priority for Italian as the user interface language because of the location of the user and the relevance of an event located in Italy. The contingent event certificate market platform 658 may also provide for alternative languages for the user to choose from, for example, in the instance of an English speaker visiting Italy, and attempting to acquire tickets to a show in Italy as a part of the English speaker's vacation. The contingent event certificate market platform 658 may also provide for a default currency based on a future item location, such as the peso being selected as the default currency based on the future item's bring produced, offered, or taking place in Mexico City.

The contingent event certificate market platform 658 may be accessed through the Internet from a plurality of sources, such as a computer, PDA, phone, mobile phone, cellular phone, GSM phone, network client device, or the like. The computer may be used to connect to the Internet, for example, using the computer's internet browser the user may connect to the contingent event certificate market platform 658 though the user's internet service provider. The user may also be able to connect to the contingent event certificate market platform 658 through the browser of the user's mobile communications facility, such as through the user's PDA, mobile phone, cellular phone, GSM phone, or other network client device known to the art. For example, a user of a cell phone may use the Internet connectivity of their cell phone to connect to the contingent event certificate market platform 658 through their wireless provider's distributed communications facility and Internet gateway.

The contingent event certificate market platform 658 may be accessed through the telephone system, such as from a phone, a mobile phone, cellular phone, GSM phone or the like. A user may place orders for contingent event certificates 606, trade contingent event certificates 606, schedule events, arrange for advertisements 602, or the like. Wireless providers may offer customers special access promotions to contingent event certificate's 606 and other products which customers access via cell phones. For example, a wireless provider may provide a discounted service that can only be accessed though their wireless service. Another example may be a wireless provider reserving special access to blocks of reserved tickets.

User interfaces 619 to the contingent event certificate market platform 658 may include and/or be associated with a social network facility 616 (the “social networks”). Social networks may be communities that in some part utilize the Internet as an element of their social organization. Examples of social networks may be MySpace, Friendster, Facebook, Gaia Online, orkut, Piczo, Yahoo! “360,” or the like. Internet social networks may be formed through an initial set of founders who invite members to join their site. New members may repeat the process, growing the total number of members and links in the network. Sites may offer features such as automatic address book updates, viewable profiles, the ability to form new links through introduction services, or other forms of online social connection known to the art. Social networks may also be organized around other connections such as ethnic groups, entertainment media, schools, services, business, age groups, sports, games, travel, technologies, dating, or the like.

Social networks may utilize a blended networking approach that may combine online activities with offline elements, such as face-to-face events. Examples of this blended approach may be MySpace, that associates its online activity to independent music and party gatherings, or Facebook that associates with activity within the college community. Social networks on the Internet may also be focused on specialized activities such as art, tennis, football, soccer, golf, cars, dog owners, or the like. These networks may provide a virtual extension of a groups' activities such as sharing photos, video, stories, planning, group rates, or the like. Internet social networks may also provide specialized interfaces to outside activities that are associated with the social network's focus. An example of this may be an Internet social network focused on football that interfaces with sport fan clubs, fantasy football leagues, online sports reviews, ticket suppliers, or the like. Social networks may also enable the distribution of user generated content proposals. For example, a social network member may receive a user generated content proposal from a member of her social network then forward it on to her social network with an associated comment, request, or the like.

The contingent event certificate market platform 658 may have an interface with Internet social networks, which may be depicted as an association between the social network facility 616 and the platform 658. These social networks may have specialized interfaces with the contingent event certificate market platform or 682 be the result of social interaction within the social network. The interface between the contingent event certificate market platform 658 and the social network may include selection of existing buy and sell options, monitoring of personal buy and sell status, viewing of existing events, initiation of a contingent event certificate 606 for a new future item, the initiation of a contingent event certificate 606 for a future item that has already received other contingent event certificates 606 but is not an actual future item yet, monitoring of the aggregation of demand 622 for a future item, or the like. The interface may be implemented as an exchange between the social network's host servers and the contingent event certificate market 682 platform's 658 host 660 as a special interface between the two networks or a general interface such as with any other customer.

A future item being produced may be contingent upon the demand 622 that is aggregated for the future item through contingent event certificate 606 generation and the threshold for demand 622 set for the future item to be produced. An individual customer may participate directly in the contingent event certificate or rights market 682. Alternatively, an individual may participate in the market 682 through the interface or association between the social network facility 616 and the contingent event certificate market platform 658. Individuals may have an interface to the contingent event certificate market platform 658 through social networks such as MySpace, Friendster, Facebook, Gaia Online, orkut, Piczo, Yahoo! 360, or the like. For instance, the Internet social network MySpace has online associations to independent music and party gatherings, and may provide an integrated interface to the contingent event certificate market platform 658. A MySpace member may initiate a contingent event certificate 606 for a new fashion magazine with a targeted editor and targeted columnists, and monitor the aggregation of demand 622 for the magazine. This aggregation of demand 622 may generate interest from an editor or columnist who then may set a demand threshold for enabling the magazine to be produced.

The demand aggregation process may be a dynamic interaction between customer demand 622 for a given future item, and the future item producer's required demand threshold to enable the future item to be produced. An Internet social network member may generate a contingent event certificate 606 for a future item that is not yet available, such as a video game from Electronic Arts, a music concert, a meeting of an artist, a match-up between sports teams, a lecture by a famous individual, or the like. Members of the Internet social network may then purchase contingent event certificates 606 for the future item and thereby aggregate demand 622 for the future item. Demand 622 for the future item, in the form of contingent event certificate 606 purchases, may be communicated to management facilities for relaying to supply future item producers. A producer 668 may in turn set a demand threshold for the future item to be produced, such as 20000 CECs for the new video game, Bob Dylan requiring a demand of 10,000 contingent event certificates 606 for a concert at Red Rocks, Colo., or the physicist Stephen Hawking requiring a demand of 2,000 contingent event certificates 606 for a lecture at Albert Hall, London, or a 1970's punk rock star requiring 100 contingent event certificates 606 to come to a large party to meet the guests, or the like.

In an embodiment, a future item 624 for which demand 622 may be aggregated may be a digitally simulated performance. The digitally simulated performance may be a pre-recorded performance, an animated performance, a holographic performance, a spliced performance, a combination thereof, and the like. For example, a digitally simulated performance may be a video performance of a living performer singing with a deceased performer. The recording may be made by editing pre-existing images of a performance by a deceased performer to manipulate and modify the background of the pre-recorded performance. Manipulations may be done with any video editing technique, such as rotoscoping. Rotoscoping may allow an editor to trace around the deceased performer and digitally separate the background from the performer. Manipulating the background of the deceased performer may facilitate placing the deceased performer into a new environment or in front of a new background, such as one similar or identical to a living performer's environment. The pre-recorded, digitally simulated performance may comprise at least a portion of a recording of the living performer coordinating their performance with at least a portion of the recording of the deceased performer. The two recordings may be edited together to arrive at the pre-recorded digitally simulated performance. For example, a living performer may match a deceased performer's tempo, volume, pitch, energy, and the like in order to give the appearance that the two performers are singing together. During recording of the living performer's performance, the living performer may glance over at a position the deceased performer may occupy in the final digitally simulated performance in order to give the appearance that they were both present at the recording. To enhance the appearance that the living and deceased performer may be performing together, a body double may be included in the recording of some angles of the living performer's performance. In an example, the final digitally simulated performance may comprise the digitally manipulated video image of a deceased performer singing a song; the recording of a living performer singing the same song, wherein the living performer may appear to be singing with the deceased performer by matching certain qualities of a deceased performer's performance and by generally acting as if the deceased performer is present at their performance; and, optionally, a recording of certain camera angles with a body double. In some embodiments, such as for when the digitally simulated performance may be intended for a television audience of a program for which there may be a live studio audience, camera angles with a body double may be acquired during a live performance of the living performer with a body double and spliced in to a pre-recorded simulated performance. Other examples of digitally simulated performances may be an editing together of more than one performance by living performers, deceased performers, animated performers, any combination thereof, and the like.

In an embodiment, the digitally simulated performance may be a holographic performance. The holographic performer animations may be projected using any holographic projector, such as a video 3-dimensional projector system (e.g.: the Musion Eyeliner System). The 3-dimensional projector system may enable freeform 3-dimensional holographic moving images to appear within a live event stage setting. Additional technology may be used to enhance the holographic effect, such as illusionary techniques (e.g.: Peppers Ghost technology). In some embodiments, a plate glass and special lighting techniques may be used to make holographic objects seem to appear or disappear, or make one holographic object seem to “morph” into another. Holographic performer animations may be projected onto transparent film placed on a stage, creating the appearance that performers are actually present on the stage. In embodiments, a holographic performance may be accompanied by a live performance. For example, the holographic performance and the live performance may be timed so that it appears that a live performer is performing with a holographic performer.

Demand 622 for a digitally simulated performance may be aggregated as described herein. A demand aggregation facility may provide an interface, such as a web site or web page that may include screens that a user or future item provider may use to request a digitally simulated performance be produced in response to obtaining, from users, digitally simulated performance-related commitments (such as and without limitation pre-orders for digitally simulated performance-related downloads and/or items). A user may access the demand aggregation facility directly or may be brought to the demand aggregation facility by linking to it from another website, such as a website for a performer, a fan club, a production company, and the like.

Once a contingent event certificate 606 is obtained, either by being purchased, earned, or at no cost, it may be sold or traded prior to the future item being produced. The selling and trading of contingent event certificates 606 may be facilitated within the contingent event certificate market platform 658, such as with FanForwards, or within a secondary market place. FanForwards may be a way of buying and selling contingent event certificates 606 within the controlled environment of the contingent event certificate market platform 658. If the demand threshold for a future item is met, then the future item may be produced and purchasers of contingent event certificates 606 may be obligated to purchase the future item, such as a proposed consumer product, a subscription to a new service offering, a ticket to an event, and the like. If the demand threshold is not met, the holders of the contingent event certificates 606 may, or may not, receive refunds for the cost of their contingent event certificates 606, if in fact the CEC 606 was paid for and not obtained free of charge. The process of aggregation of demand 622 may drive a future item from being contemplated, such as an idea for a book, to being produced, offered, scheduled, or populated, such as publication of the book, and finally fixed for sale or, in the example of the book, shipped to contingent event certificate holders. Once the future item is fixed, contingent event certificate 606 holders may be able to purchase the actual item. If demand 622 does not reach demand threshold, no future item may be produced. During the process of demand aggregation, a secondary market place may allow contingent event certificate 606 holders to financially profit from the selling of contingent event certificates. For example, a forward market may be closed after a certain period of time or reaching a threshold of demand aggregated so that trading of forward rights on a secondary marketplace may begin.

Producers may register within the contingent event certificate market platform 658 or be contacted by a management facility in order to be made available for producing. Producers may include manufacturers, distributors, retailers, service providers, musicians, celebrities, lecturers, sports figures, entertainers, or the like. A producer may specify conditions under which they will produce a future item, such as if a certain minimum amount of money is guaranteed; if a particular authors writes the forward to a proposed book, if an event is in a certain location, date, venue 614; if there is a guaranteed number of performances per year; or the like. The producer may contractually bind themselves to these specified conditions, and monitor the demand aggregation for their services using the contingent event certificate market platform 658 user interface. The producer may have the option to accept conditions outside the initially specified conditions. For instance, if an event performer had originally specified New York City as the only location they would be willing to perform in, but monitors the demand 622 and observes a demand 622 for them to perform in different city, they may have the option to accept the new location and enable the performance to take place.

A facility for measuring and tracking the demand 622 for future items may be provided within the contingent event certificate market platform 658. The facility may provide for monitoring of demand 622 by individual customers, members of an Internet social network, event performers, event and event performer management facilities, manufacturers, distributors, retailers, service providers, or the like. The user interface may be sorted by demand, genre, such as music concerts, lectures, meet the celebrity, or the like; performers; locations, such as New York City, Boston, London, or the like; date; venue 614; and other like variables to be sorted. Since demand is a function of contingent event certificates 606, security measures may also be taken to ensure the validity of each contingent event certificate 606, such as supplying digital tags to each contingent event certificate 606.

Users may receive certain benefits as members of loyalty clubs of event performers and future item producers. A user may enroll in a club and purchase products associated with an event performer, future item, or future item producer, such as music downloads, tee-shirts, mugs, jewelry, accessories, books, or the like, from the club website. The user may earn loyalty points for each purchase, for carrying a retailer credit card, for serving on an opinion panel, for referring the producer to their friends, and the like. The loyalty club may offer contingent event certificate 606 promotions to users in possession of a certain number of points, or to the user with the greatest number of points, where the contingent event certificate 606 may be made available for purchase or given freely as a loyalty reward. In turn, the user in possession of the contingent event certificate 606 may sell the contingent event certificate 606 within a trading facility within the contingent event certificate market platform 658, in a secondary marketplace, within the loyalty club, or the like. For example, Best Buy may have a loyalty club where points are awarded for having a Best Buy consumer credit card, for purchasing electronic devices, for purchasing extended warranties, for using the Geek Squad service, and the like. Best Buy may offer a reward to those loyalty club members above a certain threshold number of points, such as advanced access to the new version of the iPod nano.

In embodiments the methods and systems disclosed herein may be associated with an exchange, such as a contingent access rights exchange or a contingent event certificate exchange, which contingent event certificates are offered, issued and/or exchanged. The contingent event certificate exchange may allow exchange of contingent event certificates, as well as exchanges of other related items, such as tickets, whether issued by an issuer or a service provider for an issuer, or exchanged in a secondary market, such as between purchasers.

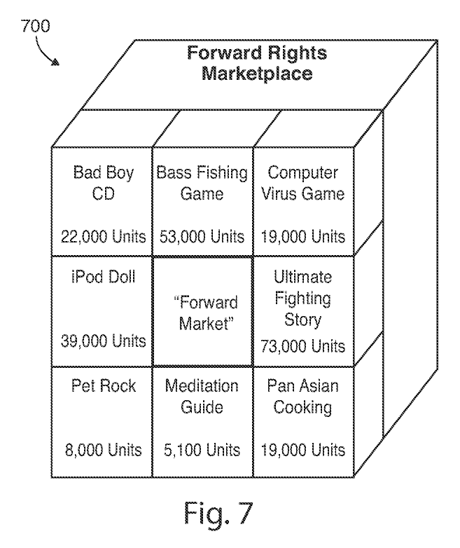

Referring to FIG. 7, a forward rights and/or obligations marketplace may support the forward markets, and demand aggregation of forward rights and/or obligations, for many different kinds of future items, such as a Bad Boy CD, a bass fishing game, a computer virus game, an iPod doll, an Ultimate Fighting story, a pet rock, a meditation guide, a pan-Asian cooking guide, and the like.

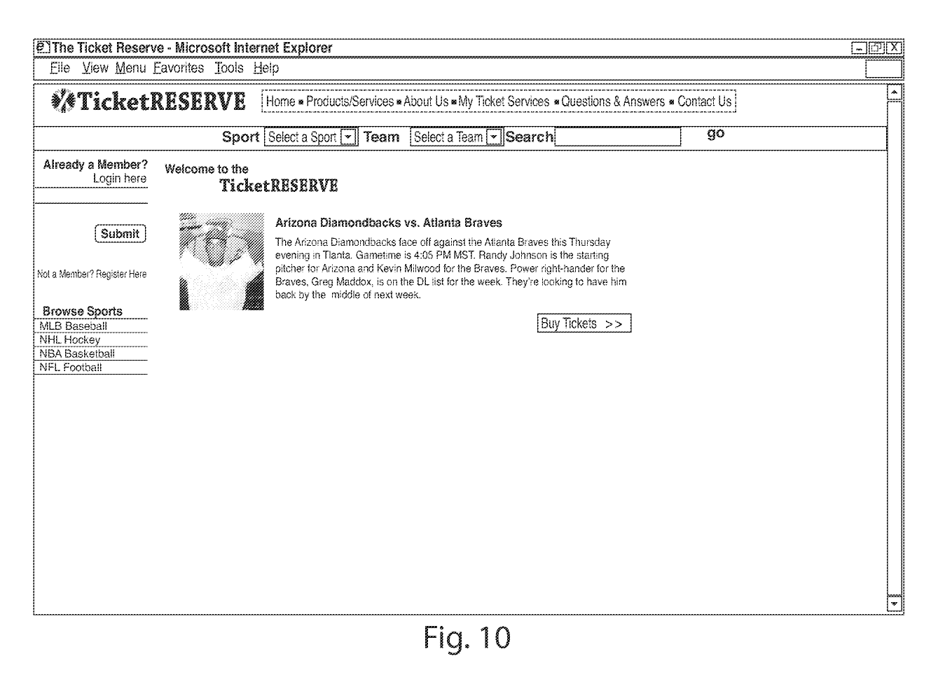

Next, referring to FIGS. 10-26 a graphical user interface for interacting with a network based electronic exchange according to the present invention will be described. The graphical user interface may be a World Wide Web based application which is downloadable from an exchange web server as a series of web pages. The web pages forming the graphical user interface may be displayed by a conventional web browser on one or more of the customer terminals.

There are a number of different kinds of users who may access the network based electronic exchange. For example, PSL licensees having excess inventory they wish to sell (e.g., event tickets for events the licensee will be unable to attend), aspiring brokers and others desiring to speculate on ticket prices who are willing to purchase and sell inventory without having any intention of actually attending a particular event, and simple fans who want to get the best possible price for tickets to attend a particular event, but who are unable to purchase event tickets in the primary ticket market.

A first scenario will be described wherein a PSL licensee accesses the electronic exchange to sell excess inventory, namely tickets to an event which are associated with one or more PSLs. A next scenario will be described wherein a trader, someone who wants to buy and sell event tickets for profit, purchases the event tickets from the PSL licensee described above. Finally, a fan's purchase of the tickets offered by the broker will be described. Upon completing the transaction, the fan will print out a pair of ticket coupons for his or her own use, and send another pair of tickets to a friend. It should be noted that the parties described in the transactions below are not fixed in their roles. Fans may purchase some tickets for the purpose of attending the underlying event, or they may plan on trading some of their holdings. Brokers, in addition to buying and selling tickets may also attend some of the events and PSL holders may buy and sell additional tickets which are not associated with their PSLs, and may also actually attend events.

When a customer first accesses the exchange, a login page shown in FIG. 10 may be sent to the customer's computer and displayed by the customer's web browser. The login page may include user name and password data entry fields for allowing the customer to log on to the exchange by entering his or her user name and password. The login page may include information on one or more upcoming featured events such as an upcoming baseball game between Arizona and Atlanta as shown. A click-on option to buy tickets to the featured event is also provided. In addition to the featured events, the user may also view information on events in different categories. For example, the customer may view different sporting events from a drop down selection menu. Alternatively, a customer may browse various events associated with a particular team from the select a team menu. A search engine search term entry field is also included on the login page. The search engine enables the user to locate and access relevant information on a number of different events by typing in key words, such as a team name, venue, or event name into the search term data entry field. A browse sports function is also provided. The browse sports function is similar to the select a sport menu assisting the customer in locating the event he or she is interested in. If the customer accessing the exchange is not a registered member of the exchange, a link is provided to direct the user to a registration page where customer data may be Supplied by the customer and recorded by the exchange.

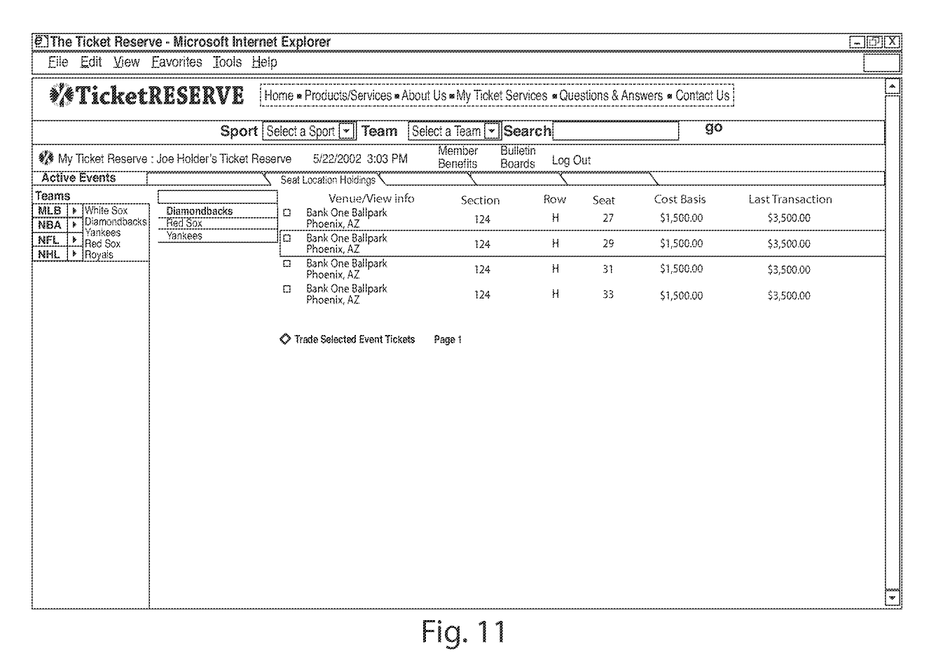

When a registered customer logs onto the exchange by entering a valid user name and password, the exchange recognizes the customer based on the user name, and presents a series of customized pages to the customer's computer reflecting the customer's holdings with the exchange. For example, according to a first scenario, a PSL licensee, Joe Holder, logs on to the exchange. A first customized user page showing Joe Holder's PSL holdings is shown in FIG. 11. A number of features of the initial login page, such as the “sport” drop down menu, the “Team” drop down menu, and the search engine search term data entry field are also displayed on the customized customer pages and are accessible throughout substantially all of the user experience. A series of selectable tabs allow the customer to view various aspects of his or her inventory. Event ticket holders tab allows the customer to view his or her event ticket holdings. Seat license holding tab allows the user to view his or her PSL holdings, PTC tab allows the customer to view his or her contingent event ticket certificate holdings. And submitted orders tab and completed orders tab, allow the customer to view the orders that he or she has submitted, and those which are have been completed, respectively.

FIG. 11 shows a customized customer page for Joe Holder with the seat license holdings tab selected. In this example, four records are shown corresponding to four PSLs owned by Joe Holder. Each record includes a description of the venue, the section, row, and seat number of the seat associated with the corresponding PSL. The cost basis for the PSL (the cost the current holder of the PSL paid for the PSL) is also displayed, as is the last transaction amount paid for the most recent PSL sold in the same zone as the subject PSL. Each PSL record further includes a check box for selecting the corresponding PSL record to include in a transaction. PSLs and the individual event tickets associated with PSLs may be traded in the same manner. However, because individual event tickets will be traded more often than PSLs, a full description of event ticket trading will be given below, but a description of PSL trading will be omitted.

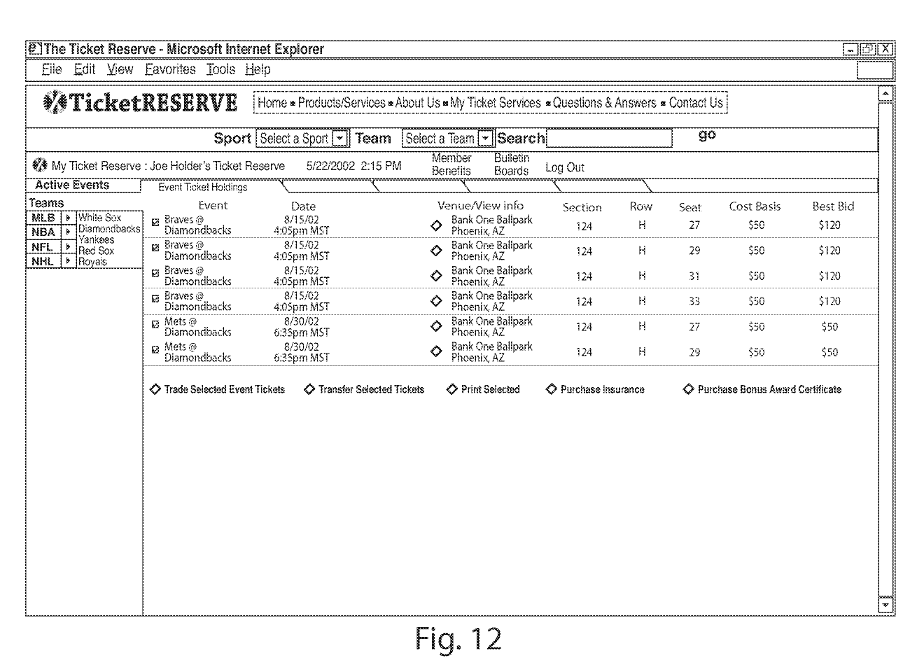

FIG. 12 shows a user customer page for PSL licensee Joe Holder with the event ticket holdings tab selected. This tab shows a listing of event ticket records. Each event ticket record includes an event description, the event date and time, the venue, the section row and seat numbers, the cost basis of the ticket (the price paid for the ticket by the current owner), and the current best bid for a ticket for a seat located in the same zone as the seat associated with the ticket. Additional pages may be provided to show the customer's additional holdings. Check boxes are provided adjacent each record to allow the customer to select individual tickets for trading or other purposes. The event ticket holdings page also provides click-on customer options such as Trade Selected Event Tickets, Transfer Selected Tickets, Print Selected Ticket, and Purchase Ticket Insurance.

If the ticket holder, Joe Holder, wishes to sell certain of his ticket holdings, he may select the corresponding ticket record by mouse clicking the check box adjacent the ticket description. A check mark appears in the selected boxes as shown. In this example, PSL licensee, Joe Holder, has selected four tickets for the Braves v. Diamondbacks game on Aug. 15, 2002 at 4:05 MST at Bank One Ballpark. The tickets correspond to section, Row H, Seats 27, 29, 31, and 33. The ticket holder then selects the “Trade Selected Event Tickets” option, in order to offer the selected tickets for sale.

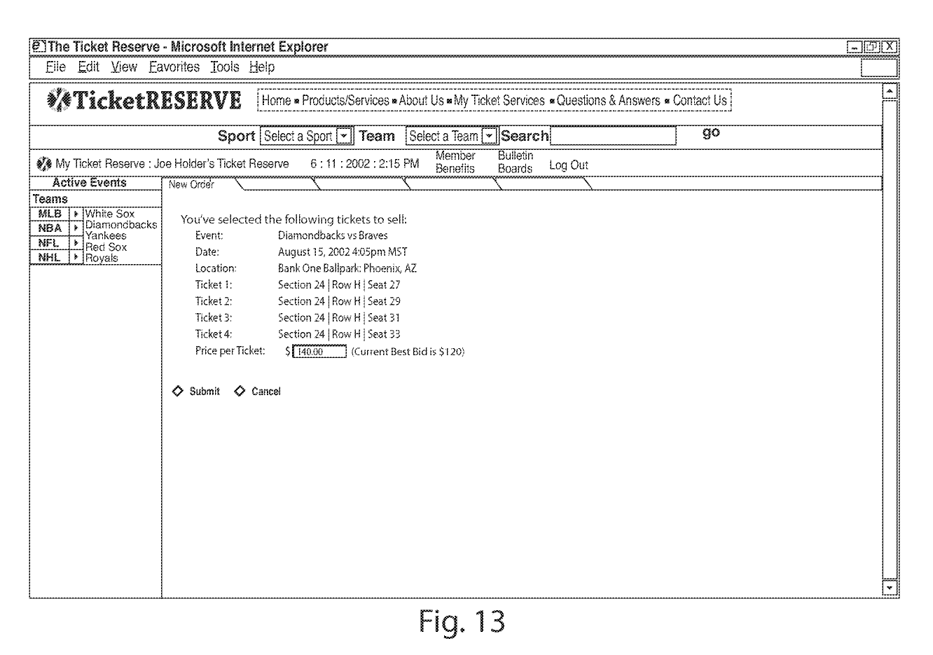

Mouse clicking on the “trade selected event tickets” option causes a new order page to be displayed on the customer terminal, as shown in FIG. 13. As can be seen, the new order page displays the event, the date, and location of the event, as well as the section, row and seat number designation of the tickets to be offered for sale. The new order page also includes a “Price per Ticket” field where the ticket holder may enter the price at which he or she is offering to sell the subject tickets. In the example shown, Joe Holder, has entered $140.00 as the sale price for the selected tickets. A current best bid field displays the current best bid that has been made for tickets located in the same zone as the tickets being offered by Joe Holder. This gives the ticket holder a sense of the market value of the tickets he or she is offering for sale. In this case, the best bid is $120.00 per ticket. Thus, Joe Holder is offering his tickets at $20.00 above the current market price. The ticket holder submits the sell tickets order by mouse clicking on the Submit option.

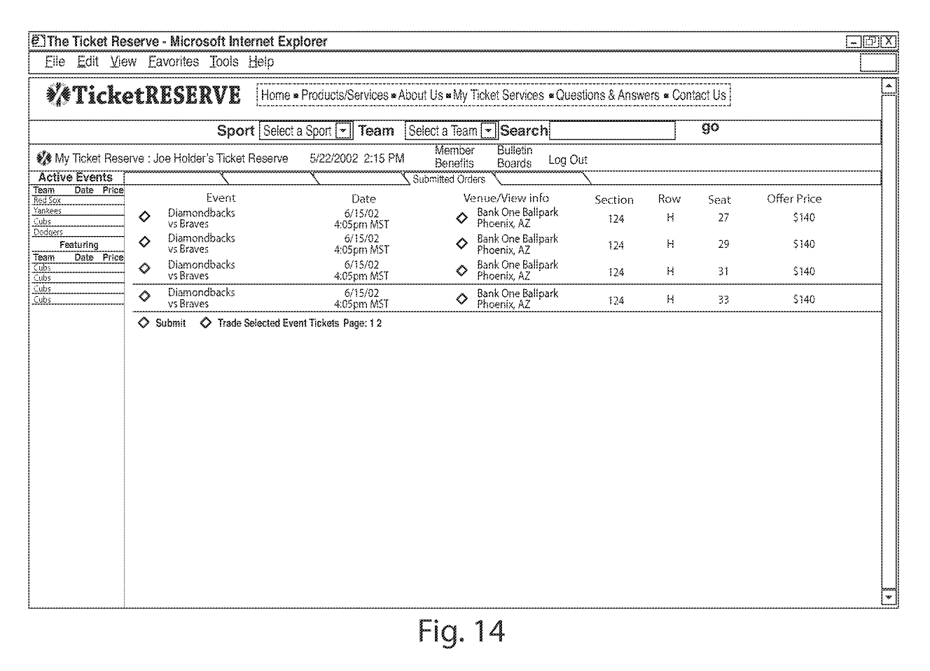

Upon submission of the sell order, the graphical user interface returns to the customized user page showing the user's ticket holdings. The ticket holder may then view the submitted order by selecting the “Customer Submitted Orders” tab. The data displayed under the “submitted orders” tab is shown at in FIG. 14. In keeping with the present example, ticket records corresponding to the ticket records selected for sale by Joe Holder in FIG. 12 are displayed. The ticket records are substantially similar to records including the event, date, venue, section, row, and seat number, but rather than including the cost basis and best bid, the submitted orders records include the price which the ticket holder entered when he or she submitted the offer, in this case. $50.00.

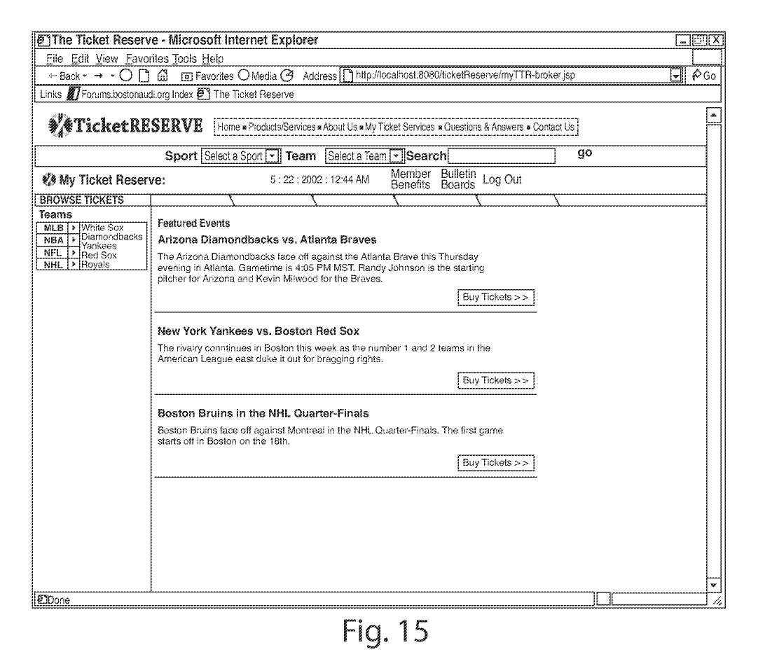

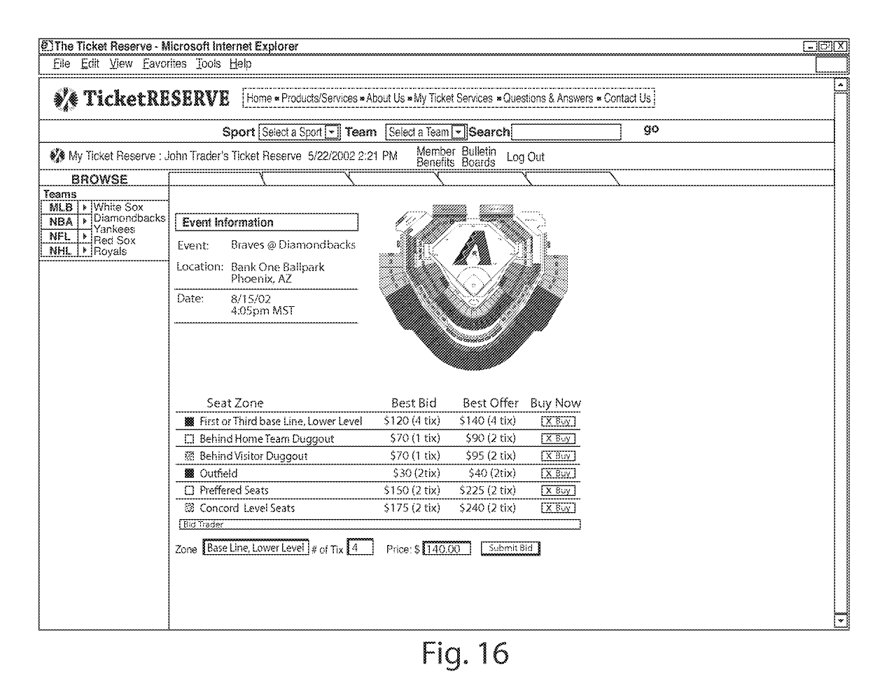

Next, a scenario will be described wherein a customer, John Trader, logs on to the exchange. In this scenario, John Trader holds no PSLs, tickets, or contingent event ticket certificates when he logs on. John Trader's intent is to purchase inventory for one or more popular events in the hope that ticket prices will increase, and that he will be able to re-sell the inventory at a profit. John Trader logs on to the exchange from the login screen of FIG. 10, in the same manner as the PSL licensee in the previous scenario. However, since John Trader has no current ticket holdings, the customized holdings page displayed by his browser and shown in FIG. 15 merely includes additional featured event in addition to the featured event which was also shown on the login page. By selecting one of the corresponding Buy Tickets options the customer, John Trader, can access a Purchase Event Ticket screen such as that shown in FIG. 16.

The purchase event tickets screen of FIG. 16 corresponds to customer John Trader selecting the buy tickets option associated with the Arizona Diamond Backs v. the Atlanta Braves featured event. Of course, any customer, including John Trader, may arrive at the same screen (or other purchase event ticket screens for other events) by using the browsing function or other navigational tools for locating a particular event.

The purchase event tickets screen lists the event, the venue and the date. The purchase event tickets screen also includes a map of the venue illustrating the various zones for which tickets are available. A current market conditions table is also displayed. The current market conditions table lists the best bid and best offer for tickets in each seat zone for which tickets are available. The customer can bid on tickets from this page by selecting a zone from a zone drop down selection menu, entering the number of tickets he or she wishes to purchase in a number of tickets field, entering a bid price in a price field, and selecting a submit bid option. The customer's bid will subsequently be displayed when other customers view the purchase/sell tickets pages as will be described below. Alternatively, the customer can elect to purchase tickets directly at the current best offer price by selecting the buy option of the desired zone.

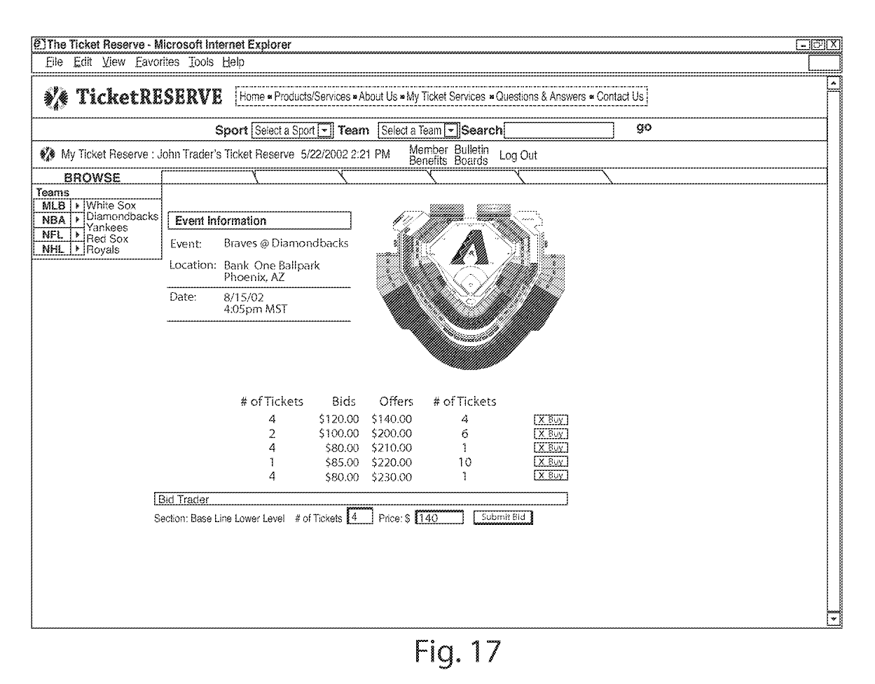

Selecting the buy option adjacent one of the zone entries in the current market conditions table causes a more detailed current market table for the selected zone to be displayed as shown in FIG. 17. The detailed current market table lists all of the offers and bids that have been submitted for tickets in the selected zone for the given event. The number of tickets associated with each bid and each offer is also displayed. The detailed current market table may be all inclusive showing all bids and offers submitted for the respective zone, or it may be limited to a smaller more manageable number of entries. Alternatively, a scroll function may be provided to display additional entries.

In the example shown in FIG. 17 five separate bids and five separate offers are displayed. From this page the customer may again submit a below market bid by entering the number of tickets in the “# of tickets” data field and the price he or she is willing to pay in the “Price” data field. The customer submits the bid by selecting the “Submit Bid” option. Alternatively, the customer may purchase any of the available tickets by directly accepting a posted offer by selecting the corresponding buy option adjacent the desired offer.

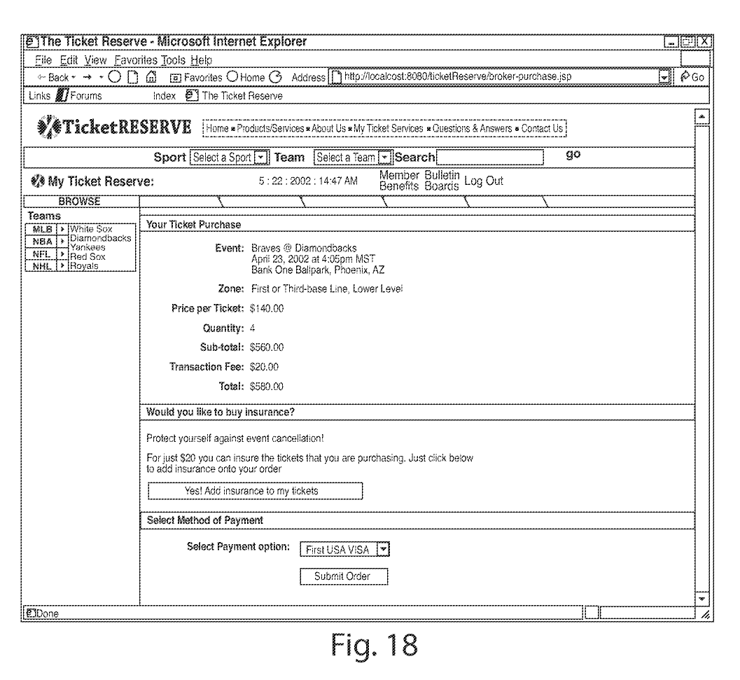

Selecting one of the buy options causes an invoice page to be displayed on the customer's terminal, as shown in FIG. 18. The invoice page displays the event, the date and the venue, the zone in which the tickets are located, the price paid per ticket, the number of tickets, the subtotal of the purchase amount, a transaction fee amount which may be added by the exchange, and a total amount.

The invoice shown in FIG. 18 further provides an option to purchase ticket insurance. Ticket insurance is a mechanism that allows the ticket purchaser to insure the price paid for the tickets in the event that the event is cancelled or rescheduled at a time inconvenient for the ticket purchaser. Typically, if the event sponsor cancels an event the event sponsor will only reimburse the face value of the tickets. However, a customer purchasing tickets for a high demand event on the exchange may pay a significant premium over the face value. By purchasing ticket insurance the customer can recoup the full purchase price paid for the tickets if the tickets become worthless or lose their value due to cancellation, rescheduling or the like. Another feature which may be offered to customers of the exchange is a bonus award program based on occurrences that take place at the event. For example, if the event is a baseball game, a customer could purchase a No Hitter Certificate. If a pitcher throws a no hitter in the designated game, the ticket holder who purchased the No Hitter Certificate would then win a prize.

Finally, the invoice page includes a payment option drop down menu. The options available on the payment drop down menu will correspond with the payment data supplied by the customer when the customer registered with the exchange. Once the customer has selected a payment option such as Visa or MasterCard or the like, from drop down menu he or she may submit the order by selecting the Submit Order option. At this point the customer's credit card account is billed the amount total displayed on the invoice at the same time the ownership records of a number of tickets equal to the quantity and within the zone listed on the invoice are updated to reflect the new owner.

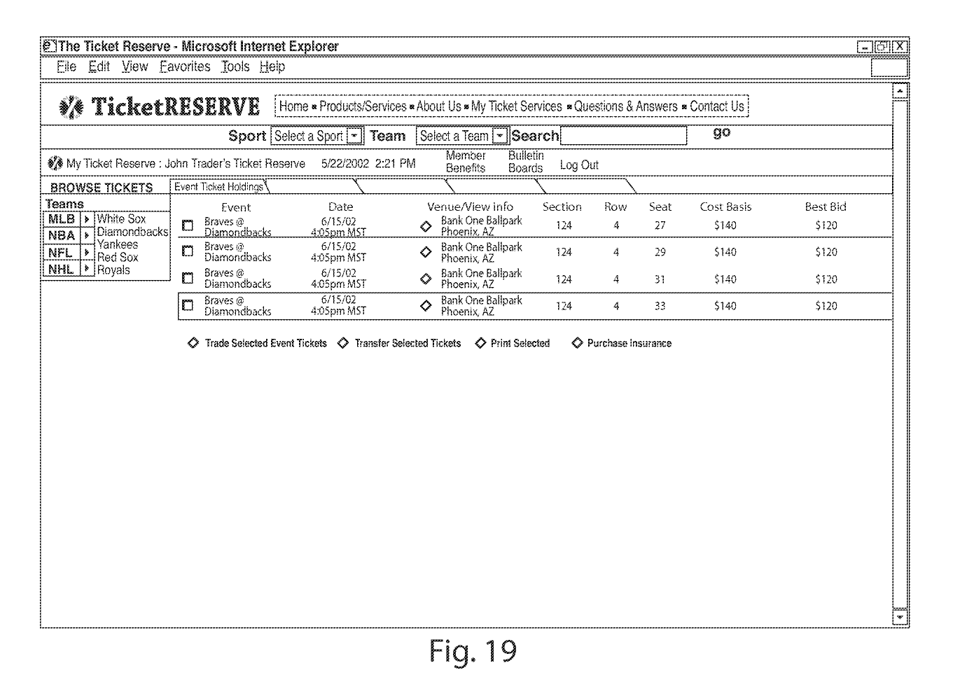

Returning to the example where John Trader is purchasing tickets on the exchange for later re-sale, we will assume that John Trader purchased the four tickets along the first third or third baseline for the Aug. 15, 2002 baseball game between the Arizona Diamondbacks and the Atlanta Braves described in the transaction above. John Trader now has inventory. Upon submitting the above order, the exchange's graphical user interface displays John Trader's customized holding page shown in FIG. 19. The four newly purchased tickets are displayed under the event ticket holding tab. It will be noted, John Trader's newly acquired ticket holdings are the same tickets which were offered for sale by Joe Holder in the earlier example. Thus, John Holder's sell order is now complete. Although not shown, Joe Holder's customer page would no longer display these four tickets under the my holdings tab and a record of the transaction would be displayed under the completed transactions tab.

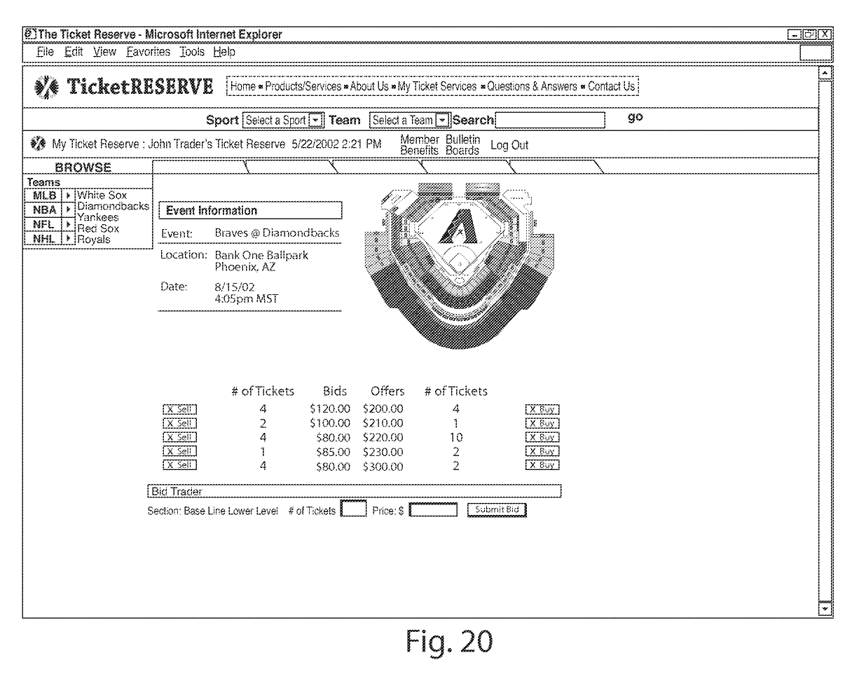

Now that John Trader has inventory, he can turn around and sell the event tickets that he has purchased. John Trader can offer to sell the tickets above the current market price or he can accept a bid from another customer on the exchange. The steps necessary for John Trader to place an above market offer to sell are identical to those described above with regard to Joe Holder's offer to sell his inventory and will not be repeated here. Alternatively, the steps necessary for John Trader to accept a current bid posted by another potential buyer will be described. It should be noted that Joe Holder also could have sold his tickets according to this alternate method. Suppose that Jane Fan has submitted a bid for four tickets to the Aug. 15, 2002, Arizona Diamondbacks v. Atlanta Braves baseball game at Bank One Ballpark, and that she has bid $200 per ticket. John Trader can monitor the market price for his inventory by locating the event or events for which he holds tickets using the navigational tools. In the example, John Trader may again locate the Diamondback v. Braves game to display the detailed purchase/sell event tickets screen shown in FIG. 20. The detailed purchase/sell event tickets screen is substantially identical to the detailed purchase tickets screen of FIG. 17, except that the desired zone current market table includes selectable sell options adjacent the current bids. These appear because John Trader now has the appropriate inventory to sell.

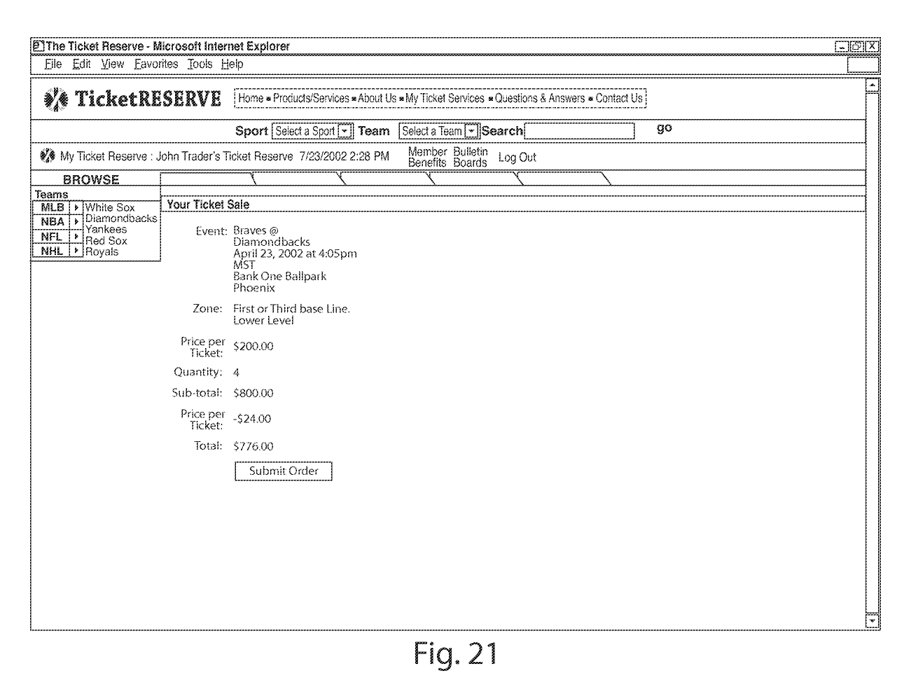

Jane Fan's bid for 4 tickets at $200.00 is currently the best bid. John Trader may accept this bid by selecting the sell option adjacent Jane Fan's bid. Of course, John Holder has no idea of the identity of the party who has submitted the bid. Selecting sell option causes a sales invoice screen to be displayed by John Trader's browser as shown in FIG. 21. Again, the invoice includes the event, the date, the venue, the seating zone, the price per ticket, the number of tickets, a subtotal amount, transaction fee, and a total amount. In this case, the transaction fee is subtracted from the subtotal and the total amount is credited to John Trader's credit card account upon his selecting the submit order option.

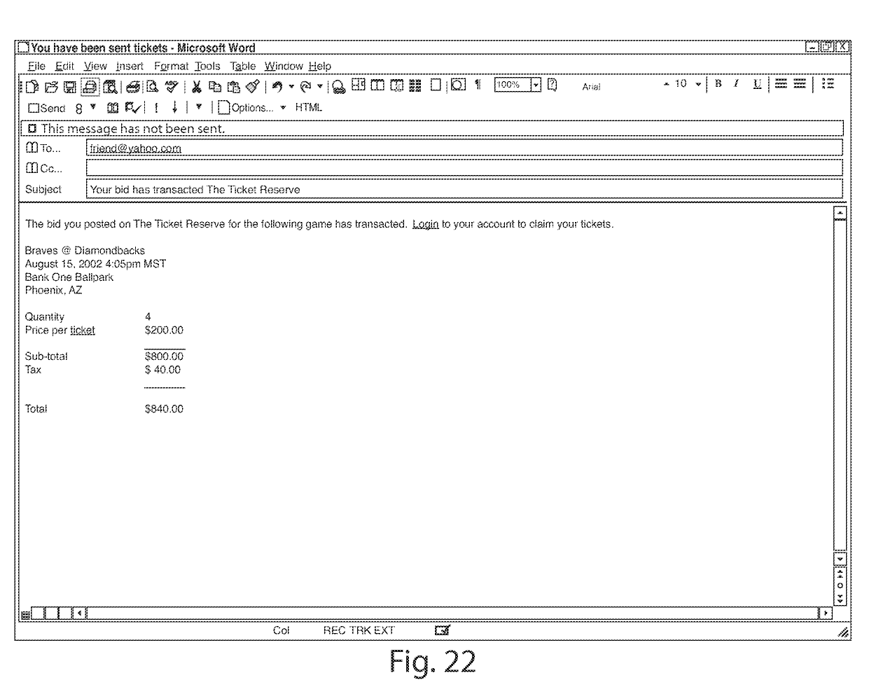

On the purchaser's side, Jane Fan's bid having been accepted, the purchase transaction proceeds automatically. The exchange sends a message to Jane Fan according her preferred method of communication, (determined when she registered with the exchange.) For example, the exchange may send an e-mail message as shown in FIG. 22. The message indicates the event, the date, the venue, the price for ticket, the quantity, the subtotal, sales tax and total. The total amount is automatically charged to Jane Fan's credit card, and the ownership records of the four tickets are updated to reflect the new owner.

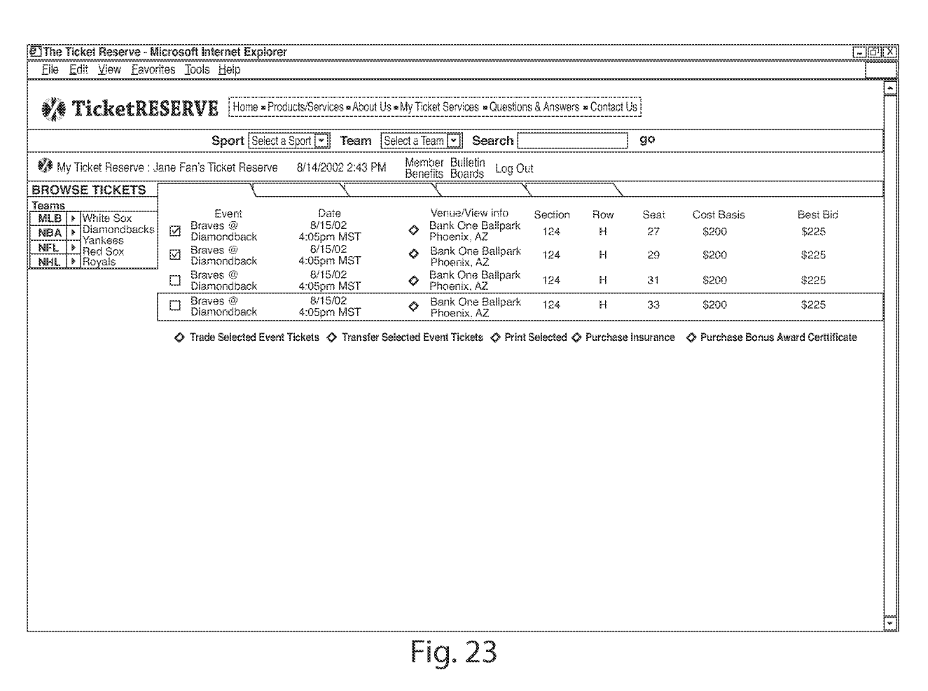

Upon receiving the message Jane Fan may log onto the exchange to view her ticket holdings by accessing her customized user page. Her new ticket holdings are displayed under the event ticket holdings tab shown in FIG. 23. As can be seen, Jane Fan's ticket holdings now include the four tickets for the Apr. 23, 2002 Braves-Diamondbacks game at Bank One Ballpark. Since Ms. Fan paid $200.00 per ticket the cost basis is displayed is $200.00. Although not shown, John Trader's ticket holdings at this point would be empty, as he has sold his entire inventory. When viewing her holdings from her customized ticket holdings page Jane Fan can elect to purchase insurance for one or more of her tickets by selecting the check box adjacent to the desired ticket and selecting the purchase insurance option. Additional screens (not shown) are provided for transacting a ticket insurance purchase.

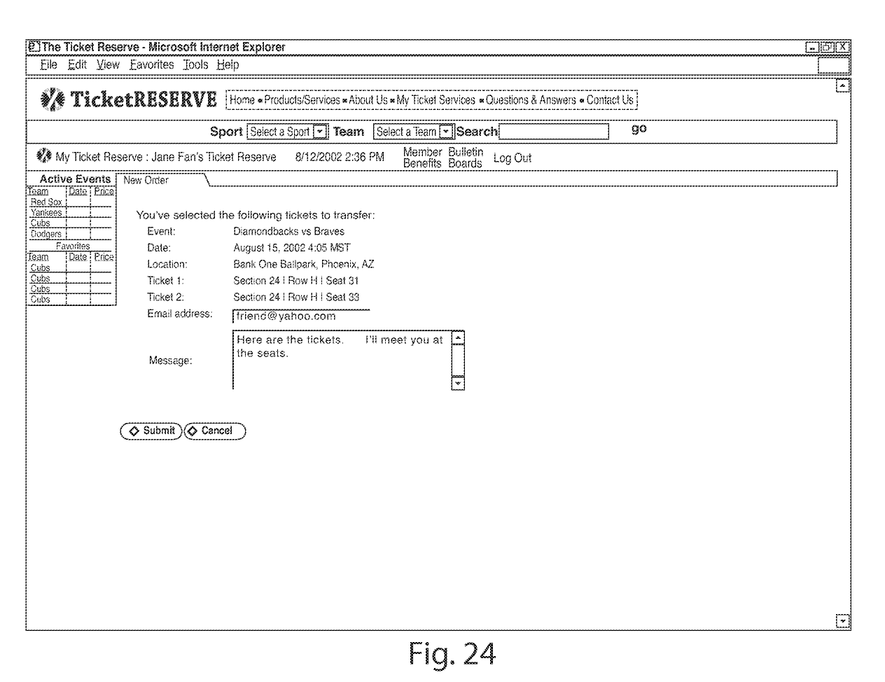

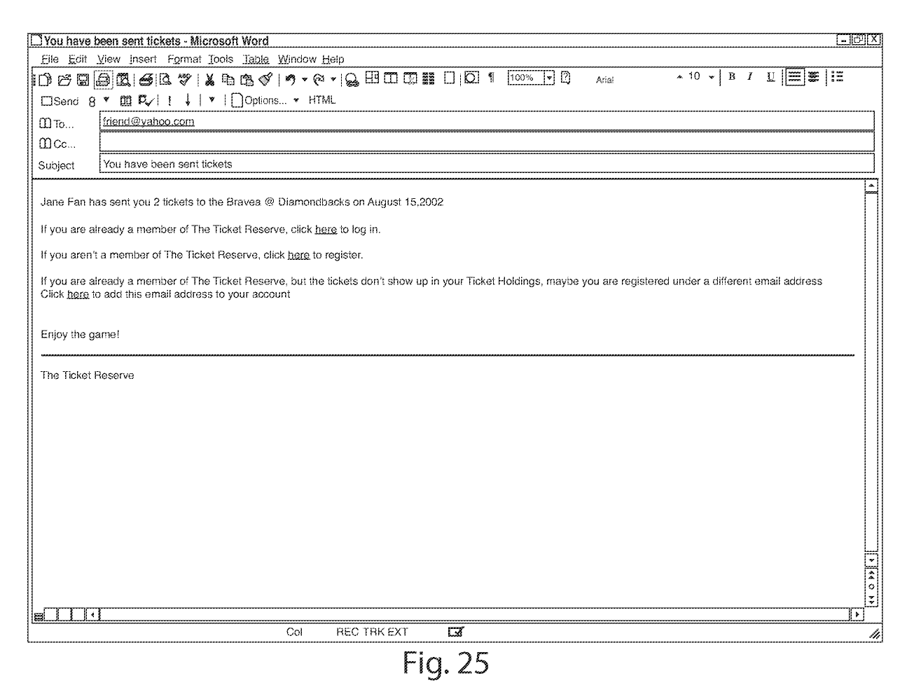

Of course, Jane Fan, having inventory can offer her ticket for sale, accept a bid for the tickets, or actually use the tickets. She may also electronically transfer some or all of her tickets to a friend. To transfer tickets she selects the check box adjacent to the appropriate tickets as shown in FIG. 23, then selects the transfer tickets option. This causes the ticket transfer page shown in FIG. 24 to be displayed by Jane Fan's web browser. The ticket transfer page includes the description of the selected tickets, including the event, the date, the venue and the section row and seat number. The transfer ticket page also includes a data field for entering the transferee's e-mail address, as well as a text field for entering a message. Upon selecting the Submit option an e-mail message such as that shown in FIG. 25 is sent to the address entered in the e-mail address field. If the transferee is registered with the exchange he or she may login to the exchange to view the transferred tickets and print ticket coupons if he or she intends to use them. If the transferee is not registered with the exchange, he or she must register before being allowed to view and print the transferred tickets.

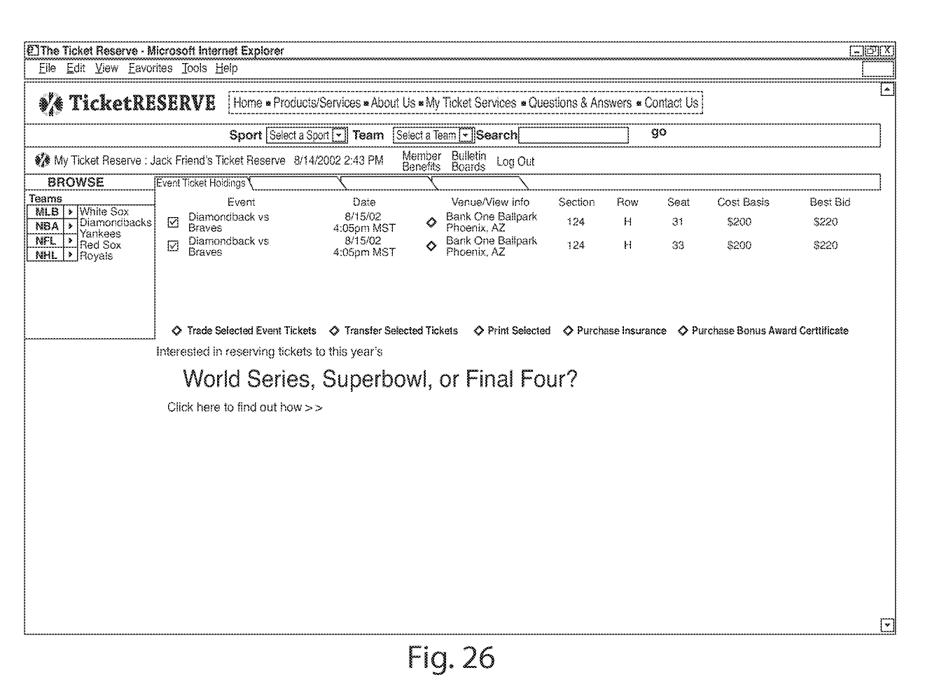

In the example shown, Jane Fan transferred two of her tickets to the Aug. 15, 2002 Braves-Diamondbacks game to her friend, Jack Friend. The transferred tickets correspond to seats 31 and 34, row H, section at Bank One Ballpark. These tickets now appear under the event tickets holdings tab of Jack Friend's customized ticket holdings page, as shown in FIG. 26. To use the tickets Jack Friend selects the check boxes adjacent the tickets and selects the print selected option. Jack Friend's computer then causes ticket coupons shown in FIG. 26 to be printed. Significantly, the ticket coupons identify Jack Friend as the ticket holder and include bar codes the bar codes may include coded data that ensures that the ticket is authentic. The ticket coupons identify the event, the date, the section number, row had seat number in the same manner as any conventional ticket. Of course, Jane Fan can print her ticket holdings in the same manner, as can any other event ticket holder.

Finally, it should be noted that contingent event certificates, can be traded on the exchange in the same manner as event tickets. With the graphical user interface just described. An exchange member's contingent event ticket certificates are referred to as playoff ticket certificates and may be viewed from the PTC holdings tab of a customer's customized holdings page. Once the contingent event ticket certificates mature into actual event tickets, the records are removed from the customer's PTC holdings tab and are displayed on the event ticket holdings tab.

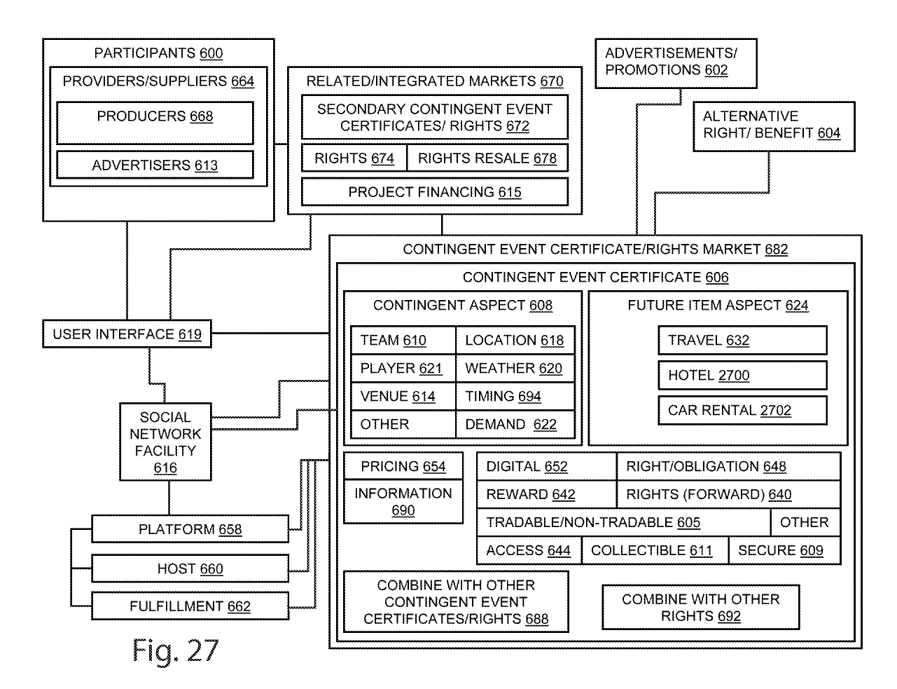

Referring to FIG. 27, in embodiments, an integrated rights marketplace 114 may provide an option to acquire access rights for travel 632, such as air travel 574, wherein the option is dependent at least in part upon an outcome of a contingency event. A contingency event may include, but is not limited to a team 610, player 621, venue 614, location 618, weather 620, timing 694, demand 622, or some other contingent aspect 608. The integrated rights marketplace 114 may enable a purchase of the access rights upon the outcome, wherein the outcome is related to the outcome of the contingent event. In embodiments, an integrated rights marketplace 114 may provide an option to acquire a right to a hotel 2700 accommodation, wherein the option is subject to a restriction pending an outcome related to a contingent event. In embodiments, an indication of the outcome may be presented in the integrated rights marketplace 114 and the restriction after receiving the indication. In embodiments, an integrated rights marketplace 114 may provide an option to acquire a right to transportation, such as a car rental 2702, wherein the option is subject to a restriction pending an outcome related to a contingent event. In embodiments, an indication of the outcome may be presented in the integrated rights marketplace 114 and the restriction after receiving the indication. In embodiments, an integrated rights marketplace 114 may provide an option to acquire a right to a restaurant reservation, wherein the option is subject to a restriction pending an outcome related to a contingent event. In embodiments, an indication of the outcome may be presented in the integrated rights marketplace 114 and the restriction after receiving the indication. An outcome may be the outcome of a sporting event, related to a weather event, related to pricing event, an event other than pricing, or some other outcome.

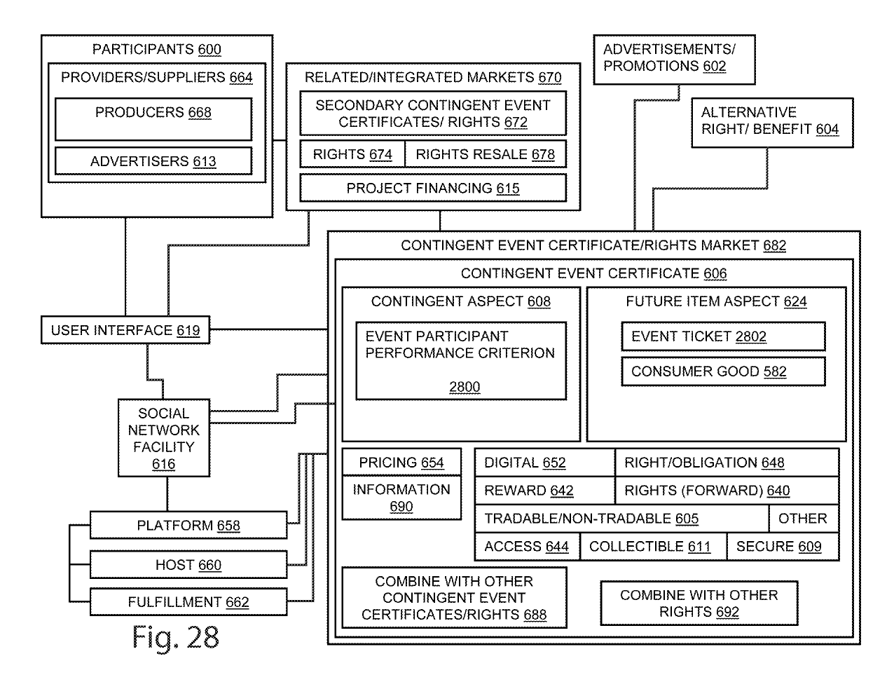

Referring to FIG. 28, in embodiments, an integrated rights marketplace 114 may offer a contingent right to purchase an event ticket 2802 in a rights marketplace, wherein the contingency is based at least in part upon a performance criterion 2800 of a participant in the event. In embodiments, an integrated rights marketplace 114 may offer a determined right to purchase a consumer good 582, wherein the determined right is offered in advance of a general public release of the consumer good 582 for purchase. In embodiments, a participant may be an individual participant, a team participant, a defined group of participants, or some other type of participant.

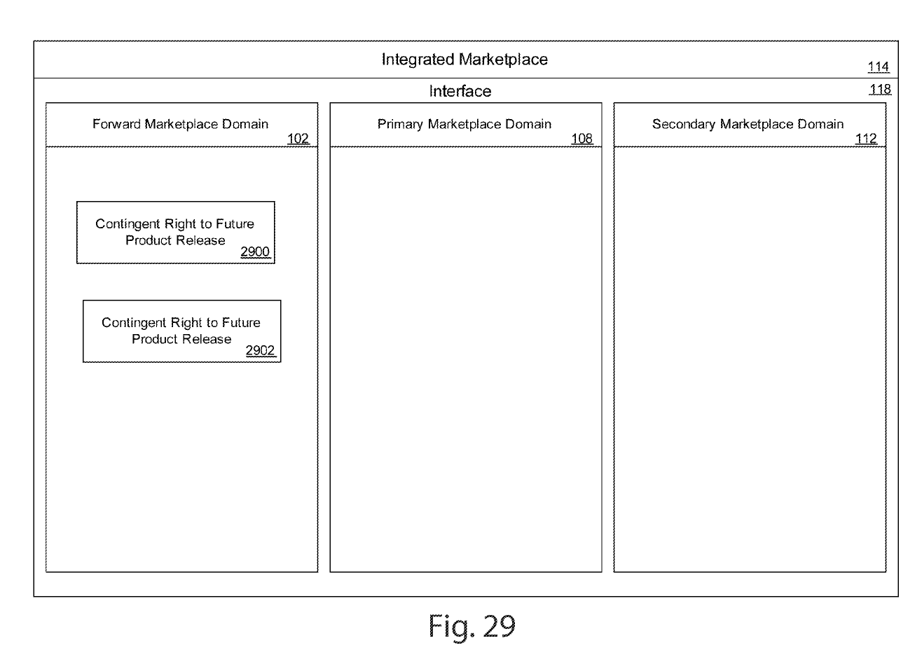

Referring to FIG. 29, in embodiments, an integrated rights marketplace 114 may provide an interface 118 that includes a forward market domain. The marketplace may enable the creation of a contingent right to purchase a future product release 2900, wherein the contingency is the occurrence of the product's release, and enable users of the interface 118 to transact the contingent right. In embodiments, an integrated rights marketplace 114 may provide an interface 118 that includes a forward market domain. The marketplace may enable the creation of a determined right to purchase a future product release 2902, wherein the contingency is the occurrence of the product's release, and enable users of the interface 118 to transact the determined right.

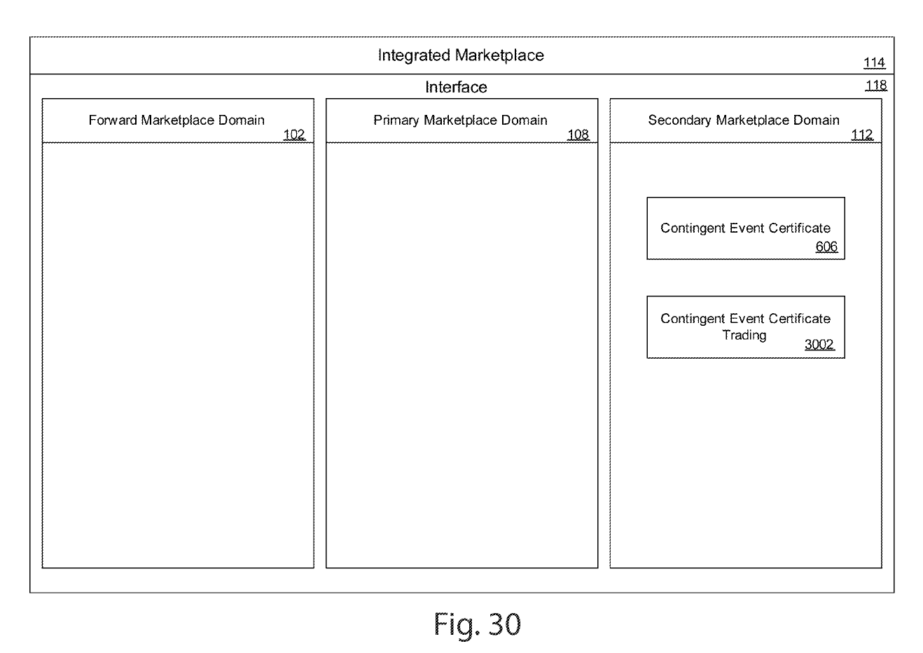

Referring to FIG. 30, in embodiments, an integrated rights marketplace 114 may provide a contingent event certificate secondary trading market 3002, a user interface 118 for accessing the secondary market, and access to the secondary market for the purposes of trading 3002 contingent event certificates 606.

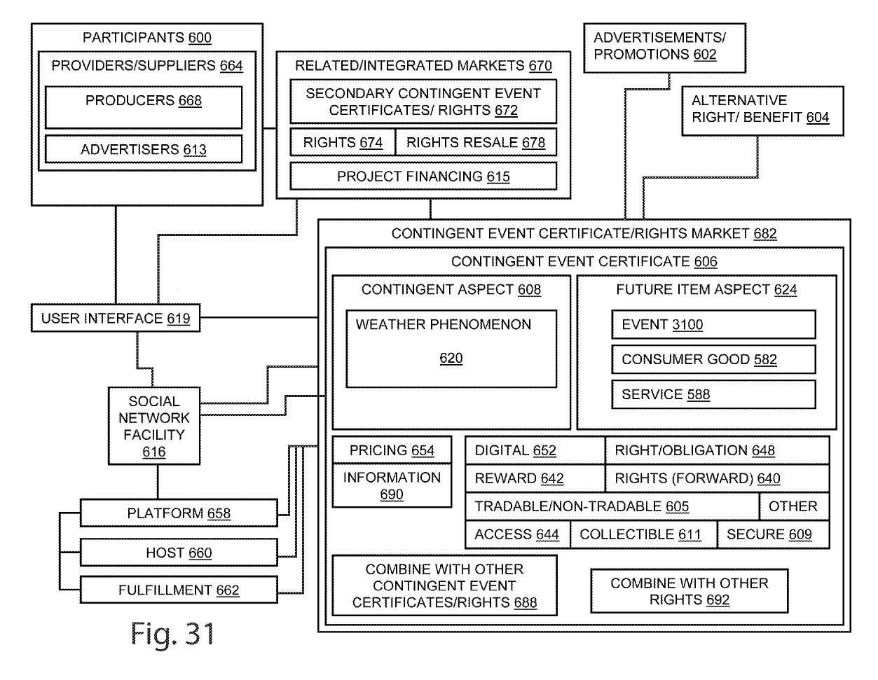

Referring to FIG. 31, in embodiments, an integrated rights marketplace 114 may provide an interface 118 that includes a forward market domain. The marketplace may enable the creation a contingent right to an event 3100, wherein the contingency is the occurrence of a weather 620 phenomenon, and enable users of the interface 118 to transact the contingent right. In embodiments, an integrated rights marketplace 114 may provide an interface 118 that includes a forward market domain. The marketplace may enable the creation a contingent right to a consumer good 582, wherein the contingency is the occurrence of a weather phenomenon 620, and enable users of the interface 118 to transact the contingent right. In embodiments, an integrated rights marketplace 114 may provide an interface 118 that includes a forward market domain. The marketplace may enable the creation a contingent right to a service 588, wherein the contingency is the occurrence of a weather phenomenon 620, and enable users of the interface 118 to transact the contingent right.

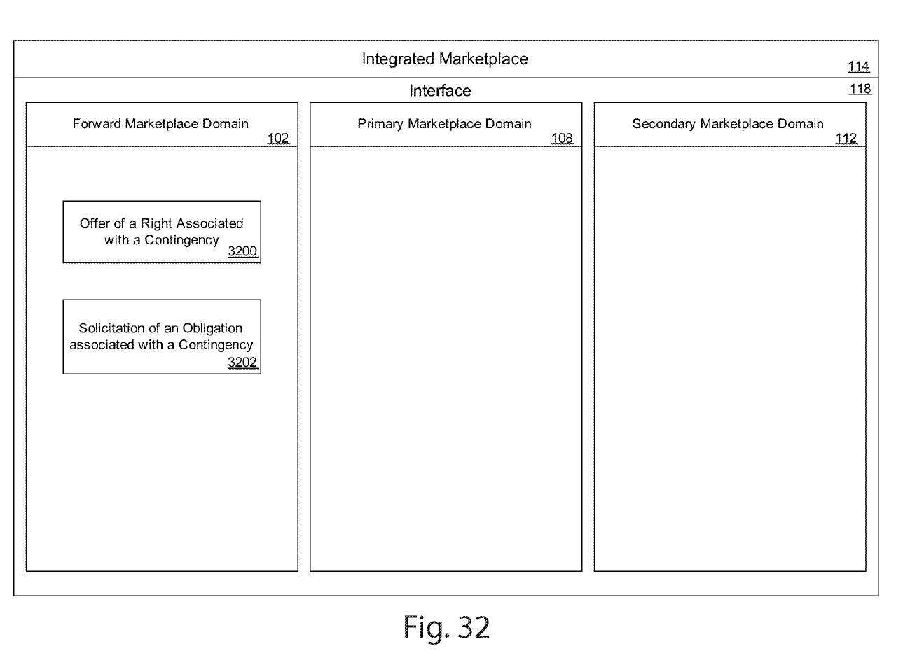

Referring to FIG. 32, in embodiments, an integrated rights marketplace 114 may provide an interface 118 that includes a rights market, and enable users of the interface 118 to interact with an offer of a right within the interface 118, the right being associated with a contingency 3200. In embodiments, an integrated rights marketplace 114 may provide an interface 118 that includes a rights market, and enables users of the interface to interact with a solicitation of an obligation within the interface, the obligation being associated with a contingency 3202. In embodiments, an obligation may be an obligation to acquire a ticket to an event, an obligation to acquire a product, an obligation to acquire a service, or some other type of obligation.

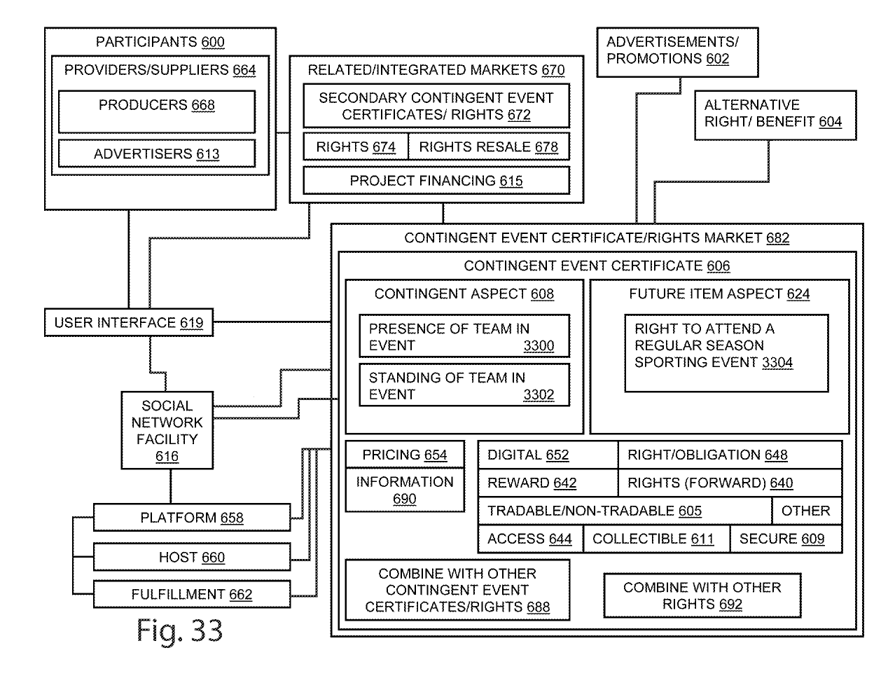

Referring to FIG. 33, in an integrated rights marketplace 114 may provide an interface 118 for offering a right to attend a regular season sporting event 3304, the right being subject to a contingency, the contingency selected from the group consisting of the presence of a team in the sporting event, the presence of a participant in the sporting event 3300 and the standing of a team participant in the sporting event 3302.

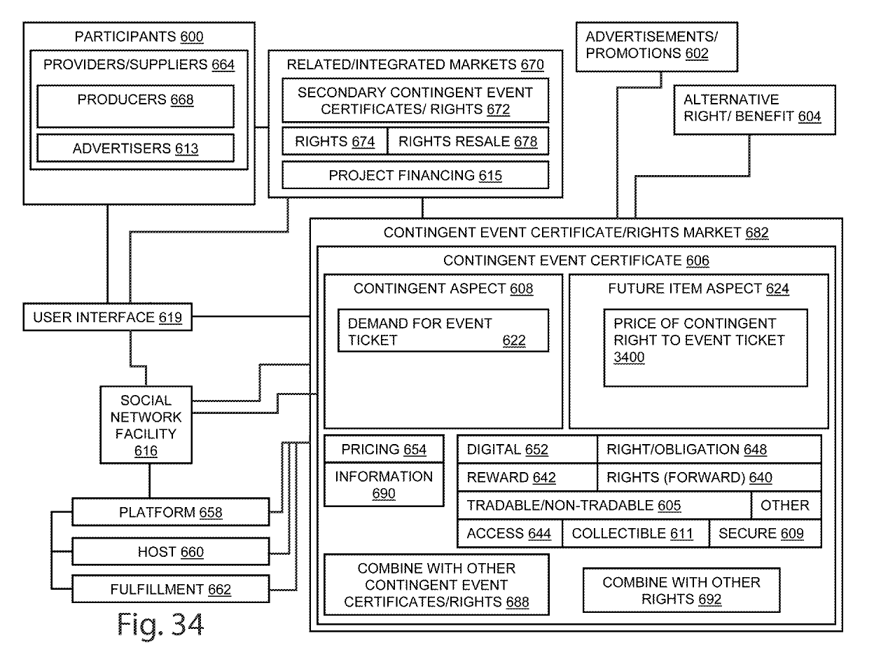

Referring to FIG. 34, in embodiments, an integrated rights marketplace 114 may provide a contingent right to purchase an event ticket within an integrated rights marketplace 114, wherein the cost of the contingent right 3400 is based at least in part on a measure of demand 622 for the contingent right. In embodiments, an integrated rights marketplace 114 may provide a contingent event certificate market platform, and select a currency for the contingent event certificate market platform based on an aspect of the user of the platform.

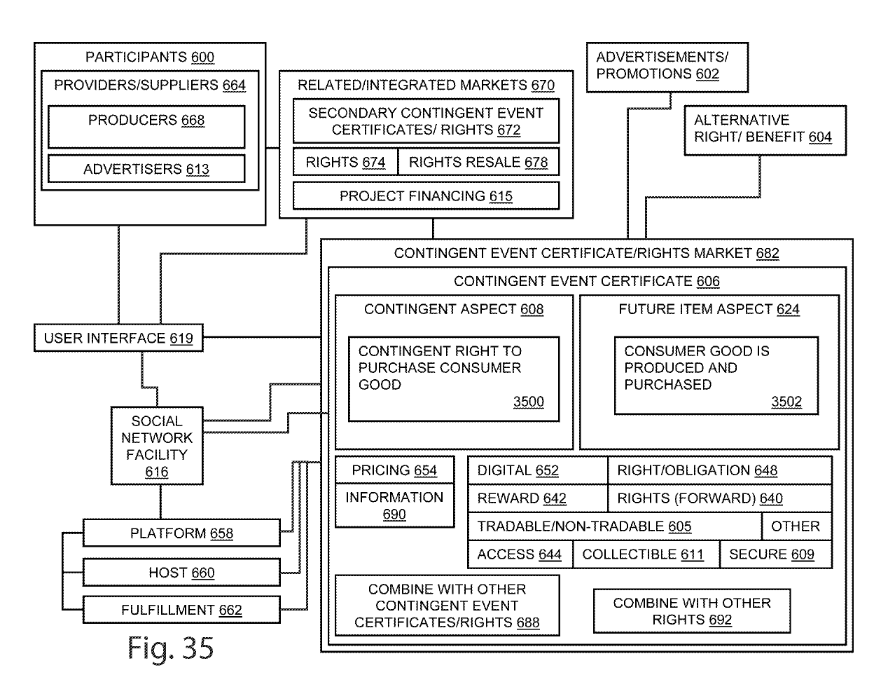

Referring to FIG. 35, in embodiments, an integrated rights marketplace 114 may provide a contingent purchase right to a consumer good (582, 3500) wherein the contingency is the production 3502 of the consumer good 582, and wherein the occurrence of the contingency secures a right to purchase 3502 the consumer good 582. In embodiments, the right may be coupled with an obligation to purchase the consumer good 582

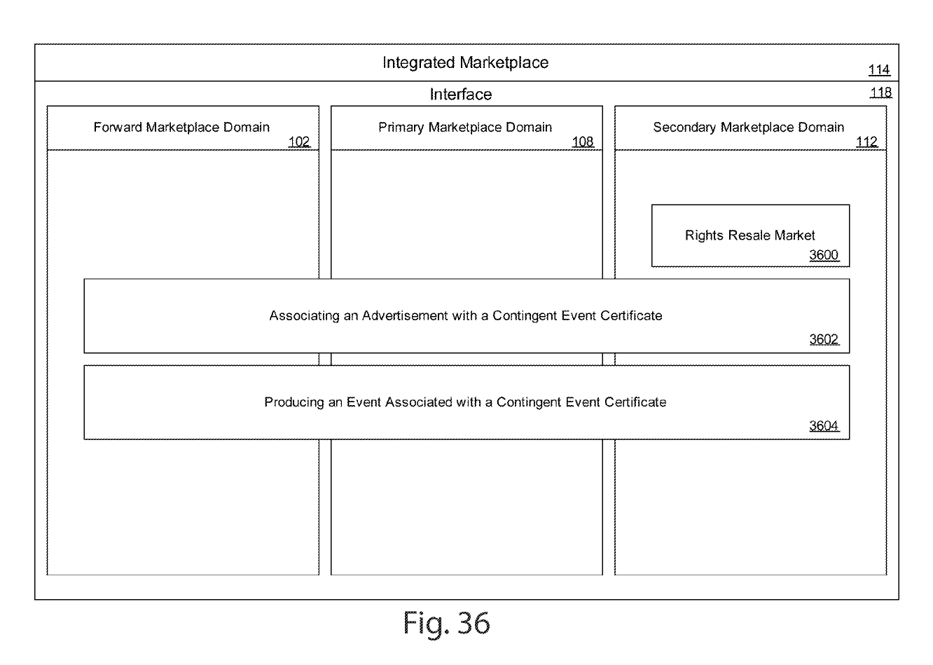

Referring to FIG. 36, in embodiments, an integrated rights marketplace 114 may provide a user interface 118 for accessing the marketplace, and enable using the interface 118 for the purposes of managing aspects of the integrated rights marketplace 114. In embodiments, an integrated rights marketplace 114 may provide a rights resale market 3600, a user interface 118 for accessing the rights resale market 3600, and enable using the interface 118 to access the rights resale market 3600 for the purposes of trading rights. In embodiments, an integrated rights marketplace 114 may provide a contingent event certificate market platform, a user interface 118 for accessing the contingent event certificate market platform; and enable using the interface 118 to access the contingent event certificate market platform for the purposes of associating advertisements with the contingent event certificate market platform 3602. In embodiments, an integrated rights marketplace 114 may provide a contingent event certificate market platform, a user interface 118 for accessing the contingent event certificate market platform, and enable using the interface 118 to access the contingent event certificate market platform for the purposes of producing an event associated with the contingent event certificate market platform.

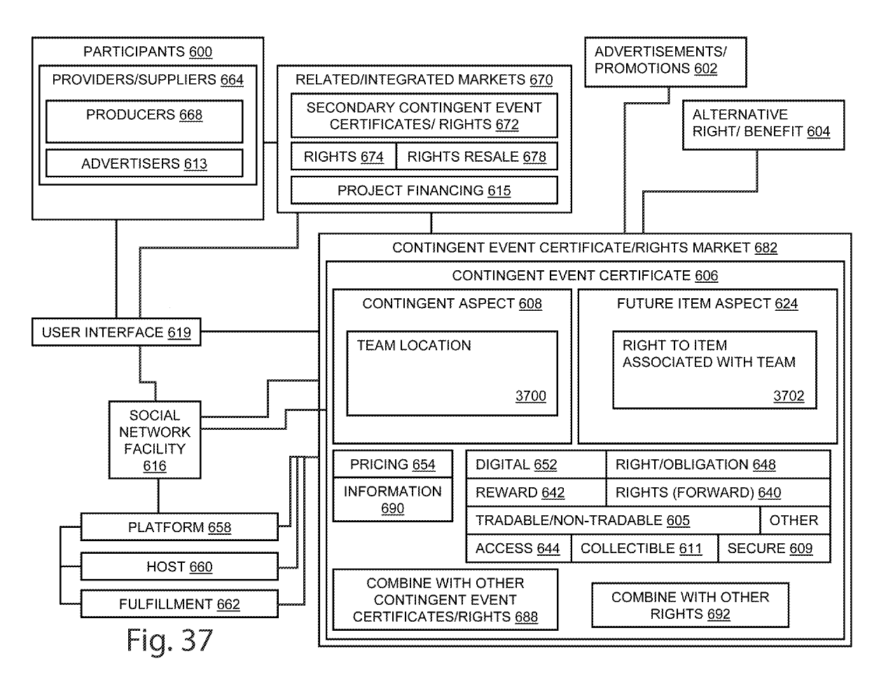

Referring to FIG. 37, in embodiments, an integrated rights marketplace 114 may provide a platform for exchanging a right, the right being subject to a contingency, wherein the right relates to a right to an item associated with a sports team 3702 and wherein contingency relates to the location 3700 of the sports team. In embodiments, the item may be a ticket to a sporting event, an item of team-related merchandise, a ticket to a post-season game, an accommodation related to a sporting event, a ticket for travel to a sporting event, a seat license, a right to acquire season tickets, or some other type of item. In embodiments, the location 3700 of the sport team may be the short-term location of the team, the long-term location of the team, the selected home city of the team, or some other location.

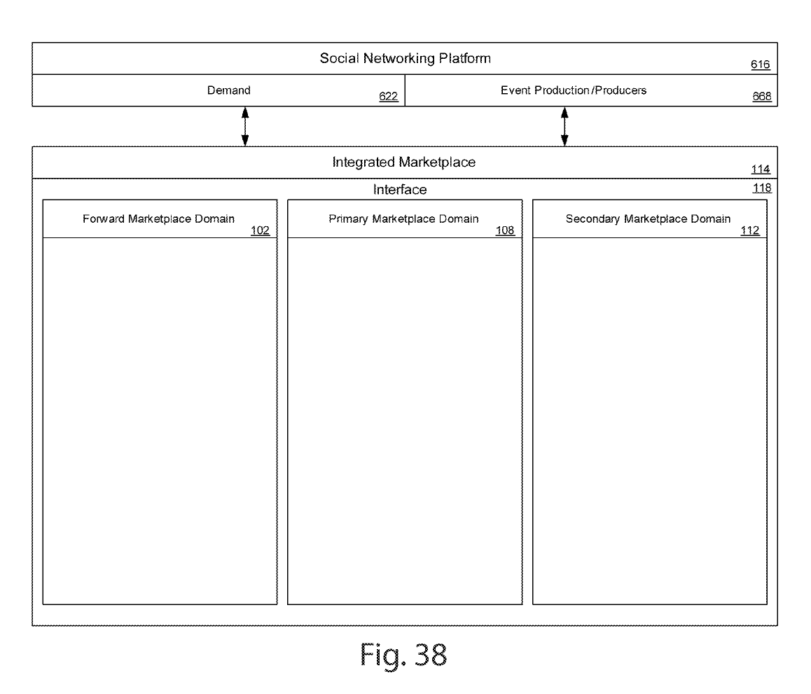

Referring to FIG. 38, in embodiments, an integrated rights marketplace 114 may provide a user interface 118 for accessing a social networking platform 616, and allow a user of the social networking platform to at least one of purchase and offer a contingent event certificate via the social networking platform 616. In embodiments, an integrated rights marketplace 114 may enable identifying conditions associated with demand 622 for a contingent event, a production facility that may be used to produce the contingent event under the conditions, and enable monitoring demand for the event. In embodiments, an integrated rights marketplace 114 may offer a contingent event certificates 606 for sale to users of a social network 616, communicate the demand associated with contingent event certificate sales to event producers, and enable converting contingent event certificates 606 to access rights contingent upon the event being produced 668.

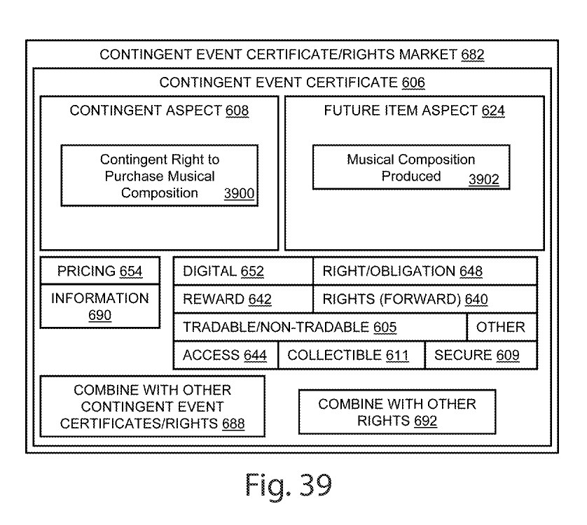

Referring to FIG. 39, in embodiments, an integrated rights marketplace 114 may provide a ticket purchase right to a contingent event 606, wherein the occurrence of the contingent event secures a right to purchase at least one event ticket (e.g., a concert ticket). In embodiments, an integrated rights marketplace 114 may provide a contingent purchase right to a musical composition, wherein the contingency is the production of the musical composition, and wherein the occurrence of the contingency secures a right to purchase the musical composition.

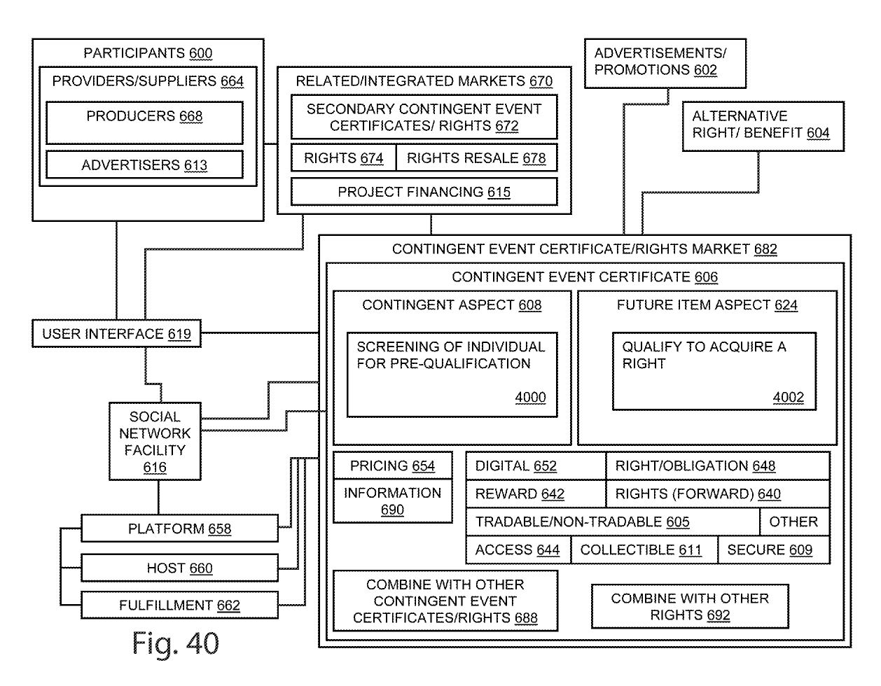

Referring to FIG. 40, in embodiments, an integrated rights marketplace 114 may screen individuals 4000 by one or more criterion, wherein the screening pre-qualifies an individual 40001, and provide pre-qualified individuals with the ability to acquire a contingent right 4002. In embodiments, an integrated rights marketplace 114 may screen individuals 4000 by one or more criterion, wherein the screening pre-qualifies an individual to purchase a consumer good 582, and provide screened individuals a contingent right to purchase the consumer good 582, wherein the manufacture of the consumer good 582 secures a right to purchase at least one unit of the consumer good 582. In embodiments, an integrated rights marketplace 114 may screen individuals by one or more criterion, wherein the screening pre-qualifies an individual to purchase a service 588, and provide screened individuals a contingent right to purchase the service 588, wherein the service 588 being offered for sale secures a right to receive the service 588.

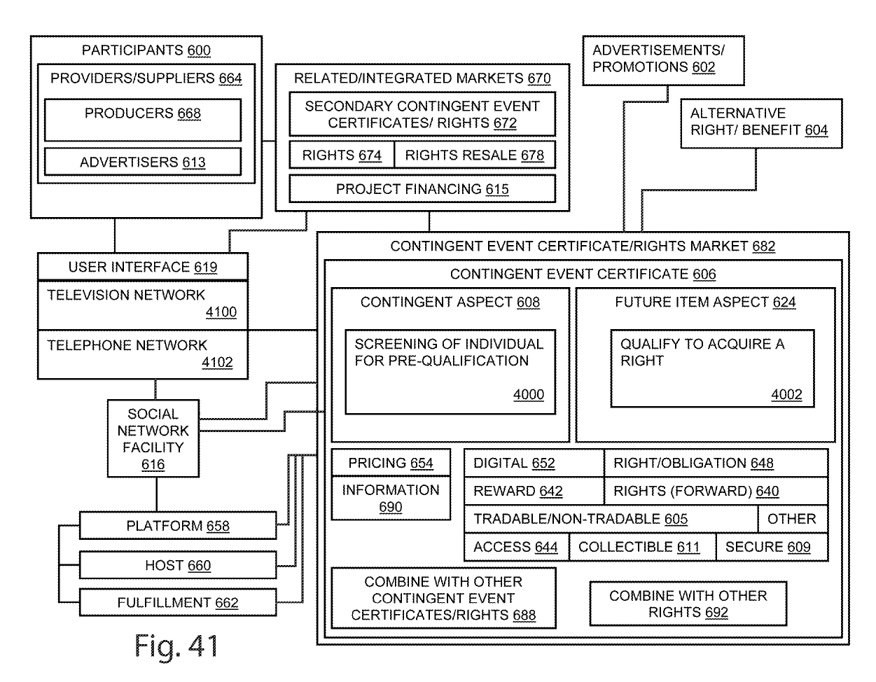

Referring to FIG. 41, in embodiments, an integrated rights marketplace 114 may offer a contingent right to an event for sale to users of a television network 4100, use a television interface 118 and its associated controls to transact the contingent right, and associate the television network 4100 with an integrated rights marketplace 114. In embodiments, an integrated rights marketplace 114 may screen a contingent right to an event for sale to users of a telephone network 4102, associate a mobile communication facility with the telephone network 4102, use a mobile communication facility interface 118 and its associated controls to transact the contingent right, and associate the telephone network 4102 with an integrated rights marketplace 114.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

It will be appreciated that the above processes, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a camera system and/or a computer in a number of ways, or all of the functionality may be integrated into a dedicated, standalone image capture device or other hardware. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
providing a contingent right to purchase an event ticket within an integrated rights marketplace, wherein the cost of the contingent right is based at least in part on a measure of demand for the contingent right.

2. A method of internationalization comprising:
providing a contingent event certificate market platform;
selecting a currency for the contingent event certificate market platform based on an aspect of the user of the platform.
